(19) United States
(12) Patent Application Publication
(10) Pub. No.: US 2024/0112100 A1
(43) Pub. Date: Apr. 4, 2024

(54) SYSTEM, METHOD, AND APPARATUS TO INTEGRATE INSPECTION DATA AND BUSINESS ANALYSIS

(71) Applicant: Gecko Robotics, Inc., Pittsburgh, PA (US)

(72) Inventors: Edward A. Bryner, Pittsburgh, PA (US); Richard Ducott, Milton, MA (US); William Barley, Woodway, TX (US); Patrick Celentano, Boston, MA (US); Christopher Connor Hazen, New York, NY (US); Mark Jacob Loosararian, Glenshaw, PA (US); Troy Demmer, Glenshaw, PA (US); Timothy R. Yousaf, Jewett, NY (US); Thomas J. Fiorelli, Spring Lake, PA (US)

(21) Appl. No.: 18/479,624

(22) Filed: Oct. 2, 2023

Related U.S. Application Data
(60) Provisional application No. 63/377,936, filed on Sep. 30, 2022.

(51) Int. Cl. G06Q 10/0631

(52) U.S. Cl. CPC G06Q 10/0631

(57) ABSTRACT

An example device includes a user interface component that implements a user interface and receives a visualization request value from user operations; an inspection database comprising an aggregation of inspection data; and a controller, comprising: a facility planning circuit that interprets a user facility visualization value in response to the visualization request value; a facility inspection data circuit that interprets the aggregation of inspection data in response to the user facility visualization value; a geographic depiction circuit that determines a geographic display boundary and a hierarchical inspection presentation for at least one industrial facility positioned within the geographic display boundary in response to the user facility visualization value and the aggregation of inspection data, and determines a user geographic display value in response to the geographic display boundary and the hierarchical inspection presentation. The user interface component provides the user geographic display value to the user interface.

### CROSS-REFERENCE TO RELATED APPLICATIONS

This application claims the benefit of U.S. Provisional Patent Application No. 63/377,936, filed on 30 Sep. 2022, and entitled “INSPECTION VISUALIZATION AND BUSINESS INTEGRATION” (GROB-0012-P01).

The foregoing application is incorporated herein by reference in the entirety for all purposes.

### SUMMARY

In some aspects, the techniques described herein relate to a system, including: a facility visualization and planning platform including: a user interface component configured to implement a user interface, and to receive a visualization request value from user operations on the user interface; an inspection database including an aggregation of inspection data; and a controller, including: a facility planning circuit structured to interpret a user facility visualization value in response to the visualization request value; a facility inspection data circuit structured to interpret the aggregation of inspection data in response to the user facility visualization value; a geographic depiction circuit structured to: determine a geographic display boundary and a hierarchical inspection presentation for at least one industrial facility positioned within the geographic display boundary in response to the user facility visualization value and the aggregation of inspection data; and determine a user geographic display value in response to the geographic display boundary and the hierarchical inspection presentation; and wherein the user interface component is further structured to provide the user geographic display value to the user interface.

In some aspects, the techniques described herein relate to a system, including: a facility visualization and planning platform including: a user interface component configured to implement a user interface, and to receive a visualization request value from user operations on the user interface; an inspection database including an aggregation of inspection data; and a controller, including: a facility planning circuit structured to interpret a view based user facility visualization value in response to the visualization request value; a facility inspection data circuit structured to interpret the aggregation of inspection data in response to the view based user facility visualization value; a geographic depiction circuit structured to: determine a view based geographic display boundary and a view based hierarchical inspection presentation for at least one industrial facility positioned within the view based geographic display boundary in response to the view based user facility visualization value and the aggregation of inspection data; and determine a view based user geographic display value in response to the view based geographic display boundary and the view based hierarchical inspection presentation; and wherein the user interface component is further configured to provide the view based user geographic display value to the user interface.

In some aspects, the techniques described herein relate to a system, including: a facility visualization and planning platform including: a user interface component configured to receive a user facility request value from a user interface; an inspection database including an aggregation of inspection data; and a controller, including: a facility inspection data circuit structured to interpret facility relevant data in response to the aggregation of inspection data and the user facility request value; a maintenance planning circuit structured to determine a maintenance schedule for at least one industrial facility in response to the facility relevant data; and a facility maintenance circuit structured to determine a maintenance schedule display value in response to the maintenance schedule and the facility relevant data; and wherein the user interface component is further structured to provide the maintenance schedule display value to the user interface.

In some aspects, the techniques described herein relate to a system, including: a facility visualization and planning platform including: a user interface component configured to receive a user facility request value from a user interface; an inspection database including an aggregation of inspection data; and a controller, including: a facility inspection data circuit structured to interpret facility relevant data in response to the aggregation of inspection data and the user facility request value; a CapEx planning circuit structured to determine a capital expenditure plan for at least one industrial facility in response to the facility relevant data; and a facility capital circuit structured to determine a capital expenditure display value in response to the capital expenditure plan and the facility relevant data; and wherein the user interface component is further structured to provide the capital expenditure display value to the user interface.

In some aspects, the techniques described herein relate to a system, including: a facility visualization and planning platform including: a user interface component configured to receive a user facility request value from a user interface; an inspection database including an aggregation of inspection data; and a controller, including: a facility inspection data circuit structured to interpret facility relevant data in response to the aggregation of inspection data and the user facility request value; an inspection planning circuit structured to determine an inspection schedule for at least one industrial facility in response to the facility relevant data; and a facility inspection circuit structured to determine an inspection schedule display value in response to the inspection schedule and the facility relevant data; and wherein the user interface component is further structured to provide the inspection schedule display value to the user interface.

In some aspects, the techniques described herein relate to a system, including: a facility visualization and planning platform including: a user interface component configured to receive a user facility request value from a user interface; an inspection database including an aggregation of inspection data; and a controller, including: a facility inspection data circuit structured to interpret facility relevant data and offset facility data in response to the aggregation of inspection data; an inspection planning circuit structured to determine an inspection schedule for at least one industrial facility in response to the facility relevant data and the offset facility data; and a facility inspection circuit structured to determine an inspection schedule display value in response to the inspection schedule and the facility relevant data; and wherein the user interface component is further structured to provide the inspection schedule display value to the user interface.

In some aspects, the techniques described herein relate to a system, including: a facility visualization and planning platform including: a user interface component configured to implement a user interface, and to receive a visualization request value from user operations on the user interface; an inspection database including an aggregation of inspection data; and a controller, including: a facility planning circuit structured to interpret a user facility visualization value in response to the visualization request value; a facility inspection data circuit structured to interpret the aggregation of inspection data in response to the user facility visualization value; and a geographic depiction circuit structured to: determine a geographic display boundary and a facility inspection presentation for at least one industrial facility positioned within the geographic display boundary in response to the user facility visualization value and the aggregation of inspection data; and determine a user geographic display value in response to the geographic display boundary and the facility inspection presentation; and wherein the user interface component is further structured to provide the user geographic display value to the user interface.

In some aspects, the techniques described herein relate to a system, including: a facility visualization and planning platform including: a user interface component configured to implement a user interface, and to receive a visualization request value from user operations on the user interface; an inspection database including an aggregation of inspection data; and a controller, including: a facility planning circuit structured to interpret a user facility visualization value in response to the visualization request value; a facility inspection data circuit structured to interpret the aggregation of inspection data in response to the user facility visualization value; and an inspection surface depiction circuit structured to: determine a facility inspection presentation for at least one industrial facility in response to the user facility visualization value and the aggregation of inspection data; and determine an inspection surface display value for at least one component of the at least one industrial facility in response to the facility inspection presentation; and wherein the user interface component is further structured to provide the inspection surface display value to the user interface.

In some aspects, the techniques described herein relate to a system, including: a facility visualization and planning platform including: a user interface component configured to implement a user interface, and to receive a visualization request value from user operations on the user interface; an inspection database including an aggregation of inspection data; and a controller, including: a facility inspection data circuit structured to interpret the aggregation of inspection data in response to the visualization request value; and a facility monitoring circuit structured to: determine a facility event value for at least one industrial facility in response to the visualization request value and the aggregation of inspection data; and determine an event display value for at least one component of the at least one industrial facility in response to the facility event value; and wherein the user interface component is further structured to provide the event display value to the user interface.

In some aspects, the techniques described herein relate to a system, including: a facility visualization and planning platform including: a user interface component configured to implement a user interface, and to receive a visualization request value from user operations on the user interface; an inspection database including an aggregation of inspection data associated with a first inspection entity, and additional facility data; and a controller, including: a facility inspection data circuit structured to interpret the aggregation of inspection data in response to the visualization request value; and a facility monitoring circuit structured to determine a facility display value in response to the aggregation of inspection data, the facility display value determined in response to the inspection data and the additional facility data; and wherein the user interface component is further structured to provide the facility display value to the user interface.

In some aspects, the techniques described herein relate to a system, including: a facility visualization and planning platform including: a user interface component configured to implement a user interface, to receive a visualization request value from user operations on the user interface, and to receive facility annotation values from user operations on the user interface; an inspection database including an aggregation of inspection data; and a controller, including: a facility visualization circuit structured to interpret an equipment visualization value for equipment positioned at an industrial facility in response to the visualization request value; and a facility review circuit structured to: determine annotation markings in response to the facility annotation values; determine a facility display value in response to the equipment visualization value and the facility annotation values; and wherein the user interface component is further configured to provide the facility display value to the user interface.

In some aspects, the techniques described herein relate to a system, including: a facility visualization and planning platform including: a user interface component configured to implement a user interface, to receive a visualization request value from user operations on the user interface, and to receive analytical review communications from user operations on the user interface; an inspection database including an aggregation of inspection data; and a controller, including: a facility inspection data circuit structured to interpret facility relevant data in response to the aggregation of inspection data and the analytical review communications; and a facility analysis circuit structured to determine a facility display value in response to the facility relevant data and the analytical review communications; and wherein the user interface component is further structured to provide the facility display value to the user interface.

### BRIEF DESCRIPTION OF THE FIGURES

FIG. 1 is a schematic diagram illustrating an example system for inspection visualization and planning operations, according to certain embodiments of the present disclosure.

FIG. 2 depicts example inspection data values, according to certain embodiments of the present disclosure.

FIG. 3 example data structure for inspection data, according to certain embodiments of the present disclosure.

FIG. 4 depicts an example geographic visualization, according to certain embodiments of the present disclosure.

FIG. 5 depicts another example geographic visualization, according to certain embodiments of the present disclosure.

FIG. 6 depicts an example data depiction visualization, according to certain embodiments of the present disclosure.

FIG. 7 depicts another example data depiction visualization, according to certain embodiments of the present disclosure.

FIG. 8 is a schematic diagram illustrating an example interaction of a visualization component, according to certain embodiments of the present disclosure.

FIG. 9 is a schematic diagram illustrating another example interaction of a visualization component, according to certain embodiments of the present disclosure.

FIG. 10 depicts example plan outputs, according to certain embodiments of the present disclosure.

FIG. 11 depicts an example geographic visualization, according to certain embodiments of the present disclosure.

FIG. 12 depicts an example geographic visualization and display, according to certain embodiments of the present disclosure.

FIG. 13 depicts another example geographic visualization and display, according to certain embodiments of the present disclosure.

FIG. 14 depicts another example geographic visualization and display, according to certain embodiments of the present disclosure.

FIG. 15 depicts another example geographic visualization and display, according to certain embodiments of the present disclosure.

FIG. 16 depicts another example geographic visualization and display, according to certain embodiments of the present disclosure.

FIG. 17 depicts an example visualization of the top of a facility component and display data, according to certain embodiments of the present disclosure.

FIG. 18 depicts an example visualization of the side of a facility component and display data, according to certain embodiments of the present disclosure.

FIG. 19 depicts another example visualization of the side of a facility component and display data, according to certain embodiments of the present disclosure.

FIG. 20 depicts another example visualization of the side of a facility component and display data, according to certain embodiments of the present disclosure.

FIG. 21 depicts another example visualization of the side of a facility component and display data, according to certain embodiments of the present disclosure.

FIG. 22 depicts another example visualization of the side of a facility component and display data, according to certain embodiments of the present disclosure.

FIG. 23 schematically depicts an embodiment to a facility visualization and planning platform, according to certain embodiments of the present disclosure.

FIG. 24 schematically depicts an embodiment to a controller, according to certain embodiments of the present disclosure.

FIG. 25 is a schematic diagram illustrating hierarchy options, according to certain embodiments of the present disclosure.

FIG. 26 is another schematic diagram illustrating hierarchy options, according to certain embodiments of the present disclosure.

FIG. 27 depicts example display and navigation controls, according to certain embodiments of the present disclosure.

FIG. 28 depicts example user geographic display values, according to certain embodiments of the present disclosure.

FIG. 29 depicts example user operations, according to certain embodiments of the present disclosure.

FIG. 30 schematically depicts an embodiment to a controller, according to certain embodiments of the present disclosure.

FIG. 31 depicts example user display values, according to certain embodiments of the present disclosure.

FIG. 32 schematically depicts an embodiment to a controller, according to certain embodiments of the present disclosure.

FIG. 33 depicts example facility relevant data, according to certain embodiments of the present disclosure.

FIG. 34 depicts example operations to determine a maintenance schedule, according to certain embodiments of the present disclosure.

FIG. 35 depicts example aspects of a maintenance schedule, according to certain embodiments of the present disclosure.

FIG. 36 depicts example user notifications, according to certain embodiments of the present disclosure.

FIG. 37 depicts example operation to determine maintenance notification values, according to certain embodiments of the present disclosure.

FIG. 38 depicts example operations to determine maintenance sensitivity values, according to certain embodiments of the present disclosure.

FIG. 39 schematically depicts an embodiment to a controller, according to certain embodiments of the present disclosure.

FIG. 40 depicts example aspects of a capital expenditure plan, according to certain embodiments of the present disclosure.

FIG. 41 depicts example aspects of operations for determining a capital expenditure plan, according to certain embodiments of the present disclosure.

FIG. 42 schematically depicts an embodiment to a controller, according to certain embodiments of the present disclosure.

FIG. 43 depicts example aspects of an inspection schedule, according to certain embodiments of the present disclosure.

FIG. 44 depicts example aspects of operations to determine an inspection schedule, according to certain embodiments of the present disclosure.

FIG. 45 depicts example aspects of operations to determine an inspection notification value, according to certain embodiments of the present disclosure.

FIG. 46 depicts example aspects of operations to determine an inspection sensitivity value, according to certain embodiments of the present disclosure.

FIG. 47 depicts example aspects of facility presentation options, according to certain embodiments of the present disclosure.

FIG. 48 depicts example aspects of a facility indicator, according to certain embodiments of the present disclosure.

FIG. 49 depicts example aspects of an inspection data indicator, according to certain embodiments of the present disclosure.

FIG. 50 depicts example operations to provide a user geographic display value, according to certain embodiments of the present disclosure.

FIG. 51 schematically depicts an embodiment to a controller, according to certain embodiments of the present disclosure.

FIG. 52 depicts example aspects of an inspection surface display value, according to certain embodiments of the present disclosure.

FIG. 53 depicts example aspects of an inspection data overlay value, according to certain embodiments of the present disclosure.

FIG. 54 schematically depicts an embodiment to a controller, according to certain embodiments of the present disclosure.

FIG. 55 depicts example aspects of facility event values, according to certain embodiments of the present disclosure.

FIG. 56 depicts example aspects of event display values, according to certain embodiments of the present disclosure.

FIG. 57 depicts example aspects of an event type indicator, according to certain embodiments of the present disclosure.

FIG. 58 depicts example aspects of additional facility data, according to certain embodiments of the present disclosure.

FIG. 59 schematically depicts an embodiment to a controller, according to certain embodiments of the present disclosure.

FIG. 60 depicts example aspects of annotation markings, according to certain embodiments of the present disclosure.

FIG. 61 depicts example aspects of a facility display value, according to certain embodiments of the present disclosure.

FIG. 62 depicts other example aspects of a facility display value, according to certain embodiments of the present disclosure.

FIG. 63 schematically depicts an embodiment to a controller, according to certain embodiments of the present disclosure.

FIG. 64 depicts example aspects of analytical review communications, according to certain embodiments of the present disclosure.

FIG. 65 depicts other example aspects of analytical review communications, according to certain embodiments of the present disclosure.

FIG. 66 depicts example aspects of an overlay selection, according to certain embodiments of the present disclosure.

FIG. 67 depicts other example aspects of an overlay selection, according to certain embodiments of the present disclosure.

FIG. 68 depicts example aspects of statistical analysis selection, according to certain embodiments of the present disclosure.

FIG. 69 depicts example aspects of context selection, according to certain embodiments of the present disclosure.

### DETAILED DESCRIPTION

Industrial facilities and equipment of various types utilize inspection operations, without limitation, as a part of ongoing facility maintenance, to ensure proper operation, to avoid downtime due to failures, to determine whether maintenance or repair is indicated, and/or to comply with regulatory requirements. Aspects of the present disclosure provide for systems, methods, and apparatuses to provide integrated inspection information with the facility purpose, for example ongoing business operations of the business, which provide additional value for the inspection operations and data to support improved business outcomes, such as reduced maintenance costs, reduced repair costs, reduced downtime, improved operational outcomes, improved return on capital investment, and improved ancillary operations related to the facilities (e.g., supporting operations, future capacity planning, and/or coordination between facilities).

Certain aspects herein are referenced as a related group, for example a related group of facilities, a related group of inspection results, or the like. A related group, as utilized herein, should be understood broadly. A related group may be related by any concept of interest, including for example: facility type; owning, managing, and/or operating entity; entity type; geographical relationship; jurisdictional relationship; inspection type; type of sensors utilized; inspection entity; a processing stream (e.g., facilities, equipment, and/or processes coordinating to support a flow of products and/or services, for example where those products and/or services may pass between entities and/or facilities throughout the course of the process); and/or a workflow.

Example embodiments herein may be enhanced by leveraging inspection data that is collected by inspection robots having features such as: multiple sensors utilized to enhance the quality and/or speed of inspection operations; position based inspection data allowing for correlation of inspection data to specific facilities, equipment, and/or locations on the equipment; automated and/or controlled positioning for the inspection robot to facilitate rapid inspection, high confidence coverage of inspection surfaces, and chain of custody for inspection data to inspected surface condition; and/or highly configurable inspection robots allowing for rapid configuration and/or customization of the inspection robot to facilitate inspection characteristics (e.g., sensor types, geometric configuration, inspection data processing, etc.) utilized for inspection operations. In certain embodiments, the utilization of such inspection robots provides for enhanced data that is valuable to the visualization, planning, and response operations herein, as well as providing for inspection operations that are affordable, rapid, and/or provide data that is readily available for operations herein. Data that is readily available for operations herein may include any one or more aspects such as: data that is available for operations (e.g., electronically stored, formatted, etc. for utilization in operations herein); data that is of a high quality (e.g., data that sufficiently characterizes the conditions being detected, such as corrosion, wall thickness, weld condition, etc.); and/or data that is configured for operations (e.g., correlated to position on the inspection surface, having checks to ensure proper calibrations and/or processing were performed, available for further processing and/or reprocessing, having appropriate time stamps that allow integration into operations herein such as determining the utilization of the equipment at the time of inspection). Example inspection robots that may be utilized to support operations herein include, without limitation, any inspection robots as described in, and/or inspection robots having one or more aspects described in, U.S. patent application Ser. No. 15/853,391 entitled INSPECTION ROBOT WITH COUPLANT CHAMBER DISPOSED WITHIN SLED FOR ACOUSTIC COUPLING (GROB-0003-U01), U.S. patent application Ser. No. 16/387,237 entitled INSPECTION ROBOT FOR HORIZONTAL TUBE INSPECTION HAVING VERTICALLY POSITIONABLE SENSOR CARRIAGE (GROB-0006-U01), U.S. patent application Ser. No. 16/813,701 entitled INSPECTION ROBOT WITH STABILITY ASSIST DEVICE (GROB-0007-U01), U.S. patent application Ser. No. 17/726,336 entitled SYSTEMS, METHODS, AND APPARATUS FOR ULTRA-SONIC INSPECTION OF A SURFACE (GROB-0008-U01), and/or PCT Patent Application No. PCT/US2022/023993 entitled FLEXIBLE INSPECTION ROBOT (GROB-0010-WO); each one of the foregoing applications are incorporated herein by reference in the entirety for all purposes. Without limitation to any other aspect of the present disclosure, inspection data may be collected in any manner, including by inspection robots as described herein, inspection data provided by any other inspection robot, inspection data provided by manual inspection operations, inspection data provided by any previously known system, inspection data provided by any source including unknown sources, and combinations of any one or more of these.

Facilities as utilized herein include any type of facility that utilizes, or that can utilize, inspection operations as a part of installation, ongoing operations, replacement, and/or deprecation of the facility. Inspected equipment includes, without limitation, any type of equipment utilized at a facility having an aspect that is inspected, for example cooling towers, tanks, pipes, containers, boilers, mixers, and/or welds.

Without limitation to any other aspect of the present disclosure, embodiments herein may utilize any type of inspection data, especially but not limited to inspection data indicating a condition of inspected equipment at a facility, such as flow data, composition data, temperature data, pressure data, vibration data, utilization data, or the like. Inspection data may include direct equipment condition detection (e.g., wall thickness values, corrosion values, crack detection values, etc.), and/or inferred equipment condition detection (e.g., flow or throughput values, temperature values, vibration values, etc.), where the inferral may be based on inferred equipment condition (e.g., indicators of potential degradation of the equipment) and/or inferred utilization of the equipment (e.g., to be utilized in a wear, degradation, and/or failure model of the equipment).

Embodiments herein utilize inspection data, but may further include other data utilized to characterize facilities, equipment, and/or related groups of these. For example, maintenance data, capital investment data, production data, compliance data (e.g., regulatory, policy, and/or industry standard information), sales data, shutdown impact data, supply chain data (e.g., related process streams affected by facilities and/or equipment herein, including suppliers affecting inputs and/or consumers utilizing outputs of the facilities and/or equipment herein), and/or entity data (e.g., owners, operators, managers, etc., of facilities, equipment, and/or supply chain stakeholders). In certain embodiments, the other data may form the majority of the entire corpus of data utilized to perform operations herein. In certain embodiments, inspection data forms the majority of the entire corpus of data utilized to perform operations herein, with the other data limited to data utilized to form related groups. In certain embodiments, inspection data forms the entirety of the entire corpus of data utilized to perform operations herein, for example with the related groups inferred according to user interactions, based upon interaction parameters (e.g., identifying a user login, user device, user access location, etc. to determine the related groups for operations herein). Without limitation to any other aspect of the present disclosure, operations herein may utilize any mix of inspection data and other data, as long as at least one aspect of inspection data is utilized by the operations.

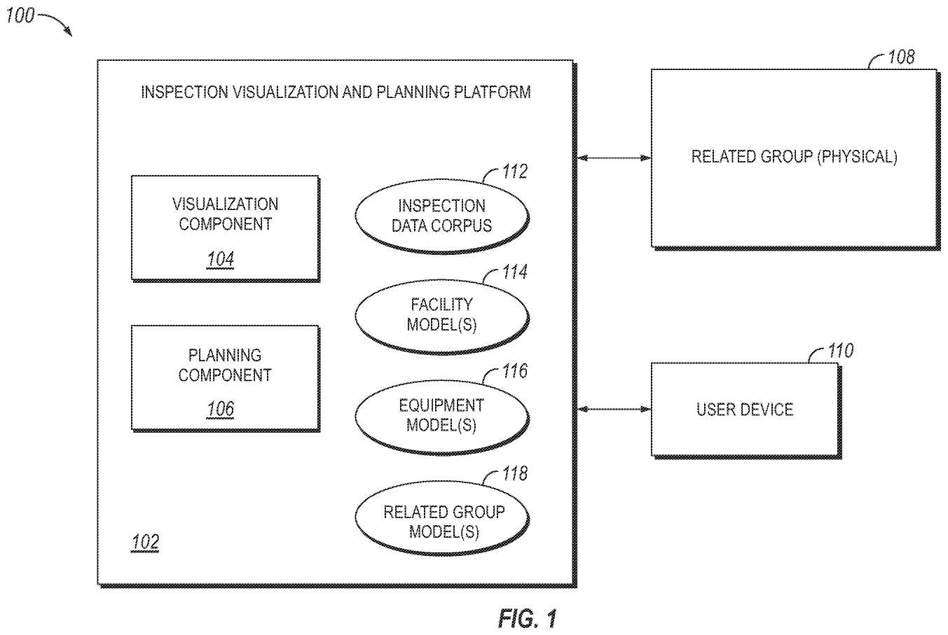

Referencing FIG. 1, an example system for inspection visualization and planning operations is schematically depicted. The example system includes an inspection visualization and planning platform 102. The inspection visualization and planning platform 102 is depicted as a single device for clarity of the present description, but may be distributed, in whole or part, among a number of devices. One or more aspects depicted in the example of FIG. 1 may be omitted in certain embodiments. The example platform includes a visualization component 104 and a planning component 106. Each component may be embodied as: a controller configured to perform one or more operations of the component; a computing device including a processor, memory, and/or other hardware devices such as network communication devices, input/output devices, and/or display devices; as computer readable instructions configured to perform one or more operations of the component when executed by a processor; as a circuit including hardware configured to cooperate to perform one or more operations of the component; and/or combinations of one or more of the foregoing. The components may be positioned, in whole or part, on the same device (e.g., as depicted in the example of FIG. 1) and/or on separate devices, and/or a given component may be distributed across more than one device. In certain embodiments, an aspect of the component may be embodied on a first device at a first time and/or operating condition, and on another device at another time and/or operating condition. In certain embodiments, aspects of a component may be positioned on a user device 110 (e.g., as an application positioned on the device, which may be installed temporarily and/or as a long term installation), on a facility 108 forming a part of the system (e.g., as a sensor positioned at the facility, as a network communication device at the facility, and/or as a part of a computing device positioned at the facility). In certain embodiments, the platform 102 and/or components thereof communicate with other devices in the system 100, such as the facility 108, the user device 110, and/or inspection devices (not shown, e.g., an inspection robot, an inspection database at least selectively accessible to the platform, etc.) by any communication means, such as internet communication, through a WAN, through a LAN, via cellular communications, via WiFi communications, or the like. Such communications between devices of the system are capable to implement user interfaces, pass commands between devices, and/or pass any data values set forth in the present disclosure between devices.

All operations set forth herein may be implemented using a permissions and/or authorization scheme, for example limiting users to access data limited for the user, for example based on the user's role (e.g., operator, manager, administrator, financial personnel, etc.), an entity related to the user (e.g., a company that employs the user), permissions set by an administrator of the platform, and/or permissions set within an organization associated with the user (e.g., a manager, an administrator, a legal officer, a compliance officer, etc.). Implementation of a permissions and/or authorization scheme may include one or more of: limiting access to the platform and/or to information on the platform according to login operations, filtering information according to the permissions, requesting additional authorization to requested information (e.g., notifying another user, administrator, and/or manager of the user that the information is requested, and/or allowing the other user, administrator, and/or manager to approve the access), limiting information that is available to be requested, or the like.

In certain embodiments, the platform 102 and/or aspects thereof may be implemented as a cloud service, through a mobile application, and/or through a dedicated application (e.g., an application installed locally on a user device that interfaces with the platform). In certain embodiments, aspects of user interfaces implemented herein are implemented as a web based application, mobile application, dedicated software application, or the like. In certain embodiments, aspects of user interfaces implemented herein are implemented through an application programming interface (API), for example allowing a user to configure an application to access inspection visualization and/or planning operations utilizing the components of the platform, and/or to configure an application for other consumer users, where the consumer users utilize the application for inspection visualization and/or planning operations as configured by the building user.

The example system includes a user device 110, such as a mobile device and/or a computing device (e.g., a terminal, laptop, desktop, etc.). The user device 110 may be the same or a separate device for different users, and/or the same or a separate device for a same user. For example, two users may utilize a single computing device, which may be considered a first user device for a first user (e.g., logging in to an application on the computing device with login information corresponding to the first user) and a second user device for a second user (e.g., logging in to the application on the computing device with login information corresponding to the second user). In another example, a user may access the platform 102 on a first device 110 at a first time, and a second device 110 at a second time—for example depending upon where the user is located, which devices are available to the user, and/or which operations are being performed (e.g., accessing visualizations on a first hardware device, performing planning operations on a second hardware device, and receiving notifications on a third hardware device), where each relevant hardware device is considered a user device for that user at each access scenario.

The example system includes a related group (physical), for example representing the relevant facilities, plants, equipment, or the like, that is inspected, contemplated for inspection, and/or related to the business operations of inspected equipment. The physical devices represented in the related group may vary according to aspects of the accessing user, entities related to the user, and/or operations being performed on the platform. For example, visualization operations may include a first group of related devices, where planning operations may include a second group of related devices (and/or multiple groups of related devices), depending upon selections by the user, aspects of the user, permissions of the user, the type of information being visualized and/or planned, or the like. Without limitation to any other aspect of the present disclosure, a user at a first time may perform visualization operations for inspected pipes for a group of facilities (e.g., facilities in a geographic region, facilities related to a particular flow of products and/or services, etc.), which would include the equipment that is inspected, and/or may further include equipment that is available for inspection but may not have yet been inspected. The user at a second time may perform visualization operations for a particular flow of products and/or services, which may include some of the equipment from the first group, but which may not include all of the equipment from the first group. The user at a third time may perform planning operations for a particular flow of products and/or services, which may have a related group that has some overlap with the first group and/or second group, but which may have additional equipment in the related group, and/or omit some equipment from the related group. The examples are provided in the context of a single user, but the concepts are provided for clarity, and apply to other users—for example a first user performing visualization operations on pipes for a group of facilities may work with a different related group from a second user performing visualization operations on pipes for the same group of facilities, for example based on the roles, responsibilities, and/or permissions of the first and second users.

An example visualization component 104 is configured to access a corpus of inspection data values 112 (e.g., an aggregation of inspection data 2410, and/or including additional data related to facilities, workflows, entities, or the like), for example inspection data that has been collected for equipment of the related group, which includes data that will be utilized to provide visualizations of inspection operations for the facilities of the related group. The corpus of inspection data values 112 is depicted on the platform 102, but may additionally or alternatively be accessible to the platform 102 (e.g., on a cloud server), and/or which may be distributed in more than one location and/or on more than one device. The visualization component 104 is configured to implement a user interface, for example on a user device, allowing users to create, access, update, and/or modify visualizations for the related group, and/or to adjust the related group (e.g., selecting facilities and/or equipment of interest for the visualization). The related group may be selected according to geography (e.g., a state or country, and/or a position related description such as a geofenced region, a distance related region, or the like), and/or in a logical arrangement (e.g., facilities and/or equipment related to a particular flow of products and/or services, to support a particular customer, associated with a specific business unit, that processes material from a particular supplier, etc.). A visualization of inspection outcomes may include any visualization (e.g., any user display value 2314) as set forth herein, including at least an overview of inspections performed, the status of equipment (e.g., wall thickness of a pipe, tank, or the like), the expected lifetime of equipment (e.g., until maintenance and/or repair operations, and/or a global lifetime of the equipment), the capacity of the equipment (e.g., limitations to pressure, temperature, fill levels, or the like based upon the inspection information), time until a next inspection operation is planned and/or scheduled, etc. In certain embodiments, visualizations may include quantitative information (e.g., overlaid numbers, graphs, etc. that can be correlated to specific values) and/or qualitative information (e.g., color overlays, pattern overlays, categorical descriptions such as good, bad, suspect, unknown, failed, etc.). In certain embodiments, resolution of the visualization is selectable, ranging from a single visualization for a facility or equipment device (e.g., an average, other statistical description, worst-case value, etc.), bucketed information (e.g., a descriptive value for each bucket, where the buckets may be based on any parameter, such as: distance, for example a value for each meter of the equipment or facility; time, for example a value for each day, month, week, year, etc. of the equipment or facility; utilization, for example a value for each 1,000 gallons, MWh, etc. passing through, utilized by, and/or generated by the equipment or facility, etc.; and/or combinations of these), full resolution available based on the inspection data available (e.g., 1 mm data where the inspection resolution included 1 mm resolution), and/or increased resolution such as interpolated data between inspection points, estimated data for missing inspection information, or the like. In certain embodiments, estimated and/or interpolated information may be tagged for the user, for example visually on a visualization surface and/or within available metadata, reporting files, or the like, allowing the user to readily understand that such data is estimated and/or interpolated. The visualization settings may be configured by the user, by another user (e.g., a manager, administrator, quality control person, etc.), including the visualized information, the selected resolution, the type of visual display, and/or the utilization of and/or indication of estimated or interpolated data.

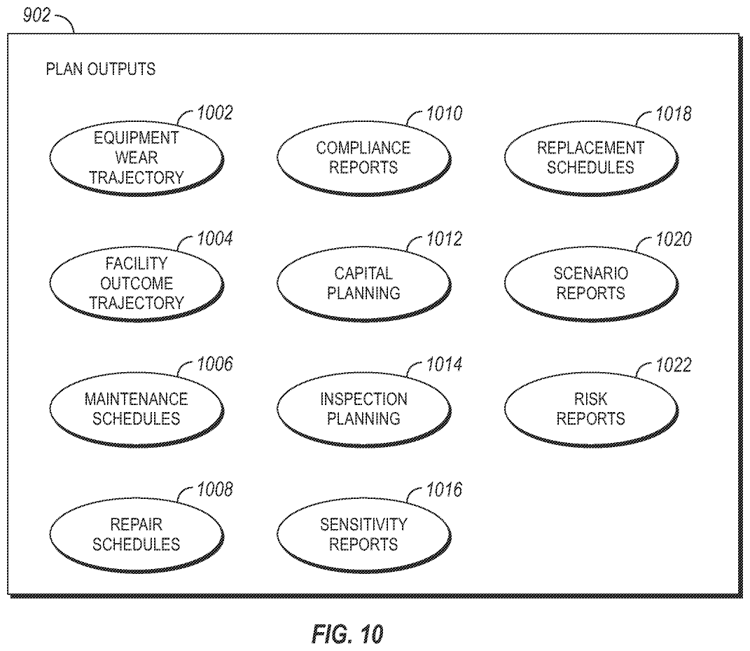

An example planning component 106 is configured to implement a user interface to allow a user to perform a number of planning operations, where the planning operations are based, at least in part, on inspection data available in the inspection data corpus. Referencing FIG. 10, example and non-limiting planning operations include providing a planning output 902 such as an equipment wear trajectory 1002 (e.g., the expected equipment wear over time and/or utilization going forward, for example: allowing for the planning of maintenance, repair, and/or replacement operations for equipment and/or facilities); facility outcome trajectory 1004 (e.g., determining the facility capacity, cost of operation, maintenance, replacement, and/or repair requirements, and/or effects of the facility changes on other related processes, product flows, and/or service flows due to changes in the facility); maintenance schedules 1006 (e.g., creating or adjusting maintenance activities, including determining how the activities affect other costs and/or capabilities such as equipment costs, operating costs, facility capacity, etc.); repair schedules 1008 (e g, similar to maintenance operations, but for repair of equipment, facilities, or the like); replacement schedules 1018 (e.g., similar to repair and/or maintenance, but for replacement of equipment and/or facilities, including whether the replacements have the same capability, or have improved or reduced capability, and/or whether replacement includes different equipment to replace the entire function—for example swapping a first fluid flow scheme with another fluid flow scheme, changing flow/storage relationships of fluids, changing reactor types, changing heat exchanger types, changing distillation column types, etc.); compliance reports 1010 (e.g., determining compliance of inspected equipment, including functional compliance such as maintaining required capability, or regulatory compliance such as having required inspection operations completed; and which may include how long compliance will be maintained using the current inspection, maintenance, replacement, and/or repair scheme, and/or effects of scheme adjustments on compliance and/or the compliance trajectory); capital planning 1012 (e.g., determining the timing, facility, and/or business unit relationships of future capital expenditures, the effects of scheme adjustments on capital expenditures, and/or operating cost tradeoffs with capital expenditures); inspection planning 1014 (e.g., adjusting inspection schedules, inspection types, inspection service providers, etc., and the effects of the inspection schedule and/or adjustments thereof to other aspects such as compliance, capital expenditures, operating costs, production capacity, and/or trajectories of these); sensitivity reports 1016 (e.g., determining any other aspects of the plan where small adjustments have large consequences and/or stochastic consequences, and/or basing the sensitivity determination on uncertainties of other parameters, such as inspection timing windows, cost estimates, etc., for example to highlight aspects of the overall plan where the outcomes of the plan may be strongly affected by occurrences that are not unlikely, and/or where particular aspects of the plan will require tight control for the planned outcomes to be successful, and/or which may include changing the plan to reduce sensitivity, even if the overall average outcome is not improved); scenario reports 1020 (e.g., adjusting some of the plan parameters through a range of values, determining outcomes for a number of plan schemes, or the like, and providing outcome reports for the various plans and/or the most promising plans, where promising plans include those with the best outcomes and/or least sensitive outcomes); and/or risk reports 1022 (e.g., indicating one or more aspects of the plan that may result in a deviation from planned or acceptable outcomes, for example monetary losses and/or reduced profits, non-compliant outcomes, loss of production, shutdown events, or the like, where the risks may be based on actual estimated outcomes from the plan, outcomes from plan deviations or disturbances, or the like). It will be seen that the inspection data informs the state of equipment, affects compliance of equipment and/or facilities, informs the trajectory of facility productivity, and interacts with other aspects of facilities. Accordingly, embodiments herein that integrate the inspection data into both visualization tools and overall facility and business planning, provide an improved outcome for facilities that rely upon industrial equipment that is subject to wear, corrosion, equipment failure, or the like, where improved outcomes relate to any aspect of the facility operation such as productivity, production capacity, loss of use, regulatory compliance, or the like.

Referencing FIG. 1, an example planning component 106 may utilize any one or more of a facility model 114 (e.g., modeling the effect of equipment within the facility on the mission of the facility, including the production capacity, relationship such as product flows within the facility, or the like, for example a liquor tank having a limited volume holding capacity, which may change over time in a predictable manner based upon inspection data, can change the capability of the facility to achieve the mission of the facility over time); an equipment model 116 (e.g., a model of the wear rate of the equipment, the effect of inspectable changes to the equipment on the capability of the equipment, or the like; in certain embodiments the model may incorporate aspects such as utilization of the equipment, utilization conditions such as temperature of operation, pressure of operation, composition of material processed by the equipment, and/or the current state of the equipment (e.g., where aged equipment may wear at a slower or faster rate than new equipment), manufacturer specifications for the equipment, or the like); and/or a related group model 118, for example a model that determines the effect of changes between facilities and/or equipment within the related group on other facilities and/or equipment within the related group (e.g., facility A having a reduced capacity affects dependent facility B that receives the output from facility A) and/or outputs of the related group (e.g., a model of the affect of changes in facilities or equipment within the group on the production capacity, cost of operation, etc. of the entire related group). In certain embodiments, operations to determine and/or evaluate a maintenance schedule 3206, an inspection schedule 4206, and/or a capital expenditure plan 3904, may incorporate, utilize, and/or access one or more of the models 114, 116, 118. In certain embodiments, the gross outputs of the related group model 118, and/or of a plan (e.g., the overall scheme for inspection, maintenance, repair, replacement, capital expenditure, etc.) are determined based on overall outcomes (e.g., production capacity, revenue, power generated, profit, etc.) and are utilized to determine the outcome of a plan herein, for example to iteratively improve and/or optimize the plan. In certain embodiments, other parameters of interest (e.g., lost production, lost power generation, compliance indicators, sensitivity indicators, risk indicators, an index value determined from any of these and/or one or more gross outputs) are determined from the related group model and/or the plan, and utilized to determine the outcome of a plan herein, for example to iteratively improve and/or optimize the plan.

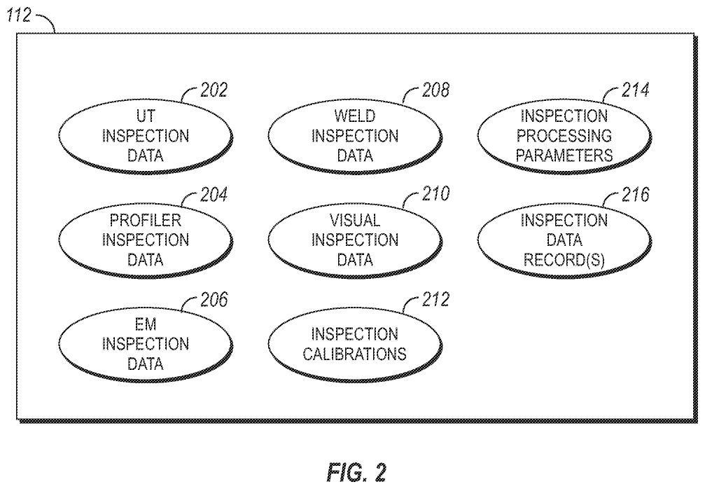

Referencing FIG. 2, example and non-limiting inspection data values 112 are schematically depicted. Example embodiments include any inspection data available as set forth herein. Example inspection data values include any one or more of: ultrasonic (UT) inspection data 202 (e.g., wall thickness values, crack detection, corrosion detection, etc.); weld inspection data 208 (e.g., data confirming the presence and/or quality of welds); profiler inspection data 204 (e.g., a laser profiler or other distance determiner, for example to determine high resolution geometric information for inspected surfaces); electromagnetic (EM) inspection data 206 (e.g., based on determination of the amount of ferromagnetic material, eddy current determinations, conductivity determinations, etc.); and/or visual inspection data 210 (e.g., data determined from camera based inspection data, including within the “visual” EM spectrum or offset spectrum data such as UV or infrared spectrum data). In certain embodiments, inspection data values 112 includes calibrations 212 utilized during inspection operations, for example allowing the platform to confirm that inspection operations were properly conducted, and/or to adjust calibrations for later processing of inspection information and/or for iterative improvement of inspection operations. In certain embodiments, inspection data values 112 includes inspection processing parameters 214, for example processing that was performed for certain inspection types—for example cutoff times, filters applied, etc., for example allowing the platform 102 to confirm that inspection operations were properly conducted, to test or correct processing operations in post-processing, and/or to adjust processing operations for iterative improvement of inspection operations. In certain embodiments, inspection data values 112 includes inspection data records 216, for example allowing for the platform 102 to utilize old inspection data (e.g., paper records, manual inspection data, etc.) and/or inspection data provided by inspection operations that are not directly communicatively coupled to the platform (e.g., inspection data provided by inspection service providers that do not digitally communicate inspection data to the platform, inspection data provided by a previous owner of a facility within the related group, etc.).

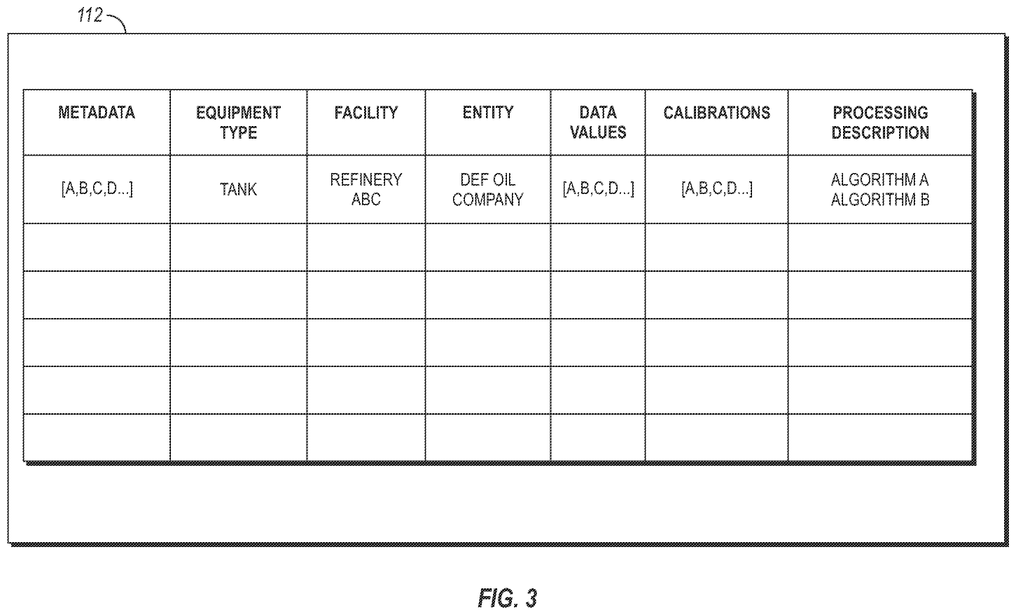

Referencing FIG. 3, an example data structure for inspection data values 112 is schematically depicted. The example inspection data of FIG. 3 is illustrative for clarity of the description, and the formatting, organization, etc. of the inspection data is not limited to the example. The example inspection data includes metadata (e.g., identifiers, time stamps, inspection providers, file names, etc.), equipment type (e.g., a tank, pipe, wall, etc.), a facility identifier, a related entity (e.g., an owner, operator, and/or manager of a facility), data values (e.g., the actual inspection data values, including raw data values and/or processed data values, and/or including position information allowing the inspection data values to the correlated to a position on the inspection surface); calibrations utilized; and/or processing operations, algorithms, and/or settings utilized. The example inspection data is a non-limiting example, and one or more aspects depicted may be omitted, additional aspects may be included, and/or the organization of the inspection data may be arranged in any manner.

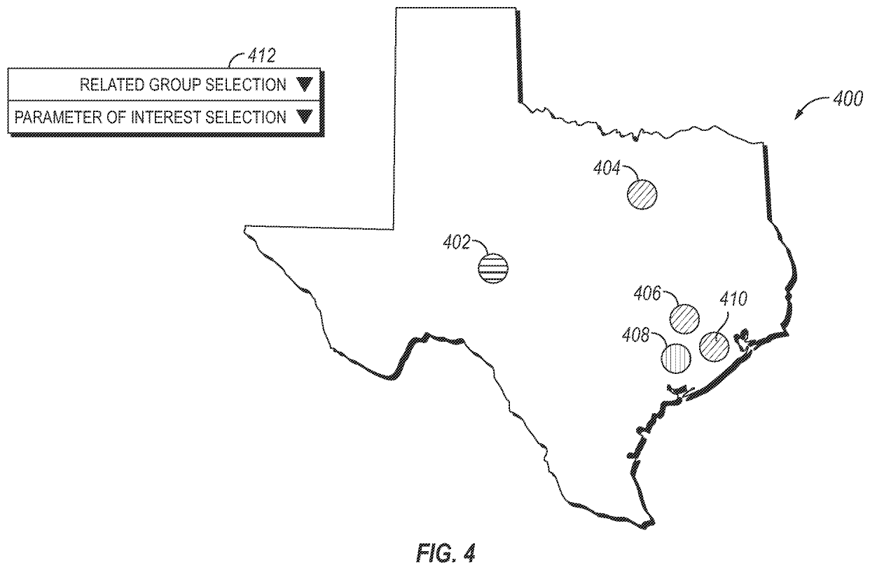

Referencing FIG. 4, an example visualization 400 is schematically depicted, which may be a user display value 2314. The example visualization 400 includes a related group of a particular facility type (e.g., refineries) in the state of Texas, as a non-limiting example to illustrate aspects of the present disclosure. In the example visualization, the provided user interface includes interaction elements 412 to allow a user to select the related group (e.g., a drop down may include equipment types, production types, facility types, business units, customers, etc., where the related group includes facilities and/or equipment responsive to the selection) and a parameter of interest selection (e.g., inspection parameters such as wall thickness values, and/or production parameters such as barrels of product produced). The example visualization depicts information for 5 relevant facilities 402, 404, 406, 408, 410, for example 5 refineries, 5 production lines, etc. In the example visualization 400, a top level visual element depicts a high level description of an outcome for each facility, for example utilizing a horizontal, vertical, or diagonal hatch pattern. The high level description of the outcome may be of any parameter of interest, for example an indication that some value is out of expected ranges, that the facility has a need for maintenance or repair, that production is within expectations, or the like. In certain embodiments, the high level description may include multiple parameters, and/or may utilize any high level marking desired, such as color coding, numerical values, size and/or shape of the facility marker, etc. In certain embodiments, the high level description may be omitted completely.

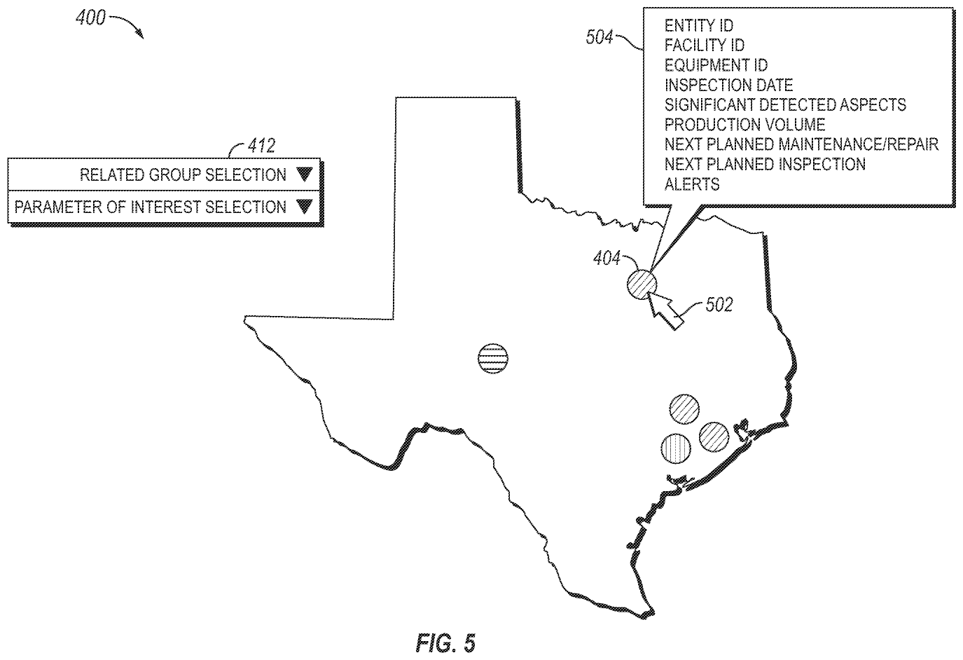

Referencing FIG. 5, an example visualization 400, consistent with certain embodiments of the visualization of FIG. 4, is schematically depicted. The example visualization of FIG. 5 includes an optional tooltip 504, for example implemented by hovering a user interaction element 502 (e.g., a mouse cursor) over a facility, where additional information selected using the optional tooltip 504 about the facility is then depicted. The utilization of selected additional information allows for the user to rapidly access additional configured information, which may include information such as a most recent inspection date, a next scheduled inspection date, any parameter of interest (e.g., according to thresholds and/or defined heuristics, such as equipment at the facility has deviations in inspection data, non-compliant equipment, equipment past a maintenance period, etc.), business related information such as total production (e.g., over a recent period, a production rate, etc.), any alerts related to the facility (e.g., including alerts that may have already been sent to a user), or the like. In certain embodiments, any information throughout the present disclosure may be provided as selected additional information, such as a plan description (e.g., “Inspection Plan A”), status information, compliance information, or the like. The selected additional information may be selected in any manner, for example by a full selection (e.g., a mouse click, Enter key, etc.), may be sent in an automated manner (e.g., periodic messaging, e-mail, and/or making the information available in a report), and/or may be omitted.

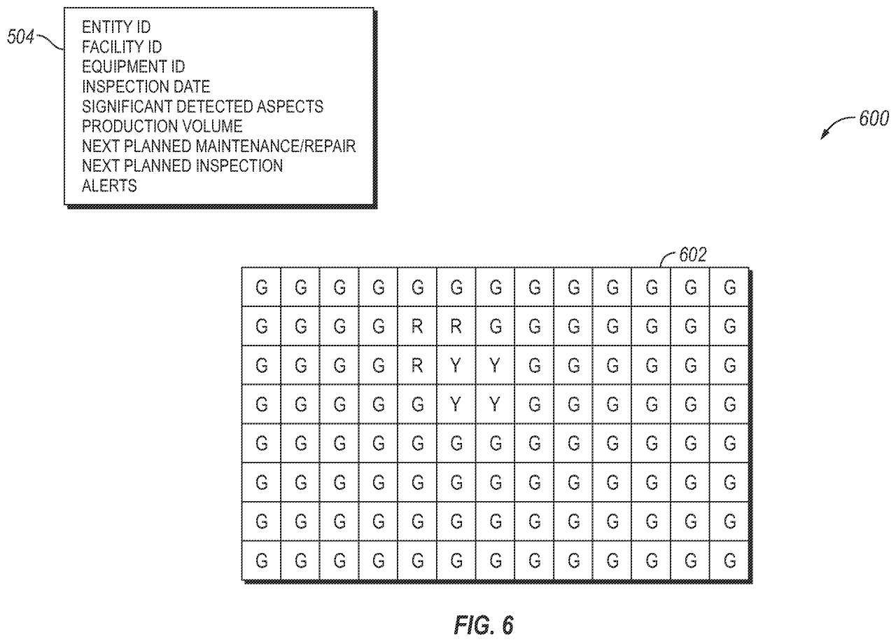

Referencing FIG. 6, another example visualization 600 is schematically depicted. The example visualization 600 is for a particular piece of equipment, for example a tank or pipe of a facility, which may be selected from a visualization such as that depicted in FIGS. 4-5, and/or which may be selected from a facility map (e.g., a facility map generated in response to selecting a facility on a visualization such as that depicted in FIGS. 4-5). The example of FIG. 6 schematically depicts a color coded inspection result 602 (e.g., R=red, G=green, Y=yellow) for the surface of the equipment, for example where the horizontal axis equates to the axial position on the pipe, and the vertical axis equates to the azimuthal position on the pipe. The display of FIG. 6 depicts a 2 dimensional display, which maps to the 3 dimensional inspection surface in a known manner. In certain embodiments, the display may be depicted in any manner, for example as a 3 dimensional perspective view, or the like. In certain embodiments, the selected resolution of the buckets (e.g., each region having a color coding) may be made in any manner, including grouping similar regions, providing regions consistent with inspection data resolution, or the like. The color coding may be based on threshold values (e.g., wall thickness thresholds), which may be adjustable by the user or another user. In certain embodiments, the coding may be quantitative (e.g., showing inspection values on the surface, instead of or in addition to color coding). In certain embodiments, other marking schemes may be utilized, for example with cross-hatching, representative shapes depicted in each region, or the like. In certain embodiments, selected additional information may be depicted in response to a focus (e.g., as a tool tip) and/or a selection of a region—including potentially any information from the inspection data (e.g., reference FIGS. 2-3) that is directly available or that can be inferred. In certain embodiments, the user may adjust the resolution and/or any of the visualization elements (e.g., marking schemes, selected additional information, etc.), and/or may adjust within permissions associated with the user. In certain embodiments, the user may adjust the depiction logic—for example whether the depiction is 2 dimensional or 3 dimensional, and/or the orientation of axes to the inspection surface. In certain embodiments, visualization may be overlaid onto a visual depiction (e.g., a model, photograph, schematic diagram, and or visual inspection data depicting the inspection surface) of the inspection surface and/or equipment embodying the inspection surface.

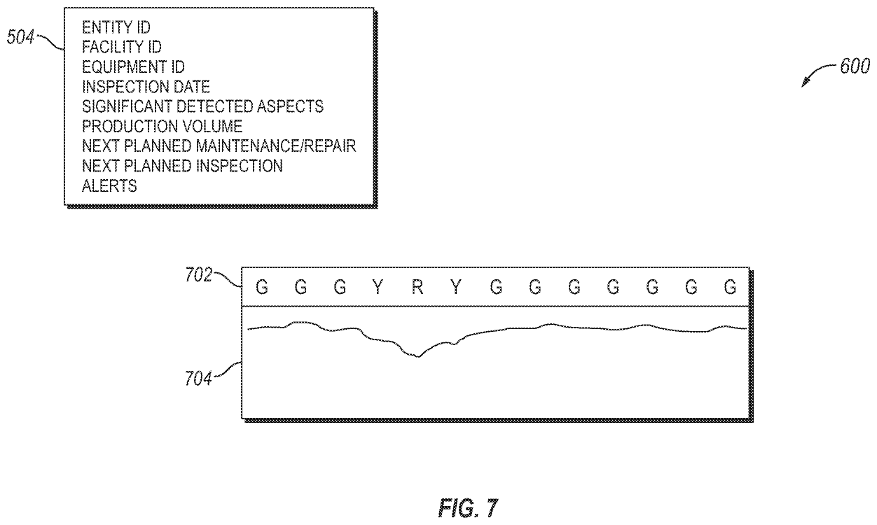

Referencing FIG. 7, a schematic depiction of a visualization 600 of inspection data is provided, which may be consistent with the depiction of FIG. 6 utilizing an alternative display paradigm. The example depiction includes a first visual element 702 indicating a categorical description of the inspection data (e.g., red/yellow/green), and a second visual element 704 indicating a quantitative description of the inspection data (e.g., a wall thickness graph). In the example of FIG. 7, the horizontal axis equates to the axial distance along a pipe, where the first visual element 702 indicates whether any azimuthal position of the pipe at that position has an issue (e.g., red indicating that at least one position has a wall thickness lower than a threshold value), and where the second visual element 704 indicates a statistical description of the inspection value at that axial position (e.g., an average wall thickness of the entire azimuthal range at that axial position). The selected data to display, and the display logic utilized in FIG. 7 are non-limiting examples.

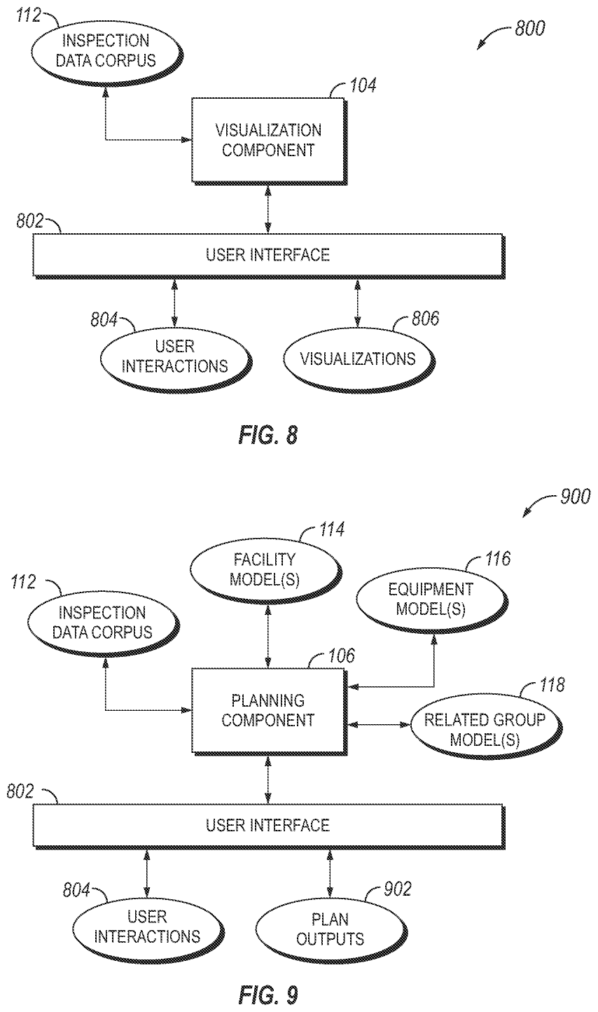

Referencing FIG. 8, an example interaction of the visualization component 104 with other aspects of an example system 800 is schematically depicted. The example visualization component 104 accesses a corpus of inspection data values 112, and implements a user interface 802 to provide a user with visualizations 806 (e.g., user display values 2314) of a facility, equipment, related group, or the like, in response to user interactions 804 (e.g. user operations) with the user interface.

Referencing FIG. 9, an example interaction of the planning component 106 with other aspects of an example system 900 is schematically depicted. The example planning component 106 accesses a[[n]] corpus of inspection data values 112, a facility model 114, an equipment model 116, and/or a related group model 118, and implements a user interface 802 to provide the user with plan outputs 902 (e.g., plan outcomes, sensitivity values, compliance values, risk values, etc.) in response to user interactions 804 with the user interface. Again referencing FIG. 10, example plan outputs 902 include one or more aspects such as: an equipment wear trajectory 1002 (e.g., an observed and/or predicted equipment wear trajectory); a facility outcome trajectory 1004; a maintenance schedule 1006; a repair schedule 1008; a compliance report 1010 (e.g., a description of compliance with a regulation and/or policy); a capital planning 1012 output; an inspection planning 1014 output; a sensitivity report 1016; a replacement schedule 1018 (e.g., for a maintenance schedule and/or an inspection schedule); a scenario report 1020 (e.g., comparing proposed changes for a maintenance schedule, an inspection schedule, and/or a capital expenditure plan, whether comparing multiple proposed change options, and/or a status quo option based on the current schedules or plans whether explicit or inferred); and/or a risk report 1022 output.

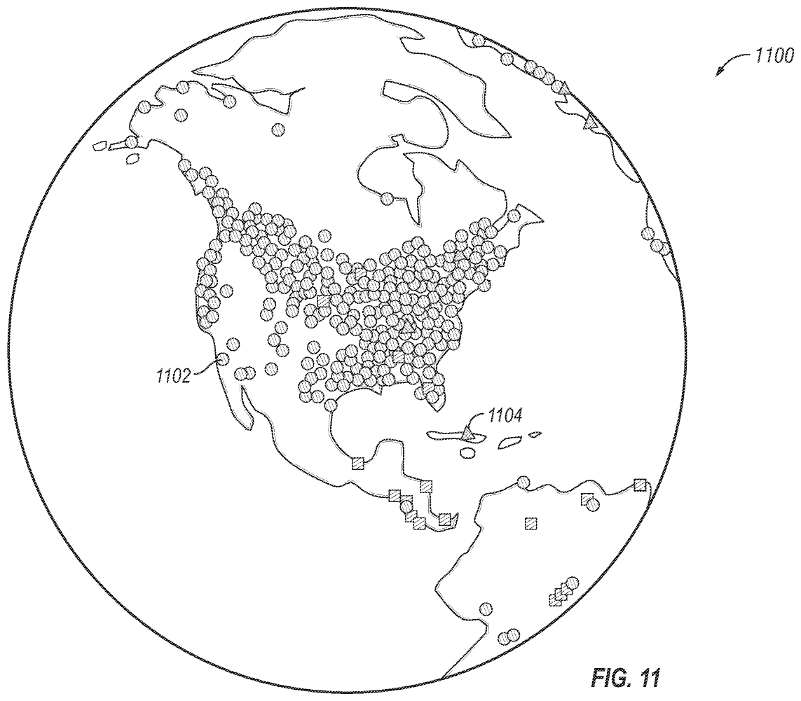

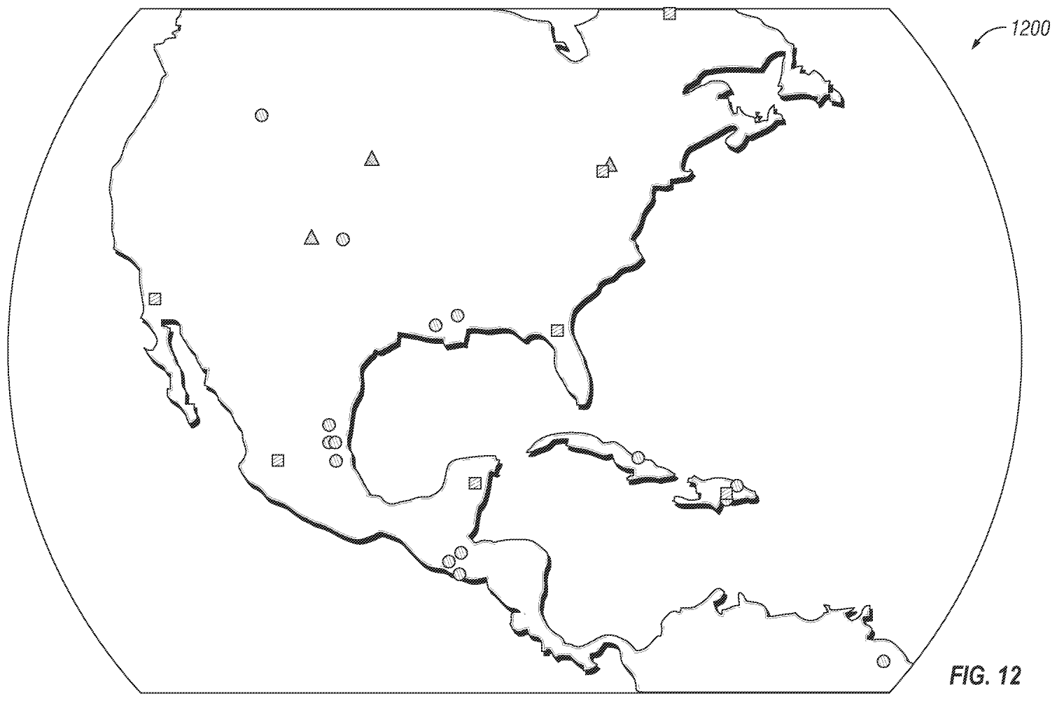

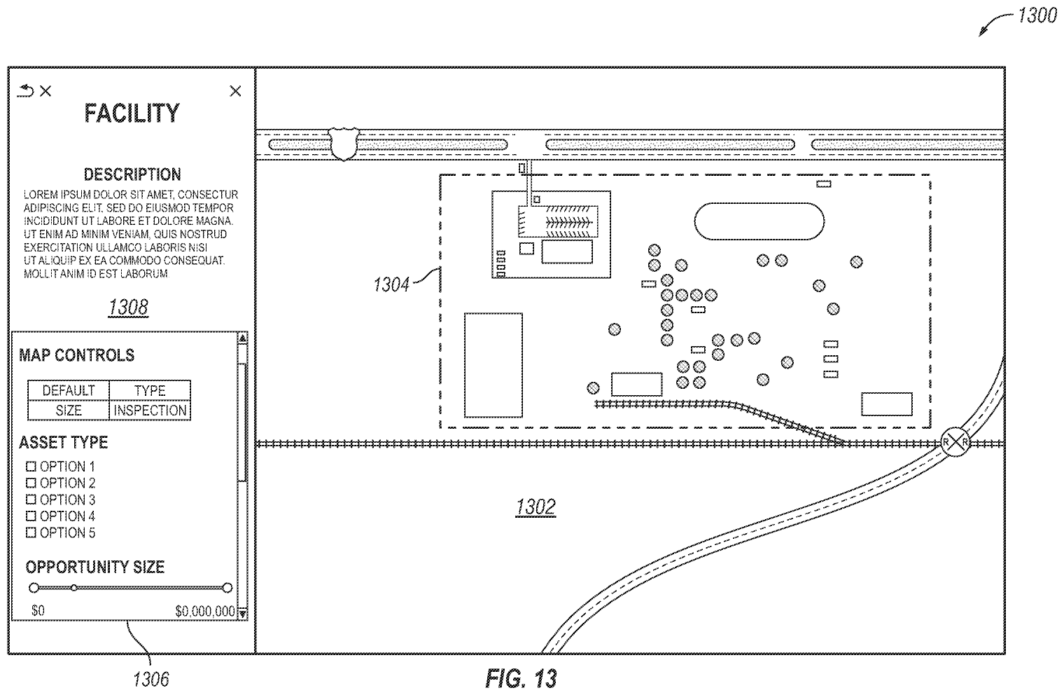

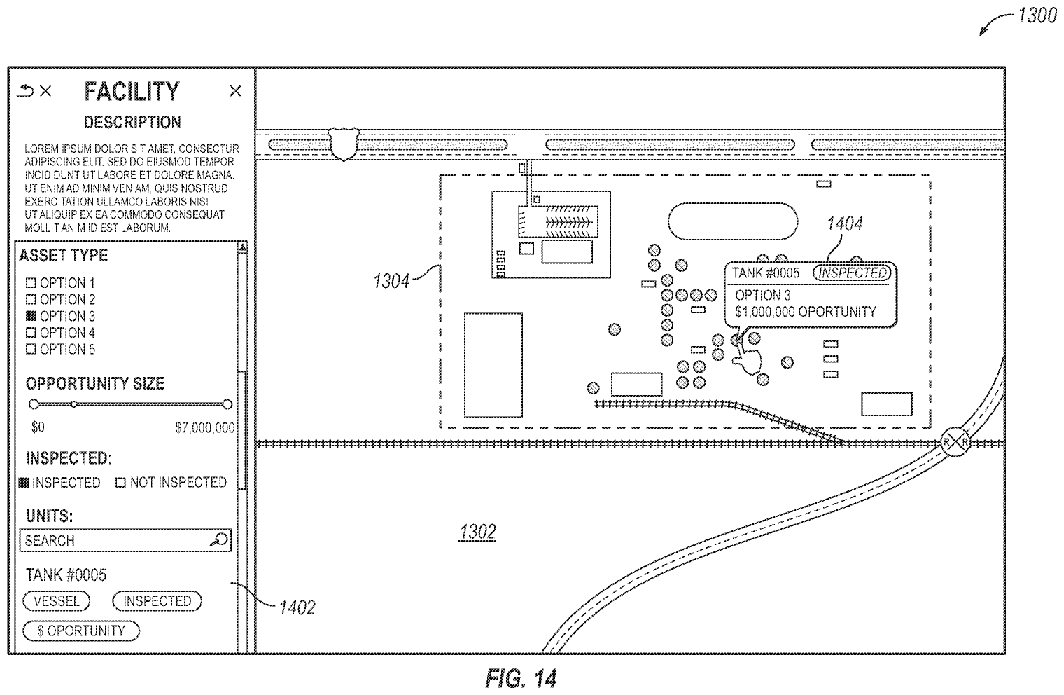

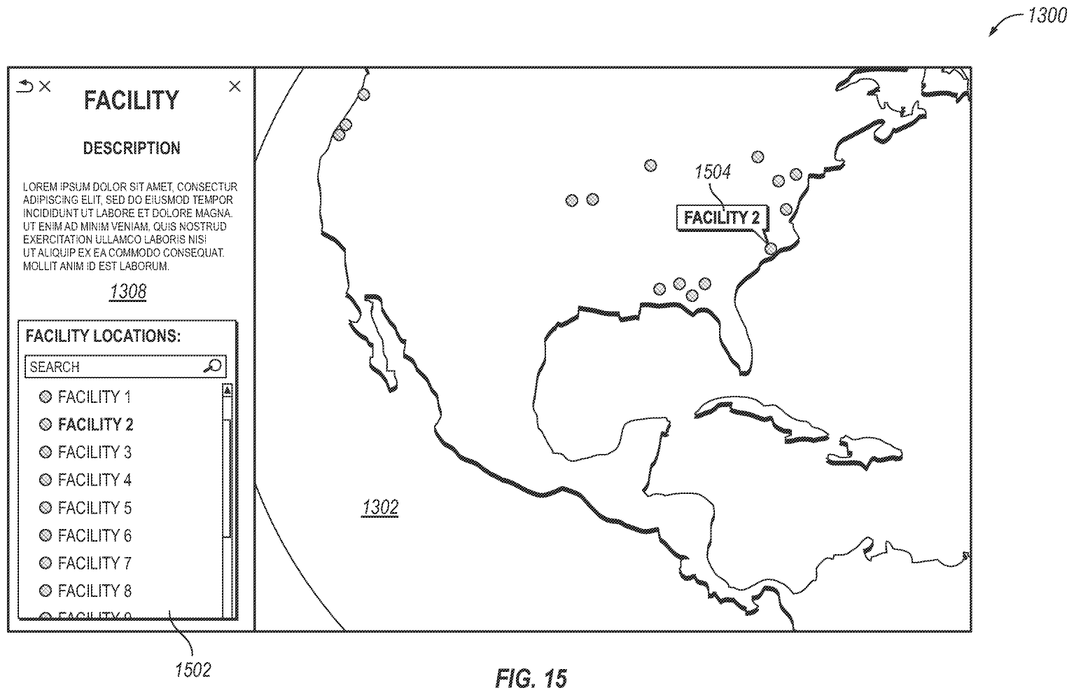

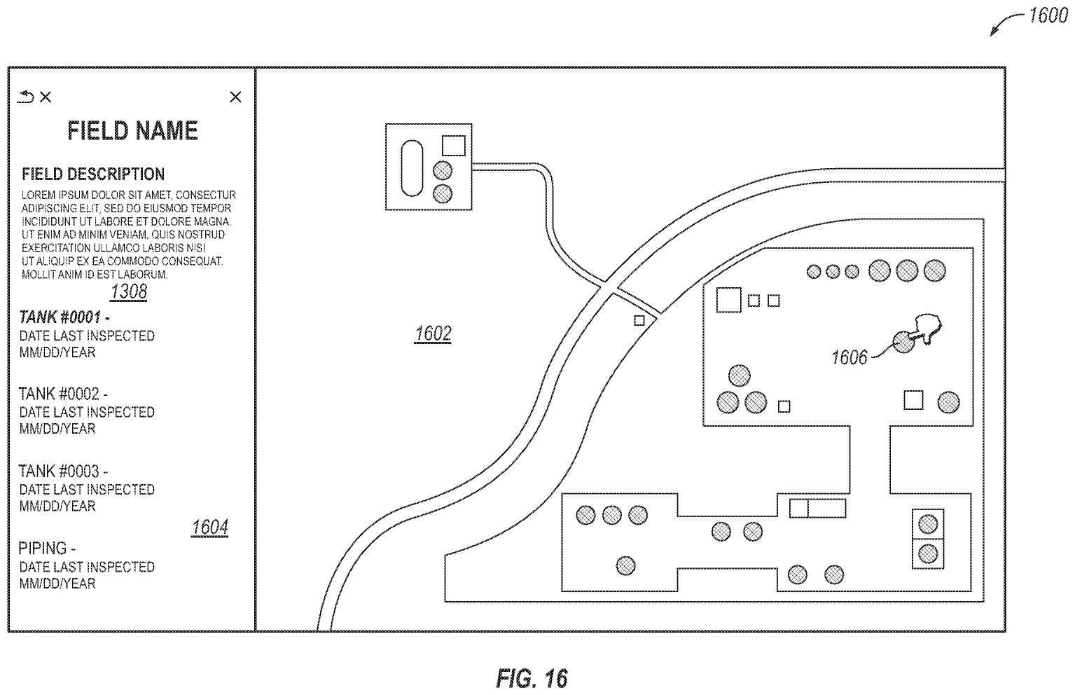

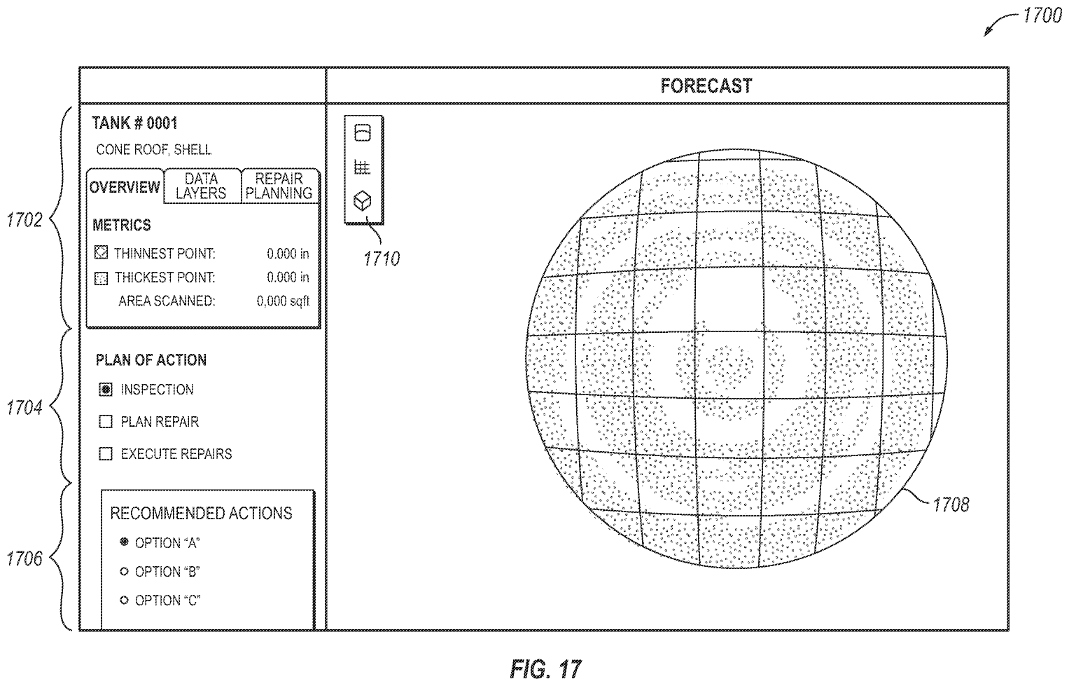

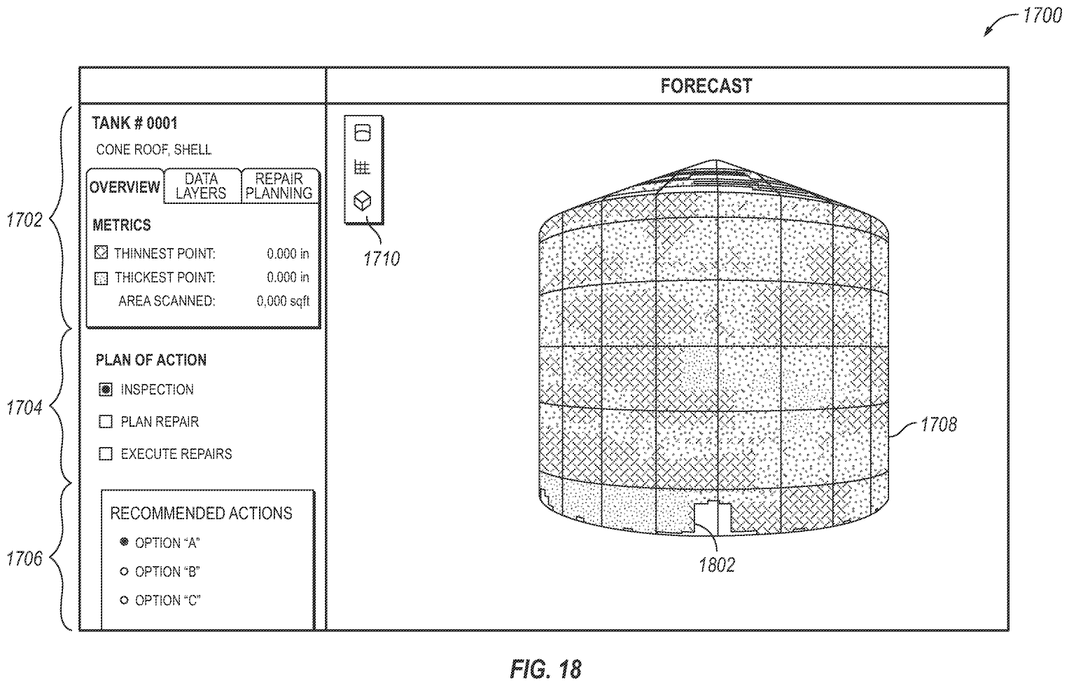

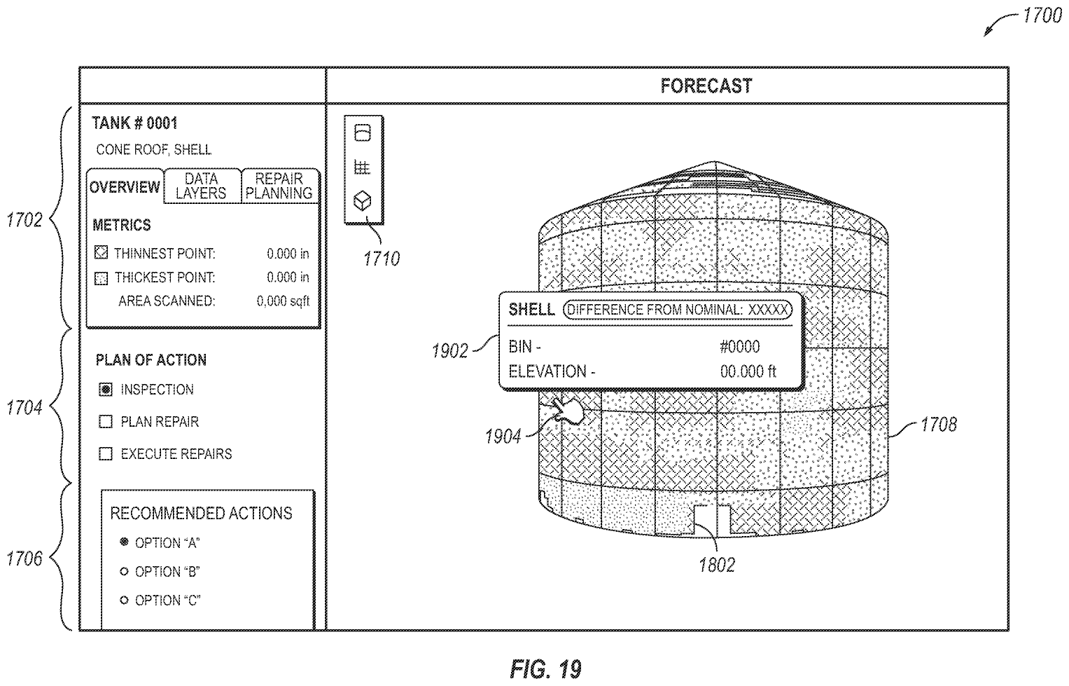

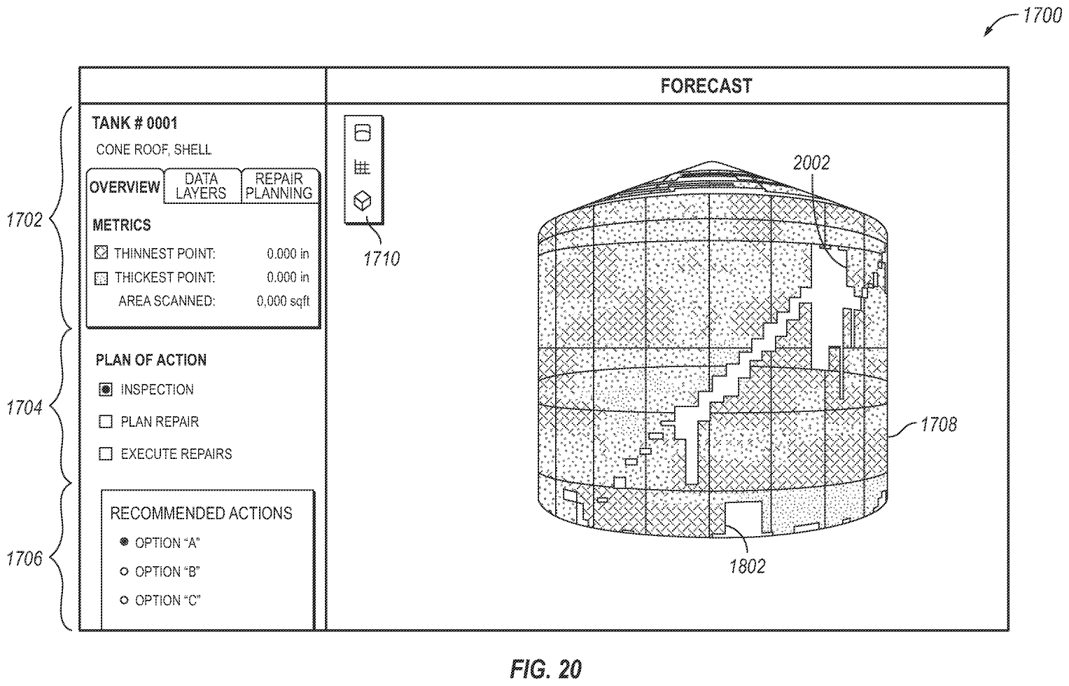

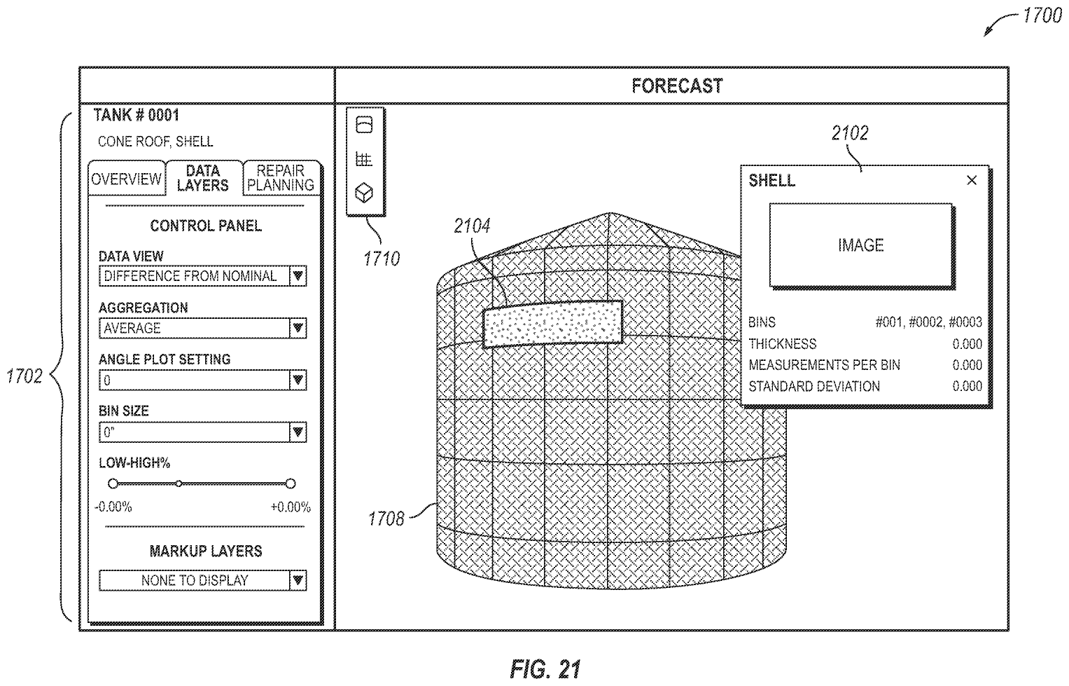

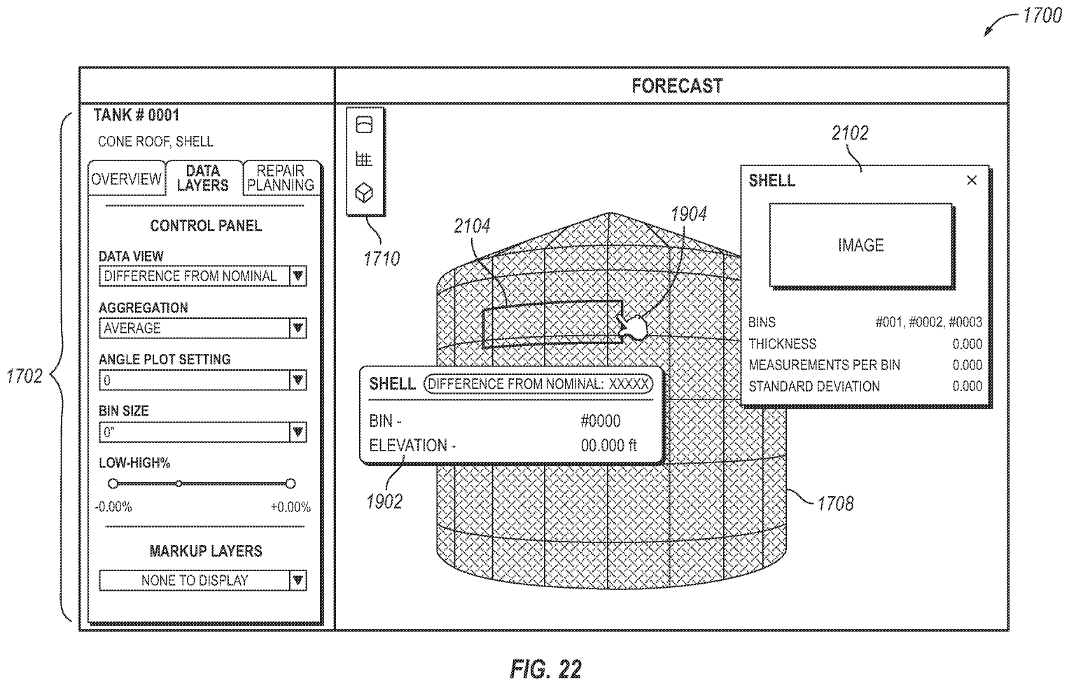

Referencing FIG. 11, a visualization 1100, for example as a user display value 2314, is depicted, for example showing facilities (e.g., 1102, 1104). The example visualization 1100 may be a user geographic display value 3102 of a hierarchical inspection presentation 2414. Referencing FIG. 12, a visualization 1200, for example as a user display value 2314, is depicted, for example showing facilities within a geographic boundary. The example of FIG. 12 may be consistent with the example of FIG. 11, for example with certain facilities filtered out, and/or the example of FIG. 12 may be a depiction of a different facility set. The example visualization 1200 may be a user geographic display value 3102 of a hierarchical inspection presentation 2414. Referencing FIG. 13, a visualization 1300, for example as a user display value 2314, and which may be a detailed view of a facility showing a facility map 1302, a facility layout 1304, and/or navigation controls 1306, is schematically depicted. The example of FIG. 13 may be any type of user display value 2314 as set forth throughout the present disclosure, including for example as a facility display value 3116. Referencing FIG. 14, the visualization 1300 is depicted with a component (and/or equipment) of the facility selected 1402, for example by clicking on the component in the facility map 1302. The example of FIG. 14 additionally depicts a tooltip 1404 for the component, including an opportunity description (e.g., due to a proposed maintenance schedule, inspection schedule, and/or capital expenditure plan). Referencing FIG. 15, an example visualization 1300, which may be consistent or distinct from the depictions of FIGS. 12-14, includes a facility search tool 1504 allowing for navigation between available facilities 1502, which may be a related group of facilities, for example owned or operated by a same entity, and/or facilities cooperating in a workflow. The example of FIG. 15 includes a tooltip associated with a selected facility, which may be selected graphically (e.g., selecting the facility on the display) and/or using the list. Referencing FIG. 16, an example visualization 1600, for example as a user display value 2314, is depicted, for example showing a facility map 1602 that may be selected by navigating a hierarchy layer and/or presented as a detailed view of a selected facility. The example visualization includes a detailed description 1604 of a selected component 1606. The example of FIG. 16 includes a description 1308, which may be a description of the facility, of the selected component, and/or a notification associated with the facility. Referencing FIG. 17, an example visualization 1700, for example as a user display value 2314, is depicted, including an inspection surface display value 3112 (aspect 1708) depicting inspection data or results on an inspection surface (a top of a cone tank, in the example). The example of FIG. 17 includes an annotation menu 1710 (e.g., to allow entry of annotation values 5906), a navigation pane 1702 having sections to display selected component details, plan review selections 1704, and/or plan action details 1706. Referencing FIG. 18, a visualization 1700, which may be consistent with the visualization 1700 of FIG. 17, includes the inspection surface display value 3112 (aspect 1708) depicting the component from a different angle. The example of FIG. 18 includes a section 1802 of the inspection data that is missing, for example due to accessibility to the inspection surface (e.g., a tank mixer or pump positioned at that location may be blocking inspection operations). Referencing FIG. 19, an example visualization 1700, which may be consistent with the visualizations 1700 depicted in FIGS. 17 and 18, includes a tooltip 1902, for example generated in response to a user focus value (e.g., cursor 1904) on the inspection surface display value 3112, which provides some detail about the inspection data at the selected location. In certain embodiments, a full selection on the inspection surface display value 3112 may pull up a detailed view of the inspection data, options to adjust the display of the inspection surface display value 3112, or the like. Referencing FIG. 20, an example visualization 1700, which may be consistent with the visualizations 1700 depicted in FIGS. 17-19, is schematically depicted. The inspection surface display value 3112 includes another gap 2002 in the inspection data, for example due to accessibility to the inspection surface from an obstacle such as stairs attached to the tank. The example inspection data may have a gap due to the view of FIG. 20 being rotated around the tank relative to the views of FIGS. 18 and 19, due to the inspection data depicted in the overlay being from a different inspection operation (e.g., an earlier or later inspection, and/or a different type of inspection such as an inspection utilizing a different payload, etc.). Referencing FIG. 21, an example visualization 1700, which may be consistent with the visualizations 1700 depicted in FIGS. 17-20, is schematically depicted. The example of FIG. 21 includes an area of interest 2104, for example selected by the user, and a detailed view 2102 providing additional information about the area of interest 2104 selected by the user. The example display of FIG. 21 is based on a near net geometric representation (the “shell”) of the tank. In certain embodiments, the area of interest 2104 may be provided to the user by another user, for example as a view based user geographic display value 3104. The example navigation panel 1702 includes a tab selection between various display, planning, and analysis options, with a “data layers” tab currently selected. Referencing FIG. 22, an example visualization 1700, which may be consistent with the visualizations 1700 depicted in FIGS. 17-21, is schematically depicted. The example of FIG. 22 is consistent with the view in FIG. 21, with changes to the display texture of the area of interest 2104, and with both the tooltip 1902 and detailed view 2102 depicted in the display.

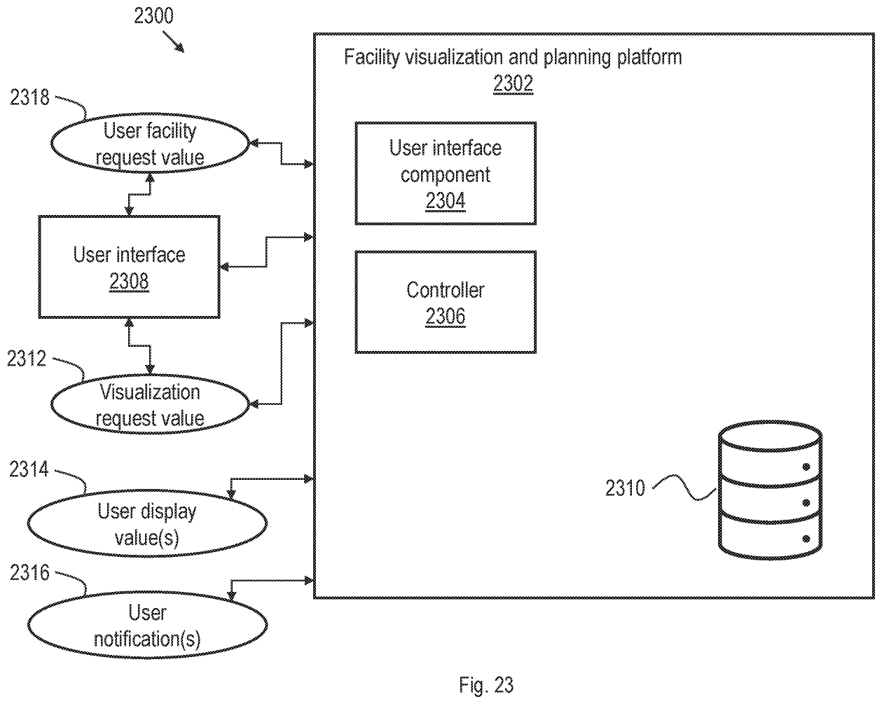

Referencing FIG. 23, an example system 2300 to perform facility visualization and planning is schematically depicted. The example system 2300 may be configured to perform an operations, and may be embodied in whole or part in any systems, controllers, views, circuits, components, or the like as set forth throughout the present disclosure. The example system 2300 includes a facility visualization and planning platform 2302, which may be embodied in whole or part as an inspection visualization and planning platform 102, and which implements and interacts with users with a user interface 2308. The user interface 2308 may include a web portal, mobile application, terminal/server arrangement, and/or may be embodied at least in part as a dedicated application on a user device 110. The implementation of the user interface 2308 may be varied according to which user device 110 is active, how the user chooses to interact with the platform 2302, and/or according to the operating conditions of the system 2300, which actions are being performed by a user, or the like. The example system 2300 includes a user interface component 2304 that implements the user interface 2308, and interprets user operations, user inputs, or other user activity from the user interface 2308, and/or that provides communications to users, communications to facilities, user notifications 2316 (on the user interface 2308 or otherwise), and/or provides user display values 2314 that implement selected depictions of facilities, inspection data, maintenance data, equipment or components at facilities, and/or any other display values as set forth throughout the present disclosure. In certain embodiments, the user interface component 2304 interprets a user facility request value 2318 from user operations on the user interface 2308 and/or a visualization request value 2312 from user operations on the user interface 2308. The facility visualization and planning platform 2302 includes, and/or accesses, a data store 2310 including an aggregation of inspection data, which may be data for selected facilities and/or data for all facilities accessible to the system 2300, and which may include inspection raw data, inspection processed data, detected states or conditions from inspection operations, inspection activity or history, inspection provider information, etc. In certain embodiments, the data store 2310 includes, without limitation to any other aspect of the present disclosure, facility information (e.g., facility locations, names, equipment at the facility, cost data for the facility including operational costs and/or capital costs, production information for the facility, and/or relationship information between facilities), business information (e.g., products produced, profitability of products, costs of lost production or down time, etc.), user permissions (e.g., permissions for users to access data, permissions to views or displays or portions thereof, including permissions according to an associated organization or entity for the user, according a role of the user, and/or as specified by another user of the platform 2302), regulatory information (e.g., applicable regulations for data privacy, inspection requirements, maintenance requirements, operating margins, etc.), policy information (e.g., applicable policies, such as set by an entity owning or operating a facility, and/or by a platform provider or administrator, which may relate to data privacy, inspection requirements, maintenance requirements, operating margins, cost parameters, risk parameters, sensitivity parameters, industry standards, etc.), and/or maintenance information (e.g., maintenance requirements, maintenance activity or history, maintenance provider information, etc.). The example data store 2310 is depicted as a single device for clarity of the present disclosure, but the data store 2310 may be distributed across devices, at least partially included on various user devices 110 accessing the platform 2302, included in whole or part as cloud storage accessible to the platform 2302, or the like. The example facility visualization and planning platform 2302 includes a controller 2306 configured to perform one or more operations as set forth throughout the present disclosure, and which may be embodied, in whole or part, in any systems, controllers, views, circuits, components, or the like as set forth throughout the present disclosure.

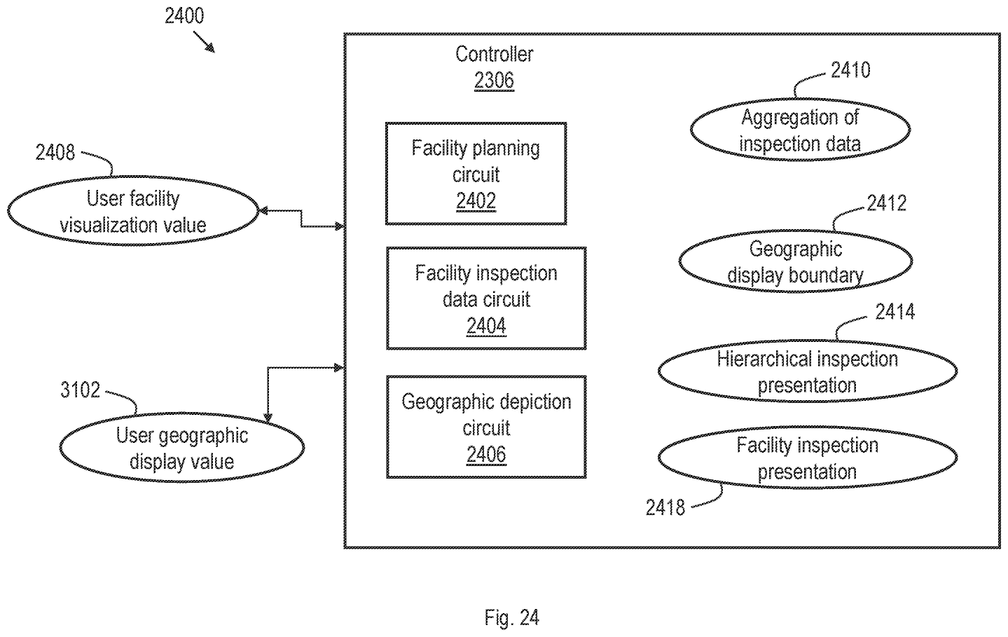

Referencing FIG. 24, an example system 2400 to provide a geographical depiction of a hierarchical inspection presentation, and/or to implement a user interface for geographical depiction of inspection data is schematically depicted. The example system 2400 may be embodied as a controller 2306 on a facility visualization and planning platform 2302. The example controller 2306 includes a facility planning circuit 2402 that interprets a user facility visualization value 2408 in response to a visualization request value 2312 (e.g., received by an interface component 2304 from user operations on the user interface 2308), a facility inspection data circuit 2404 that interprets the aggregation of inspection data 2410 in response to the user facility visualization value 2408 (e.g., by retrieving, tagging, sorting, indexing, etc., inspection data relevant to facilities depicted and/or permitted for access by the user), and a geographic depiction circuit 2406 that determines a geographic display boundary 2412 (e.g., which region will be displayed, and/or how the region will be displayed) and a hierarchical inspection presentation 2414 (e.g., including various display levels available, which one is currently being depicted, and/or operations to navigate between display levels) for at least one industrial facility positioned within the geographic display boundary 2412 in response to the user facility visualization value 2408 and the aggregation of inspection data 2410. The example geographic depiction circuit 2406 determines a user geographic display value 3102 in response to the geographic display boundary 2412 and the hierarchical inspection presentation 2414, for example determining which facilities, borders, geographical elements, or the like are to be displayed to the user in real time. In certain embodiments, the user interface component 2304 provides the user geographic display value 3102 to the user interface 2308, for example depicting the facilities, borders, and/or geographical elements on the user device 110.

In some aspects, the techniques described herein relate to a system, wherein the user operations on the user interface to provide the visualization request value include at least one operation selected from: defining a geographic boundary; selecting a geographic region; selecting a facility of interest; selecting a facility type of interest; selecting an entity of interest; selecting an equipment type of interest; or selecting a predetermined facility group; selecting a predetermined equipment group; providing a facility relationship value; providing an equipment relationship value; adjusting a current user geographic display value; or a hierarchy selection value.

In some aspects, the techniques described herein relate to a system, wherein the facility planning circuit structured is further configured to interpret the user facility visualization value in response to the visualization request value by determining at least one relevant facility for user display.

In some aspects, the techniques described herein relate to a system, wherein the geographic display boundary includes a geographic region for depiction determined in response to the at least one relevant facility.

In some aspects, the techniques described herein relate to a system, wherein the geographic region for depiction includes a geometric region encompassing the at least one relevant facility.

In some aspects, the techniques described herein relate to a system, wherein the geographic region for depiction includes a bounded region at least partially defined by a geographic boundary encompassing the at least one relevant facility.

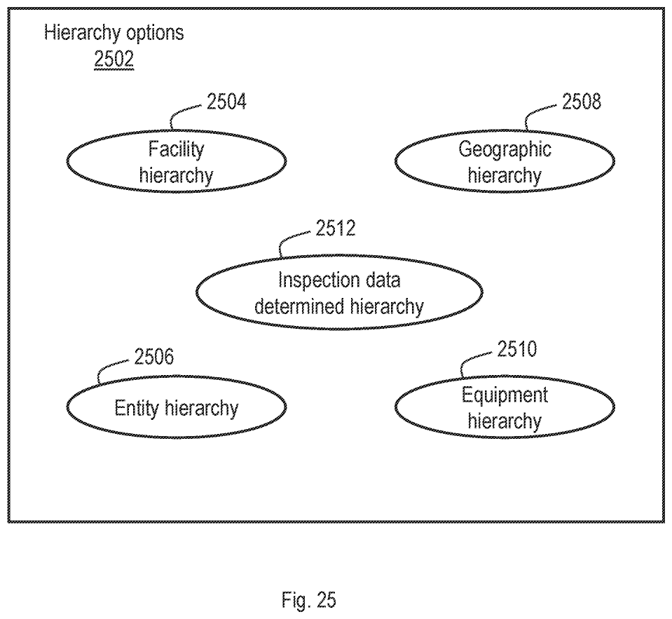

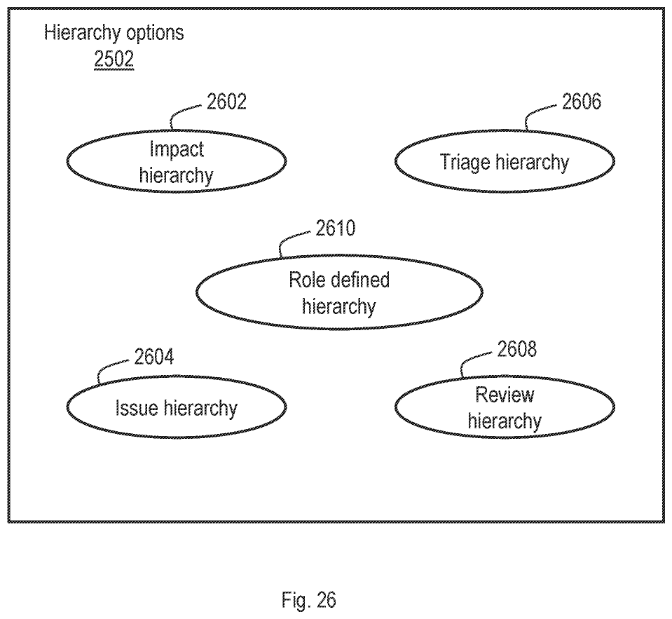

Referencing FIG. 25, example and non-limiting hierarchy options 2502 for the hierarchical inspection presentation 2414 are schematically depicted. The example hierarchy options illustrate some capabilities of the system 2400, and are non-limiting. A particular hierarchy scheme for a given embodiment may utilize another hierarchy scheme, and/or may use elements (or all) of more than one hierarchy scheme. Example hierarchy options 2502 include: a facility hierarchy 2504 (e.g., allowing the user to navigate through facility levels, for example facilities for a full business unit at a top level, facilities for a region, then facilities at a location, and then a sub-facility element such as a particular production line or piece of equipment); an entity hierarchy 2506 (e.g., allowing a user to navigate through entity levels, such as an organization, a business unit, a facility, an operator for a part of a facility, a particular operating crew, etc.); a geographic hierarchy 2508 (e.g., based on geographic regions, national/state/county/city regions, geographic regions mapped to a business organization, etc.); an equipment hierarchy 2510 (e.g., a facility, production line, specific equipment, etc.); and/or an inspection data determined hierarchy 2512 (e.g., a hierarchy based on types of inspections, inspection frequency, inspection data results such as facilities having nominal, suspect, anomalous, non-compliant, or other inspection results, allowing the user to navigate through inspection data in order of importance and/or according to issues to be addressed). Referencing FIG. 26, example and non-limiting hierarchy options 2502 include one or more of: an impact hierarchy 2602 (e.g., based on importance of facilities to an overall workflow and/or business goal, estimated impact of improvement opportunities, an impact of recommended changes to costs, productivity, or profitability, etc.); an issue hierarchy 2604 (e.g., where issues may be ranked according to cost, impact, likelihood of occurrence, non-compliance with a policy or regulation, etc.); triage hierarchy 2606 (e.g., a hierarchy based on importance and/or impact of detected events; an ordering selected by the user to allow the user to review aspects of components, facilities, and/or workflows in an order of importance to the user; and/or a hierarchy with the most urgent, severe, or highest impact issues presented at a top level of the hierarchy etc.); a review hierarchy 2608 (e.g., presenting a hierarchy ordered according to a review checklist, a preference expressed by the user, a defined hierarchy from another user—for example an operator user that sets the review order for a manager user, etc.); and/or a role defined hierarchy 2610 (e.g., allowing different types of users, such as manager, operators, inspection providers, maintenance providers, regulatory monitors, marketing personnel, etc., to utilize a different hierarchy option to provide the information desired in the order and with the navigation scheme that is helpful to that user).

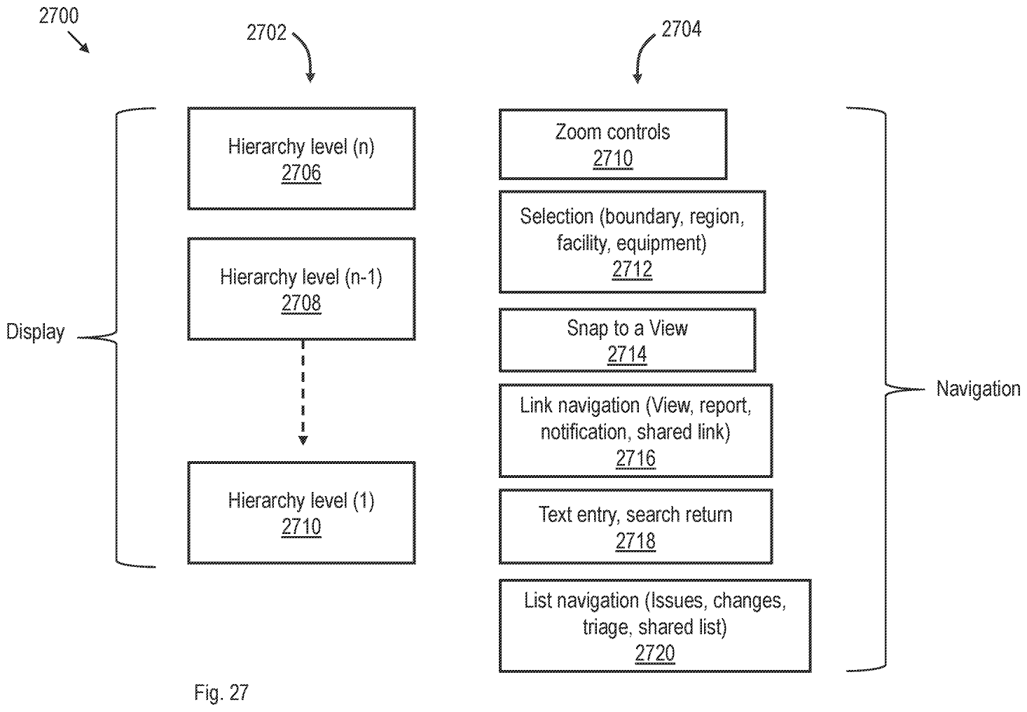

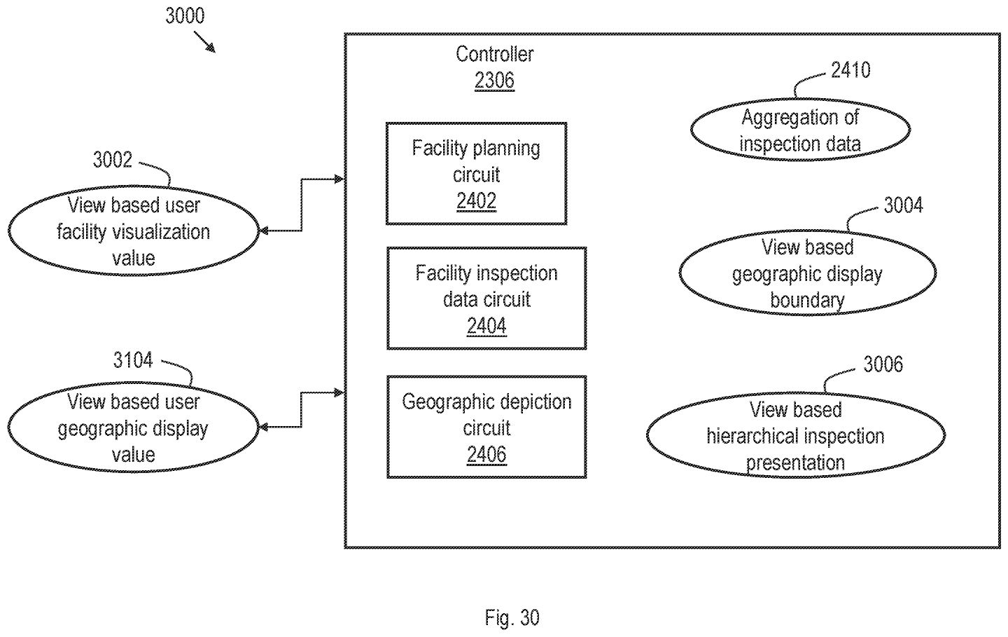

Referencing FIG. 27, an example hierarchy navigation scheme 2700 is schematically depicted, which may be stored in the hierarchical inspection presentation 2414, and/or exercised by the geographic depiction circuit 2406 to determine the user geographic display value 3102 in response to user operations on the user interface 2308. The example hierarchy navigation scheme 2700 includes navigation levels 2702 for display (e.g., with levels “1” 2710 to “n” 2706, and an intermediate level “n−1” 2708 depicted in the example), where the navigation level 2702 includes levels selected according to the applicable hierarchy options 2502. The example hierarchy navigation scheme 2700 includes navigation operations 2704 that allow the user to move through the navigation levels 2702, for example by: a zoom control 2710 (e.g., allowing the user to move up or down the levels with a zoom control such as a mouse wheel operation, specified zoom level, zoom slider control, and/or touch screen zoom operation); a selection 2712 utilized to determine the navigation level 2702 (e.g., selecting a boundary, a region, a facility, and/or specific equipment, where selection of an icon, text name, dedicated navigation icon, and/or notification icon can be utilized to determine the desired navigation level 2702 for the user); a snap to a view 2714 (e.g., a user that has a predetermined navigation level 2702 allowing for immediate access to a particular view, a link to a particular view (e.g., reference FIG. 30 and the related description), default views provided by the user interface component 2304, etc.); a link navigation 2716 (e.g., a link provided to a view, in a report, in a notification, and/or a link shared between users, allowing a user to be directed to a navigation level 2702 and/or configured view to immediately access relevant information); a text entry and/or search return 2718 (e.g., the user searches for “facilities in Texas”, and the geographic depiction circuit 2406 determines a navigation level 2702 and geographic position that is responsive to the search or text, and/or where the text defines a named navigation level 2702 directly); and/or a list navigation 2720 element (e.g., a listing of available navigation levels 2702 allowing the user to select the desired navigation level 2702, where the list may include all available navigation levels 2702, and/or an organizational theme for the hierarchy options 2502 such as issued based, change based, triage based (e.g., most urgent, severe, or highest impact issues at a top level of the hierarchy), and/or a shared list such as navigation levels 2702 configured by another user).

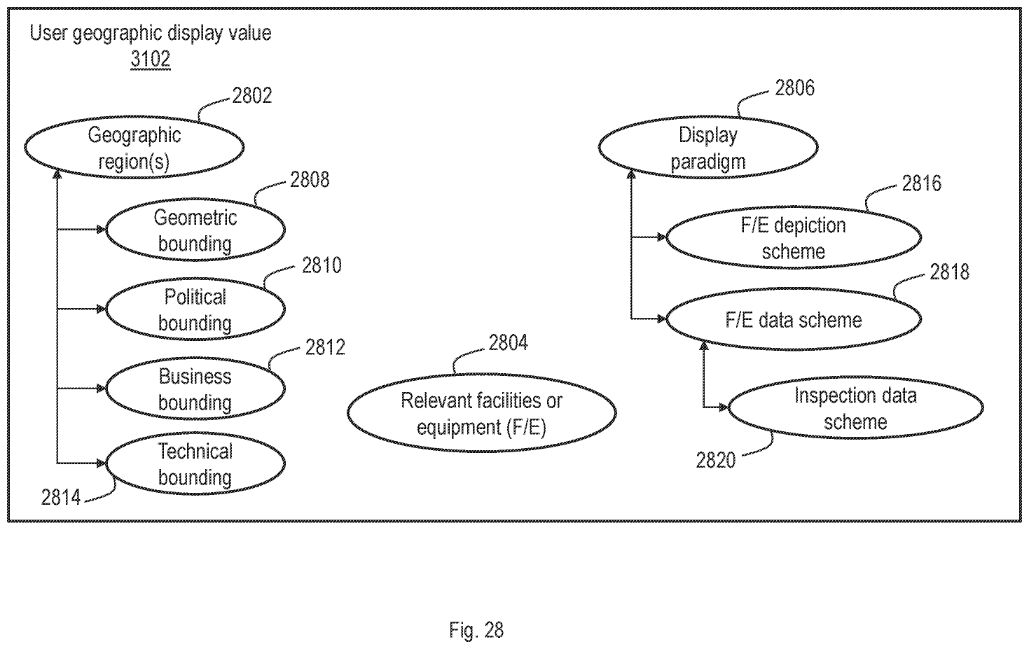

Referencing FIG. 28, example user geographic display values 3102 include a geographic region 2802 for depiction (e.g., the physical location to be depicted, such as a portion of a map, a country, a state, a region, a facility, a location within a facility, etc.) and a display paradigm 2806 (e.g., how features of interest are to be depicted, including for example facility depictions, inspection data depictions, maintenance data depictions, issue notifications, component or equipment depictions, etc.). The example geographic region 2802 includes one or more aspects such as: a geometric bounding 2808 (e.g., a simple geometric shape for overall depiction, such as a circle, rectangle, etc., for example according to a window of the user interface 2308, a selected shape by the user, etc.); a political bounding 2810 (e.g., depiction of political borders, such as national, state, or county boundaries, etc.); a business bounding 2812 (e.g., depicting a region according to a business consideration, such as a market area, a business unit area, depicting facilities for certain business entities such as a particular owner, operator, manager, etc.); and/or a technical bounding 2814 (e.g., depicting a region and/or facilities therein according to a facility type, inspection type, maintenance type, presence of selected issues, etc.). The example display paradigm 2806 includes one or more aspects such as: a facility, entity, and/or equipment (F/E) depiction scheme 2816 (e.g., how facilities are to be depicted, including at various navigation levels 2702, including icons, color schemes, text content and/or formatting, and/or which information is depicted at which navigation levels 2702; and/or how entities are to be depicted, for example depictions that indicate which entities are associated with which facilities and/or geographic regions); a facility, entity, and/or equipment data scheme 2818 (e.g., which data will be depicted at which navigation levels 2702, where the data depicts one or more elements such as facility or equipment names, ownership, operators, capital costs, expenditures, production output, equipment age, time since last service, maintenance, or inspection, a time to the next service, maintenance, or inspection, etc.); and/or an inspection data scheme 2820 (e.g., configuring the depiction of inspection data at different navigation levels 2702, including a summary of inspection results, a minimum or maximum result, issues detected in the inspection data, etc.). An example user geographic display value 3102 includes a depiction configuration for relevant facilities or equipment 2804, including for example which facilities or equipment will be depicted at which navigation levels 2702, and/or whether the facilities or equipment will be depicted according to specified criteria (e.g., related equipment across a selected political boundary that is nevertheless within view of the current geographic region 2802 may be depicted or omitted, and/or the user may omit certain types of facilities or equipment, and/or limit the view to facilities or equipment having an issue, subject to a change recommendation, or the like, for example to allow the user to focus on particular operations on the platform 2302).

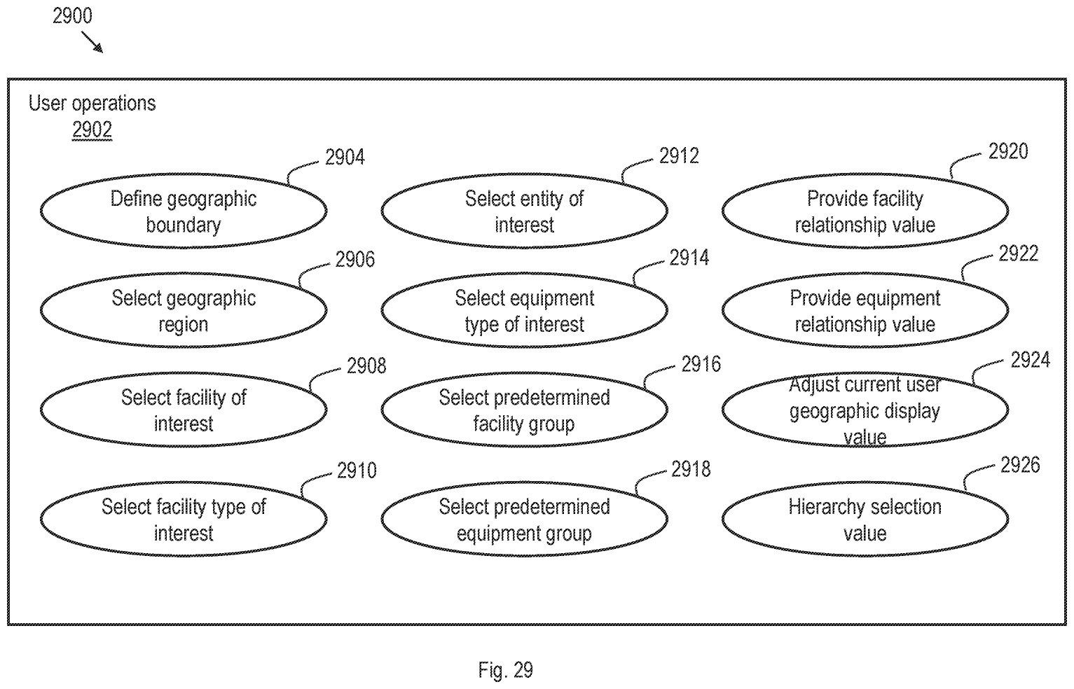

Without limitation to any other aspect of the present disclosure, FIG. 29 is an illustration 2900 of example user operations 2902 available on various embodiments of the platform 2302, including for example operations to provide a visualization request value 2312. Example and non-limiting user operations 2902 include one or more operations such as: defining a geographic boundary 2904 (e.g., selecting a region on a map, boxing out a region, free-hand drawing of a region, selecting a region from a list, etc.); selecting a geographic region 2906 (e.g., graphically selecting a region, selecting a region from a list, etc.); selecting a facility of interest 2908 (e.g., selecting a facility from the user geographic display, selecting a facility from a list, searching for a facility and selecting as a return from the search and/or from a list returned from the search, etc.); select facility type of interest 2910; selecting an entity of interest 2912 (e.g., selecting a facility owner, business unit, facility operator, facility manager, inspection operator, maintenance provider, etc., from a graphical depiction (e.g., a depiction of a facility having one or more entities depicted therewith), from a list, entered by the user, etc.); selecting an equipment type of interest 2914 (e.g., all boilers, distillation columns, tanks, pipes, etc.); selecting a predetermined facility group 2916 (e.g., built by the user or another user, and/or prepared by the platform 2302, for example all facilities owned by an entity, all facilities permitted to the user, etc.); selecting a predetermined equipment group 2918; providing a facility relationship value 2920 (e.g., user criteria utilized to associate a group of facilities for any purpose, for example facilities having an inspection and/or maintenance issue, facilities utilizing certain types of inspections, facilities subject to particular regulatory and/or policy constraints, facilities having a production value exceeding a threshold, facilities having a capital expenditure exceeding a threshold, etc.); providing an equipment relationship value 2922; adjusting a current user geographic display value 2924 (e.g., any aspect of any display value as set forth throughout the present disclosure, which may be constrained by user permissions); and/or a hierarchy selection value 2926 (e.g., operations to select an applicable hierarchy scheme, to define or adjust a hierarchy scheme, and/or to navigate through a currently applicable hierarchy).

Referencing FIG. 30, an example system 3000 to provide for view customization of a geographical depiction of inspection information is schematically depicted. The example system 3000 may be embodied as a controller 2306 on a facility visualization and planning platform 2302. The example controller 2306 includes a facility planning circuit 2402 that interprets a view based user facility visualization value 3002 in response to a visualization request value 2312 (e.g., provided by a interface component 2304 from a user interface 2308), a facility inspection data circuit 2404 that interprets the aggregation of inspection data 2410 in response to the view based user facility visualization value 3002, and a geographic depiction circuit 2406 that determines a view based geographic display boundary 3004 and a view based hierarchical inspection presentation 3006 for at least one industrial facility positioned within the view based geographic display boundary 3004 in response to the view based user facility visualization value 3002 and the aggregation of inspection data 2410. The example geographic depiction circuit 2406 determines a view based user geographic display value 3104 in response to the view based geographic display boundary 3004 and the view based hierarchical inspection presentation 3006. An example user interface component 2304 provides the view based user geographic display value 3104 to the user interface 2308.

For example, the operations of system 3000 allow a first user to define a view of facilities, inspection data, geographic boundaries, and/or specific locations, which may be shared with another user, referenced by the user to return to a specific view or type of analysis, etc. In certain embodiments, the view based user facility visualization value 3002 may be utilized to define hierarchy schemes, facility depictions, and/or any other display aspects as set forth throughout the present disclosure. An example system 3000 includes a first user performing the user operations on the user interface to provide the view based user facility visualization value 3002, and the user interface component 2304 providing the view based user geographic display value 3104 to a second user.

An example system 3100 includes the user interface component 2304 providing the view based user geographic display value 3104 to the user interface 2308 as a selectable visualization request value 2312—for example allowing the user to interact with the platform 2302 in any manner desired, and providing the view based user geographic display value 3104 as a selectable view that the user can apply.

An example facility planning circuit 2402 interprets the view based user facility visualization value 3002 in response to the visualization request value 2312 by determining at least one relevant facility for user display (e.g., a facility within a depicted region, permitted for viewing for the user, related to a selected entity, and/or meeting any other user criteria for display). An example view based user geographic display value 3104 includes a geographic region for depiction determined in response to the at least one relevant facility. An example geographic region for depiction includes a geometric region encompassing the at least one relevant facility, related facilities, including the facility within a selected hierarchical level, etc. An example geographic region for depiction includes a bounded region at least partially defined by a geographic boundary (e.g., a region including part of Texas and bounded at least in part by a portion of the Texas border) encompassing the at least one relevant facility.

An example system 3000 includes the user operations on the user interface to provide the view based user facility visualization value 3002 occurring on a first platform session, where the geographic depiction circuit 2406 stores the view based geographic display boundary 3004 and the view based hierarchical inspection presentation 3006, and where the user interface component 2304 provides at least one of the view based geographic display boundary 3004 or the view based hierarchical inspection presentation 3006 to the user interface on a second platform session. The first and second platform sessions may be sessions from different users, or different sessions for a same user. In certain embodiments, a session is determined based on login information, access to the platform from separate user devices, sessions based on opening an application to access the platform, and/or sessions based on a delay period (e.g., each day is determined to be a separate session). For example, such operations allow the user to return to a previous navigation point or display, to share the navigation point or display with another user, and/or to pick up analysis using previously configured aspects for a hierarchy scheme, selected facilities or entities, and/or any other settings utilized to determine display values.

An example system 3000 includes the user operations on the user interface to provide the view based user facility visualization value 3002 occurring on a first platform session, where the facility planning circuit 2402 stores the view based user facility visualization value 3002, and where the user interface component 2304 provides the view based user facility visualization value 3002 to the user interface on a second platform session. For example, such operations allow the user to return to a previous navigation point, to pick up a previous analysis session, or to continue an incomplete session.

An example system 3000 includes the user operations on the user interface to provide the view based user facility visualization value 3002 occurring on a first platform session, where the geographic depiction circuit 2406 stores the view based user geographic display value 3104, and where the user interface component 2304 provides the view based user geographic display value 3104 to the user interface on a second platform session. For example, such operations allow the user to return to a specific display, and/or share the specific display with another user.

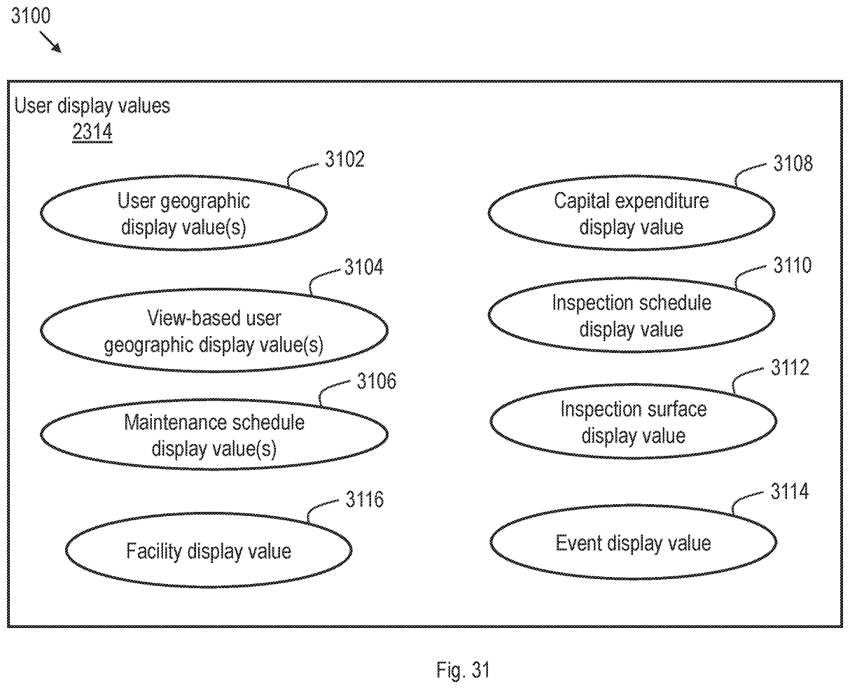

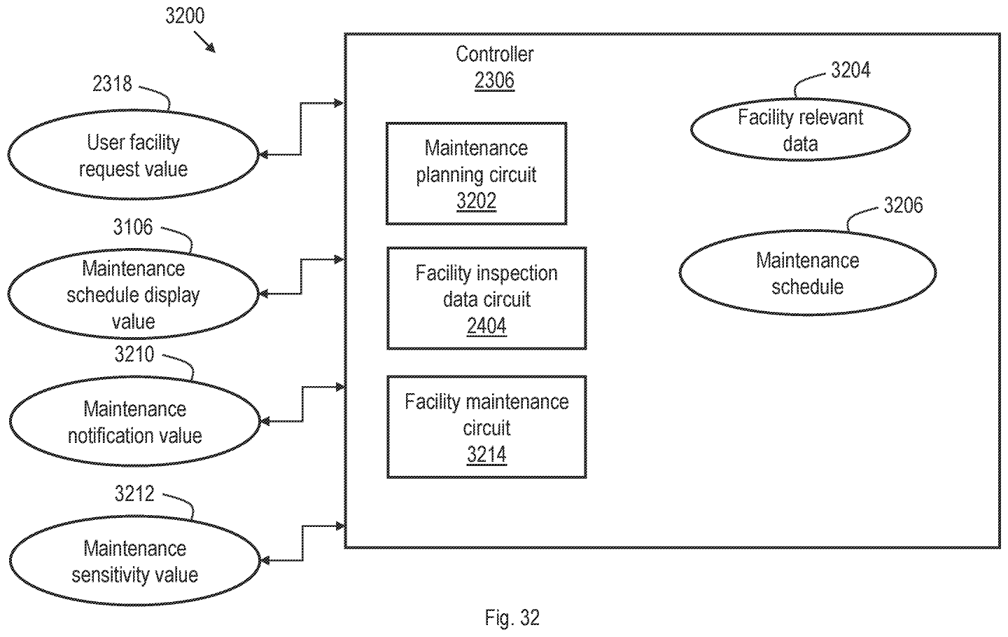

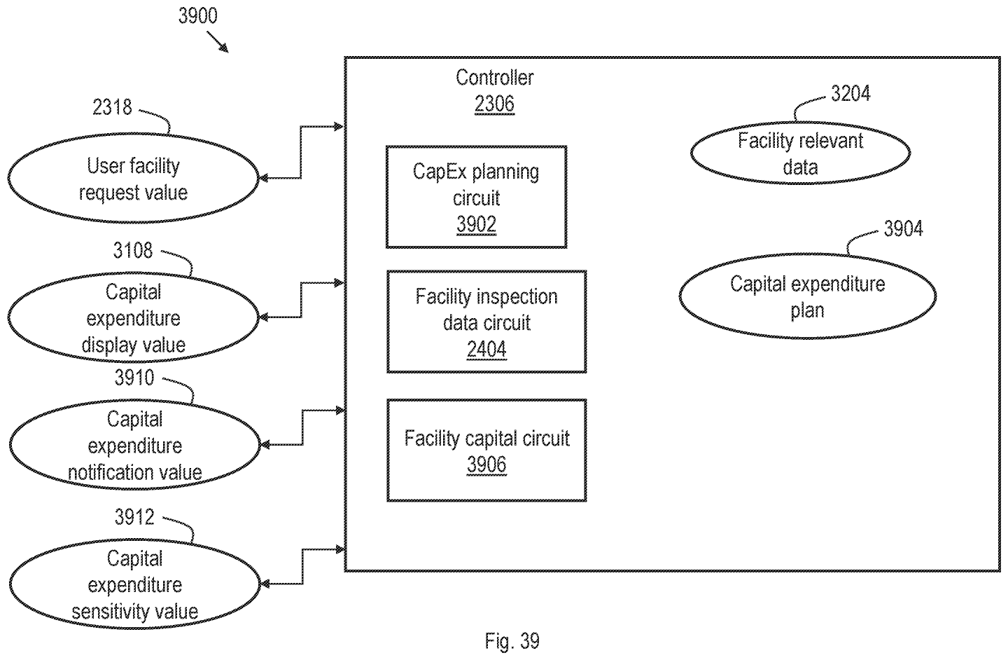

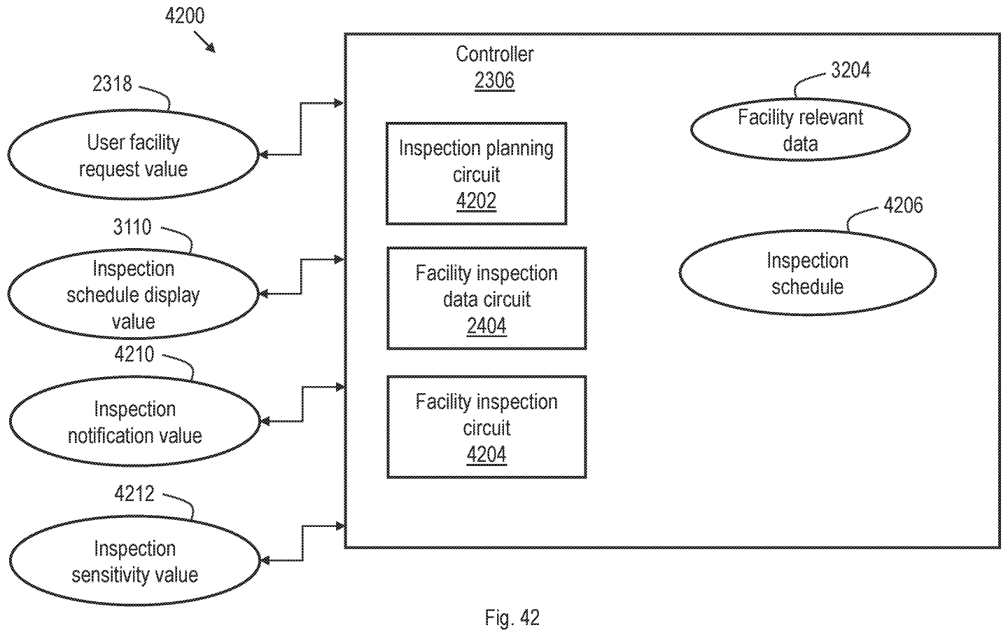

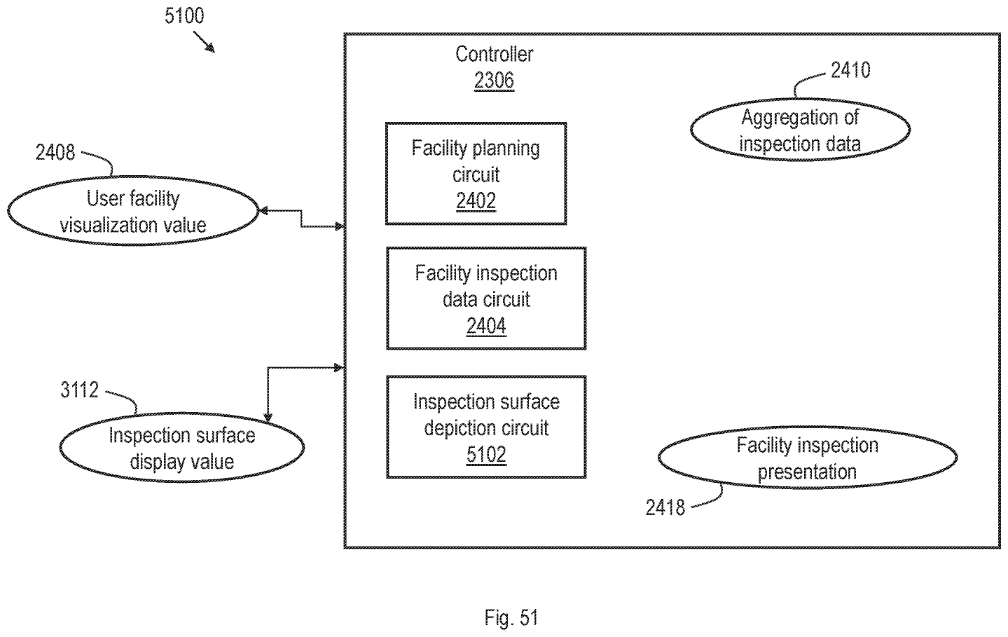

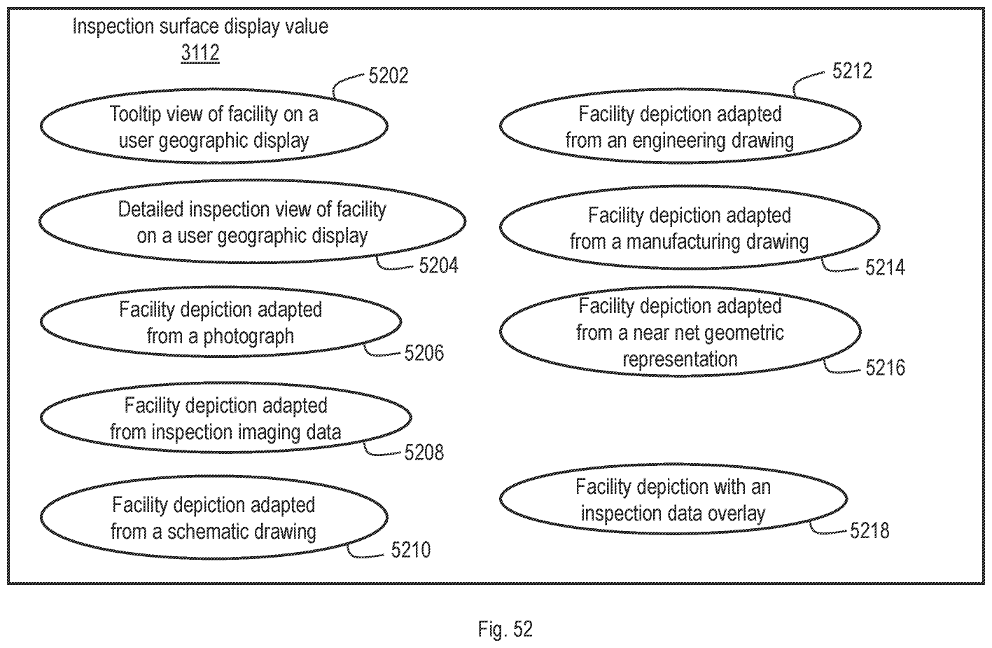

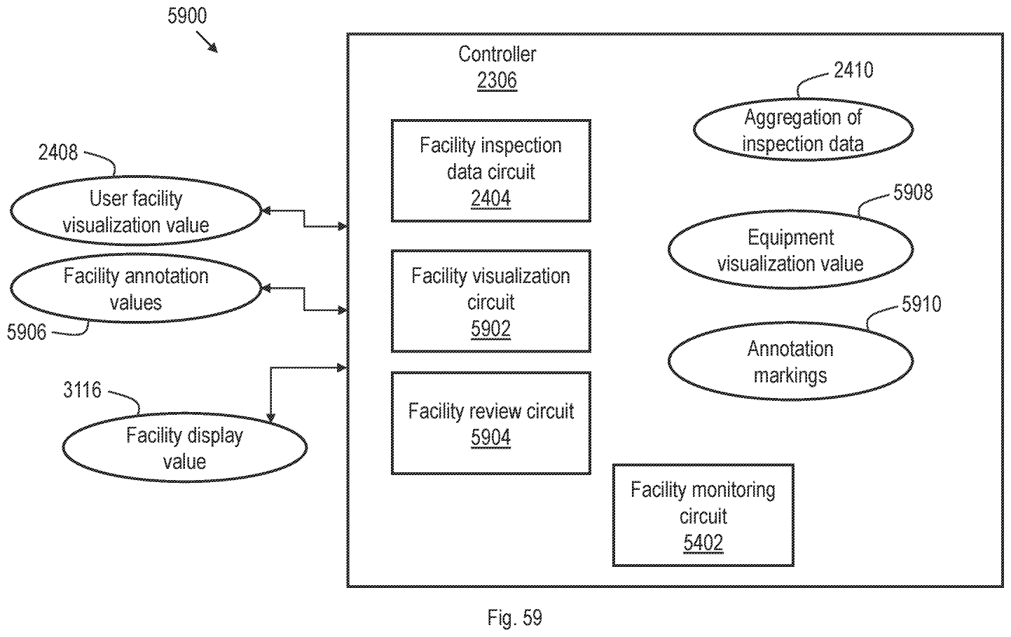

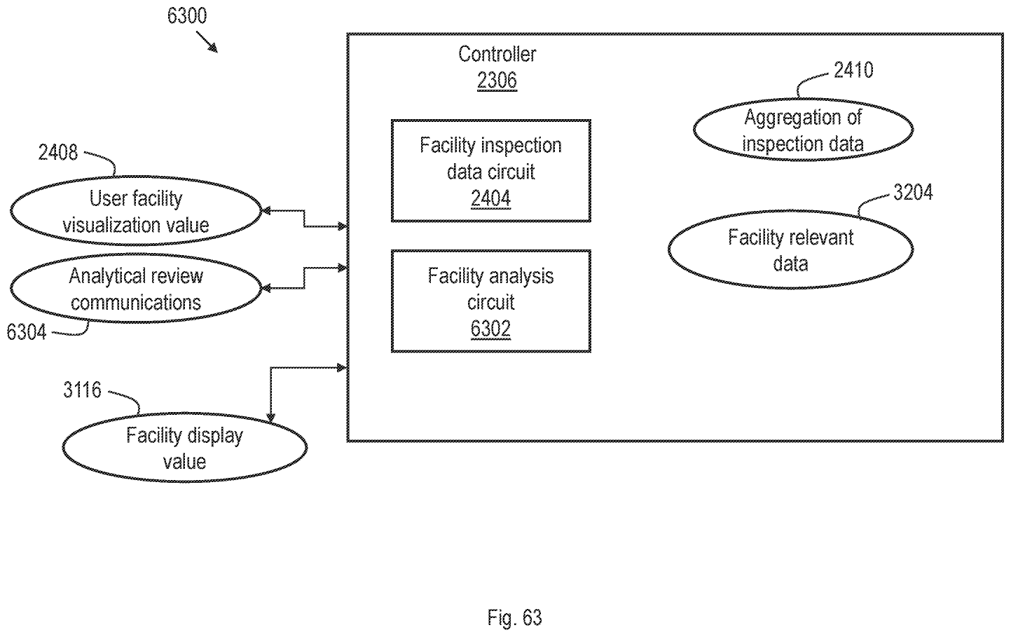

Referencing FIG. 31, example and non-limiting user display values 2314, which may be utilized in any display throughout the present disclosure, includes one or more display values such as: a user geographic display value 3102 (e.g., reference FIG. 24 and the related description); a view based user geographic display value 3104 (e.g., reference FIG. 30 and the related description); a maintenance schedule display value 3106 (e.g., reference FIG. 32 and the related description); a facility display value 3116 (e.g., reference FIGS. 59, 63 and the related descriptions); a capital expenditure display value 3108 (e.g., reference FIG. 39 and the related description); an inspection schedule display value 3110 (e.g., reference FIG. 42 and the related description); an inspection surface display value 3112 (e.g., reference FIG. 51 and the related description); and/or an event display value 3114 (e.g., reference FIG. 54 and the related description).

Referencing FIG. 32, an example system 3200 to determine a maintenance schedule for industrial equipment based on inspection information is schematically depicted. The example system 3200 may be embodied as a controller 2306 on a facility visualization and planning platform 2302. The example system 3200 includes a facility inspection data circuit 2404 that interprets facility relevant data 3204 in response to the aggregation of inspection data and the user facility request value 2318 (e.g., from user operations on the user interface 2308), a maintenance planning circuit 3202 that determines a maintenance schedule 3206 for at least one industrial facility in response to the facility relevant data 3204, and a facility maintenance circuit 3214 that determines a maintenance schedule display value 3106 in response to the maintenance schedule 3206 and the facility relevant data 3204. An example user interface component 2304 provides the maintenance schedule display value 3106 to the user interface 2308. For example, the maintenance schedule 3206 may include maintenance operations to be performed, the frequency, timing, and/or sequencing of such operations, and/or components, equipment, or facilities for the maintenance operations. The maintenance schedule display value 3106 may include aspects of the maintenance schedule 3206 relevant to the user, operations that are due or imminent, changes of the maintenance schedule 3206 relative to a previous maintenance schedule, or the like.

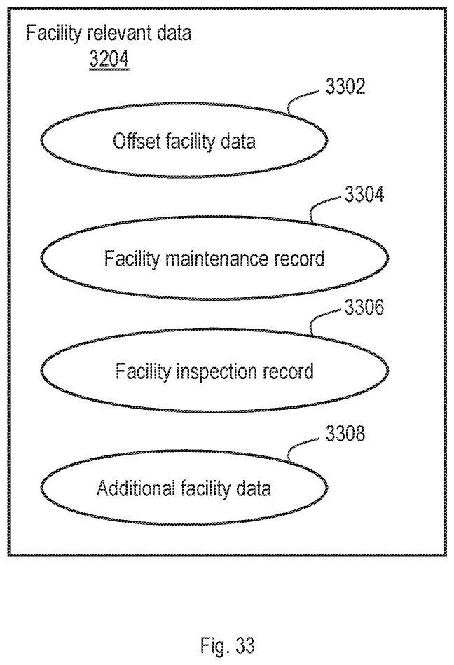

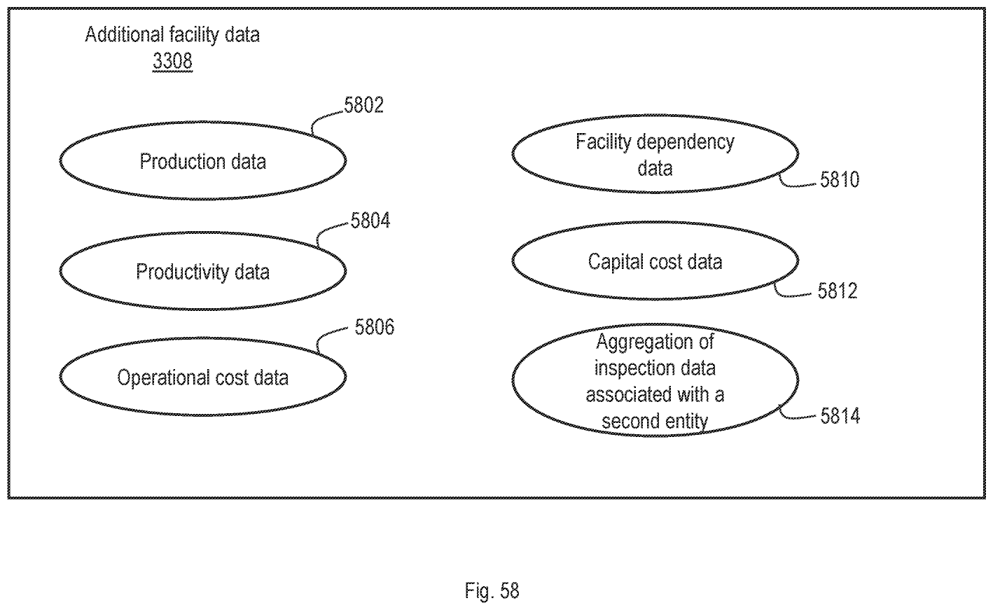

Referencing FIG. 33, example and non-limiting facility relevant data 3204 includes one or more aspects such as: offset facility data 3302 (e.g., data from a related facility, a similar facility in terms of equipment, utilization, and/or stress induced by operations, and/or a facility having a similarity relevant to maintenance operations such as criticality to a workflow, remoteness of the location, utilizing similar inspection operations and/or maintenance operations, etc.); a facility maintenance record 3304 (e.g., maintenance previously performed on the facility or equipment); a facility inspection record 3306 (e.g., inspections previously performed on the facility or equipment, data from such inspections, and/or conditions or issues identified from such inspections); and/or additional facility data 3308 (e.g., reference FIG. 58 and the related description). In certain embodiments, the facility relevant data 3204 is included in the data store 2310 and/or aggregation of inspection data 2410. In certain embodiments, the facility relevant data 3204 and/or aspects thereof are available to the system 3200, for example by querying a database communicatively coupled to the system 3200.

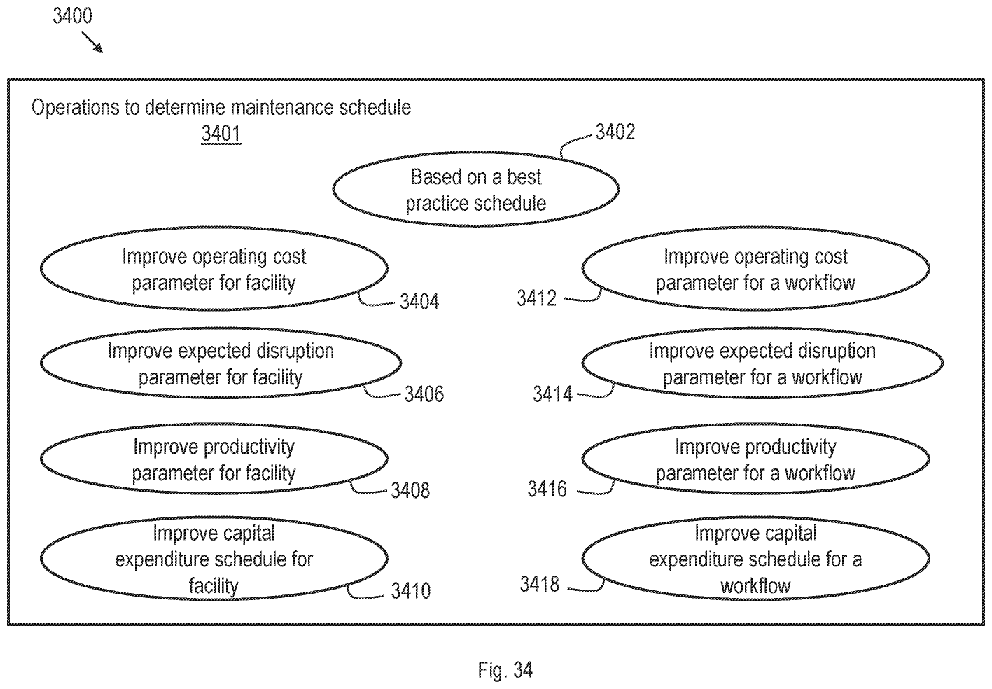

Referencing FIG. 34, an illustration 3400 depicts example operations 3401 to determine the maintenance schedule 3206. Example operations 3401 include, without limitation, determining the maintenance schedule 3206 based on one or more of: a best practice schedule 3402 (e.g., determining maintenance operations for offset facilities, and/or for a group of facilities, that generally provide good outcomes); improving an operating cost parameter for a facility 3404 (e.g., a maintenance schedule that provides an improved operating cost, considering aspects such as: cost of the maintenance; downtime for the maintenance; cost and/or downtime for inspection operations based on the selected maintenance schedule (e.g., where inspection operations can reduce the need for and/or obviate maintenance operations); operating margin for the related equipment based on maintenance operations; risk of component failure based on maintenance operations; operational impact to a workflow due to a failure of the component or facility; and/or component expense based on maintenance operations—for example where a more capable component or facility could reduce or eliminate maintenance operations, but may cost more for procurement, installation, and/or integration); improving an expected disruption parameter for the facility 3406 (e.g., disruptions from a failure, for maintenance operations, for inspection operations, and/or for component repair, replacement, or substitution); improving a productivity parameter for the facility 3408 (e.g., where maintenance operations can preserve component capability, component throughput (e.g., where a degraded component can be utilized, but potentially in a reduced capability configuration such as lower temperature, pressure, loading, fill level, etc.), and which may account for maintenance cost and downtime and/or inspection cost and downtime); improving a capital expenditure schedule for a facility 3410 (e.g., where a different component or grade of component, which may be higher cost, can provide improved capability, reduce or obviate the need for certain maintenance activities, and/or has an improved failure condition, for example with a reduced impact for failure, reduced service time in response to a failure, etc.); improving an operating cost parameter for a workflow 3412 (e.g., accounting for the effects of the equipment, component, and/or facility on a larger workflow including the facility, for example where considering the workflow as a whole may lead to a different maintenance schedule indicated than for the facility individually, for example due to externalities relative to the facility related to shutdowns, downtime, or other risks to the workflow); improving an expected disruption parameter for the workflow 3414; improving a productivity parameter for the workflow 3416; and/or improving a capital expenditure schedule for a workflow 3418. In certain embodiments, operations to determine the maintenance schedule 3206 may include consideration for limited maintenance resources (e.g., where limited providers and/or specialized equipment are utilized for maintenance actions), synchronizing maintenance for related components (e.g., similar components at a single facility, to reduce maintenance costs and/or disruption, for example shutting down components of a production line at the same time), and/or ensuring asynchronization of maintenance (e.g., to balance maintenance resources, avoid expediting or special costs, etc.).

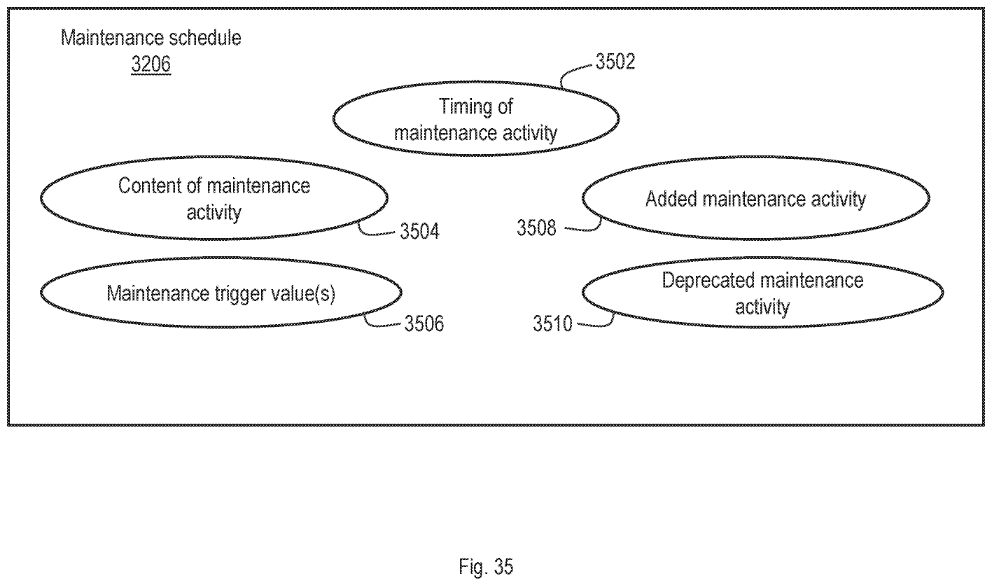

Referencing FIG. 35, an example and non-limiting maintenance schedule 3206 includes one or more aspects such as: a timing of maintenance activities 3502 for the at least one industrial facility (e.g., acute timing such as for a specific maintenance event; chronic timing such as the frequency and/or sequencing of maintenance events and/or acceptable ranges for these); a content of maintenance activities 3504 for the at least one industrial facility (e.g., which maintenance activities are to be performed, which maintenance provider to be utilized, etc.); a maintenance trigger value 3506 for the at least one industrial facility (e.g., conditions utilized to determine when the maintenance activity is to be performed, for example a given throughput or utilization of the component, a given duty cycle of the component such as time spent above threshold temperatures, pressures, fill levels, operating speed, and/or inspection values that trigger maintenance events such as wall thickness values, prominence of cracks or corrosion, etc.); an added maintenance activity 3508 for the at least one industrial facility (e.g., highlighting new maintenance activities in the maintenance schedule 3206 relative to a previous version); and/or a deprecated maintenance activity 3510 for the at least one industrial facility (e.g., highlighting maintenance activities that are no longer needed, either in particular instance (e.g., the next one can be skipped) or on an ongoing basis (e.g., a maintenance activity is no longer needed due to changes in other maintenance activity, changes in an inspection schedule, changes in a regulatory requirement, changes in the component, and/or alternative risk management such as a replacement schedule change, servicing change, component throughput or utilization change, and/or change in the criticality of the component to the facility and/or a related workflow).

An example facility maintenance circuit 3214 determines a maintenance notification value 3210 in response to the maintenance schedule 3206 and the facility relevant data 3204. An example user interface component 2304 provides the maintenance notification value 3210 to a user of the facility visualization and planning platform 2302. Example and non-limiting maintenance notification values 3210 include any notification to a user, such as: an indication of a change in the maintenance schedule, an indication of non-compliant maintenance (e.g., a regulatory and/or policy based required maintenance that is overdue, omitted, not recorded, etc.), a scheduling notification for a maintenance event, and/or a change in maintenance outcomes (e.g., maintenance operations that were unsuccessful, insufficient for the actual condition of the component, insufficient as indicated by an inspection operation, resulting in increased cost and/or downtime relative to previous maintenance events, etc.). In certain embodiments, the maintenance notification value 3210 may be provided on the user interface 2308 (e.g., as an icon next to a related facility, in a notification area of the display, and/or within a messaging function on the user interface 2308), provided directly to the user (e.g., as a text message, e-mail, voice mail, etc.), and/or provided in another manner (e.g., in a notification section of a report generated by the platform 2302).

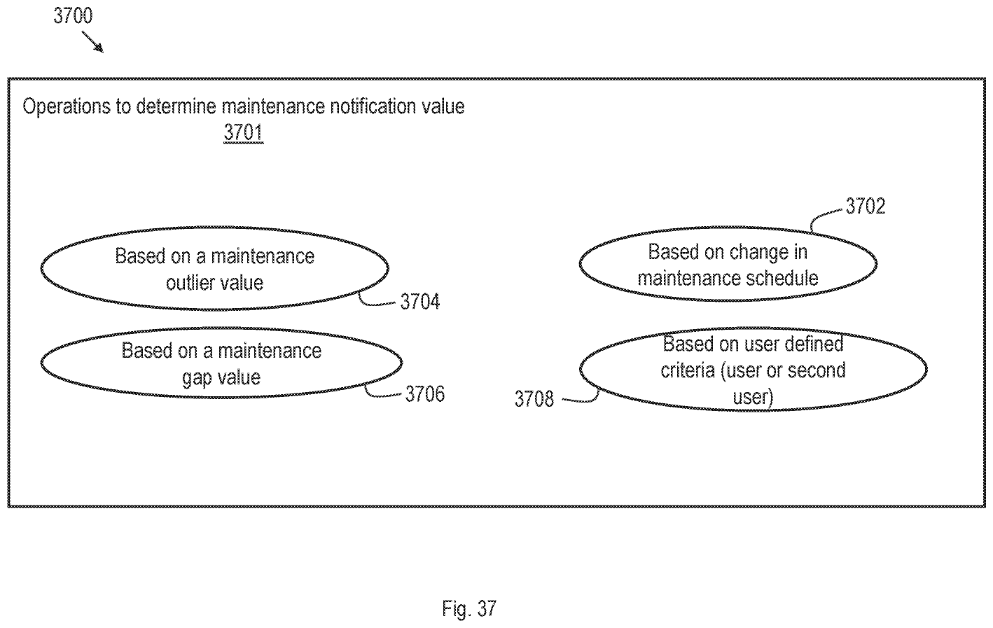

Referencing FIG. 37, an illustration 3700 of example operations 3701 of the facility maintenance circuit 3214 to determine a maintenance notification value 3210 is schematically depicted. An example operation 3704 includes determining the maintenance notification value 3210 based on a maintenance outlier value. For example, the maintenance schedule 3206 or any aspect thereof may be determined to be an outlier based on maintenance schedules for offset facilities or components, and/or for similar facilities or components, where the outlier status is determined according to a statistical analysis. A maintenance schedule may be an outlier even if it is within acceptable ranges, for example having one or more aspects that are statistically distinct from an average, and/or having a number of aspects that, considered together, are statistically distinct from an average. In certain embodiments, a maintenance outlier value may be determined in response to maintenance activity (e.g., scheduling and performance of maintenance pursuant to the maintenance schedule), maintenance outcomes, and/or any other aspect of maintenance activity. In certain embodiments, the outlier status related to the maintenance activity may be determined in response to an exceptionally average situation—for example a component that consistently receives maintenance exactly at scheduled times (and/or consistently offset from scheduled times), and/or exceptionally average maintenance execution and/or outcomes. In certain embodiments, outliers based on determination of exceptionally average conditions or outcomes may be an indicator that some aspect of the system is overdesigned (e.g., related to constraints that could be relaxed, presumably reducing costs, and/or providing additional flexibility somewhere else in the system, at a facility, within a workflow, etc.) and/or an indicator of a data collection issue (e.g., data that has been faked, inserted erroneously, aspects where default data has been utilized, data is missing, etc.). An example operation 3706 includes determining the maintenance notification value 3210 based on a maintenance gap value. Example and non-limiting maintenance gap values include maintenance events that have been missed, that is unavailable, unsuccessful maintenance events, compliance gaps (e.g., including a notification of gaps that are accepted, for example under a waiver), maintenance events that have exceeded a planned cost and/or downtime, and/or aspects of the maintenance schedule that may not be achievable (e.g., due to a limited number of providers, limited amount of specialized equipment, and/or based on historical performance of the maintenance events for the same or similar facilities). An example operation 3702 includes determining the maintenance notification value 3210 based on a change in the maintenance schedule. The operation 3702 may include a description of the changes, providing the maintenance schedule in full (including the changes), providing a notification to a user to check the schedule, highlighting changed aspects of the maintenance schedule (e.g., as displayed on the user interface 2308), etc. An example operation 3708 includes determining the maintenance notification value 3210 based on user defined criteria—for example the user defining any aspect of the maintenance schedule and/or maintenance operations that should be utilized to determine the notification, and/or the content (e.g., data, formatting, presentation) of the notification. An example operation 3708 includes the user selecting aspects of the maintenance schedule where changes indicate a maintenance notification value 3210 should be sent, and/or thresholds for the changes that indicate a maintenance notification value 3210 should be sent. Another example operation includes the user selecting maintenance outcomes and/or thresholds for these, outlier descriptions (and/or categories and/or thresholds for these), and/or indicating a periodic (e.g., once per month) and/or episodic descriptions (e.g., after significant maintenance events, facility or workflow downtime events, changes in regulations and/or policies, addition or loss of maintenance providers, etc.) for determining and/or providing the maintenance notification value 3210.

An example facility maintenance circuit 3214 determines a maintenance sensitivity value 3212 in response to the maintenance schedule 3206 and the facility relevant data 3204. An example user interface component 2304 provides the maintenance sensitivity value 3212 to a user of the facility visualization and planning platform 2302. In certain embodiments, the maintenance sensitivity value 3212 may be determined as a part of determining a maintenance notification value 3210, and/or may be provided to a user as a part of providing the maintenance notification value 3210.

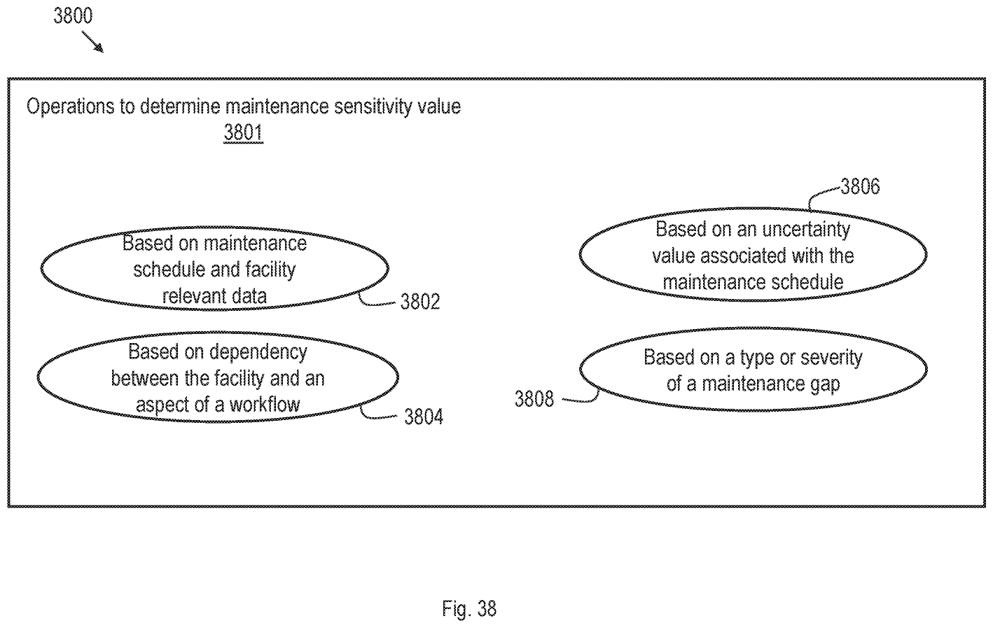

Referencing FIG. 38, an illustration 3800 of example operations 3801 of the facility maintenance circuit 3214 to determine a maintenance sensitivity value 3212 is schematically depicted. An example operation 3802 includes determining the maintenance sensitivity value 3212 based on the maintenance schedule and facility relevant data, for example determining aspects of the maintenance schedule that are at risk (e.g., utilizing competing resources with other facilities, having limited time windows to perform operations, and/or having marginal capability to address identified risks). An example operation 3804 includes determining the maintenance sensitivity value 3212 based on a dependency between the facility and an aspect of a workflow including the facility. For example, where execution of a maintenance event is protecting a large cost to the workflow (e.g., for a critical component), a maintenance sensitivity value 3212 may be provided to highlight what might otherwise be an unexpected leveraging of the maintenance event to the overall workflow. An example operation 3806 includes determining the maintenance sensitivity value 3212 in response to an uncertainty value associated with the maintenance schedule. For example, determinations herein to provide the maintenance schedule 3206 may be based on various estimates such as the impact on downtime to the facility and/or a workflow, estimates of the economic impact of a failure of the component, and/or estimates of the risk reduction achieved by the maintenance operations, where those estimates may be subject to uncertainty and/or management of understood variability. In certain embodiments, these uncertainties and variabilities can be managed utilizing sophisticated analysis techniques such as a Monte Carlo analysis and/or a Bayesian analysis of the facility, component, workflow, and/or maintenance execution. However, in many cases, especially for example where single point failures of a component can have a large impact on a facility or system, but in any case where a description of the variability of the system is not fully characterized or the uncertainties are not fully understood, then such a system can experience events that are not well characterized even by sophisticated analysis techniques. The example operation 3806 can highlight these situations to a user, for example to be utilized to consider additional maintenance or inspection operations, to add data streams to reduce the uncertainties, to keep alternative responses available (e.g., additional parts in inventory, maintenance crews on high alert, etc.) for the system, to adjust the facility or workflow operations (e.g., to reduce sensitivity to failure modes related to the uncertainty), or the like. An example operation 3808 determines the maintenance sensitivity value 3212 based on a type or severity of a maintenance gap (and/or maintenance sensitivity), for example a notification related to a maintenance gap for a regulatory requirement may be provided more prominently than a notification related to a maintenance gap that does not comply with a manufacturer recommendation but relates to a component that has never experienced a failure related to the applicable maintenance operations. In certain embodiments, the type or severity of a maintenance gap may be categorical (e.g., risks related to compliance, productivity, profitability, public perception, and/or safety issues may receive appropriately distinct treatment), or quantitative (e.g., an estimated financial impact, likely downtime over a selected period, etc.).

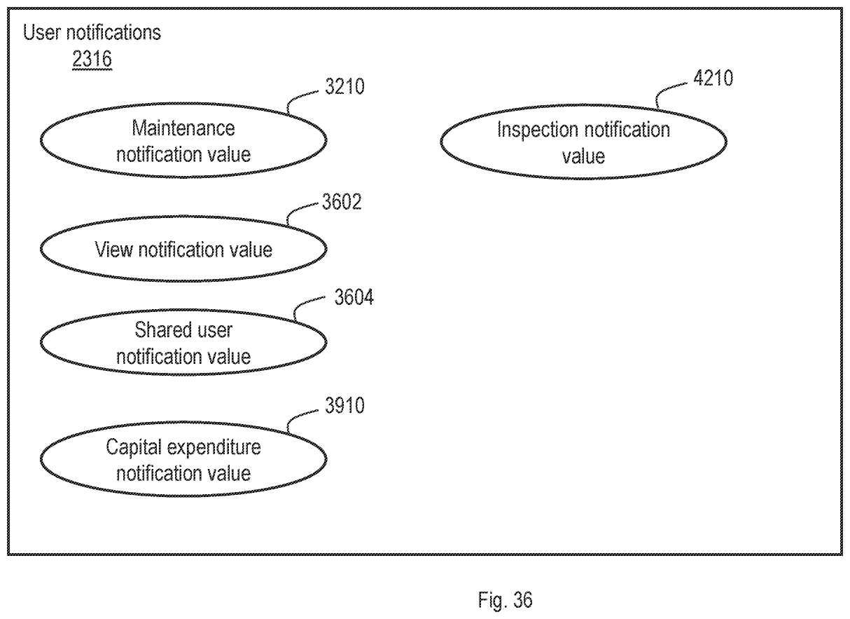

Referencing FIG. 36, example and user notifications 2316, which may be utilized for any notification or alert throughout the present disclosure, includes one or more notification values such as: a maintenance notification value 3210 (reference FIG. 32 and the related description); a view notification value 3602 (e.g., for notifications to a second user of a view based user geographic display value 3104 provided by a first user, and/or any selected information related to the view); a shared user notification value 3604 (e.g., any notification to a second user provided by a first user, and/or provided in response to actions of the first user on the platform 2302); a capital expenditure notification value 3910 (e.g., reference FIG. 39 and the related description); and/or an inspection notification value 4210 (e.g., reference FIG. 42 and the related description).

Referencing FIG. 39, an example system 3900 to configure a capital expenditure plan 3904 for an industrial facility based in inspection data is schematically depicted. The example system 3900 may be embodied as a controller 2306 on a facility visualization and planning platform 2302. An example controller 2306 includes a facility inspection data circuit 2404 that interprets facility relevant data 3204 in response to the aggregation of inspection data and the user facility request value 2318 (e.g., as received by a user interface component 2304), a CapEx (e.g., capital expenditure) planning circuit 3902 that determines a capital expenditure plan 3904 for at least one industrial facility in response to the facility relevant data 3204, and a facility capital circuit 3906 that determines a capital expenditure display value 3108 in response to the capital expenditure plan 3904, a capital expenditure sensitivity value 3912, and the facility relevant data 3204. For example, the capital expenditure display value 3108 may include aspects of the capital expenditure plan 3904 that are relevant to the user, for example related to facilities the user is responsible for, that the user has permissions to view related data for, according to a role of the user, changed aspects relative to an earlier capital expenditure plan 3904, aspects of the capital expenditure plan 3904 identified by the user, or the like. An example user interface component 2304 provides the capital expenditure display value 3108 to the user interface 2308.

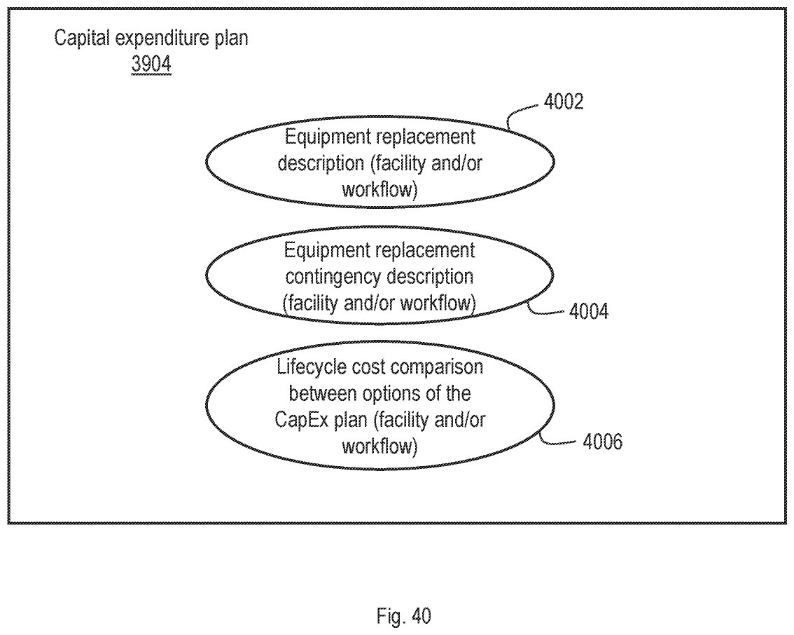

Referencing FIG. 40, example and non-limiting aspects of a capital expenditure plan 3904 are schematically depicted. The example capital expenditure plan 3904 includes one or more aspects such as: an equipment replacement description 4002 (e.g., equipment that should be replaced, at a facility and/or in a workflow, for example: to provide additional capability or operating margin; to take advantage of newly available maintenance and/or inspection operations; to reduce or eliminate the need for maintenance and/or inspection operations; to change operations of a production line and/or workflow (e.g., to create a parallel capability for a critical point in the process, to change a sequence of operations for the process, and/or to otherwise remove or manage a sensitivity and/or dependency in the process); an equipment replacement contingency description 4004 (e.g., indicating detected inspection values and/or failure modes, where the equipment should be replaced in response to the detected values or modes; and/or indicating substitute equipment that can be utilized in response to a detected inspection value and/or failure mode, including potentially changing, upgrading, or replacing the substitute equipment to enable it to operate as a substitute); and/or a lifecycle cost comparison 4006 between options for the capital expenditure plan 3904 (e.g., depicting options for the equipment replacement description 4002 and/or the equipment replacement contingency description 4004, which may include estimated outcomes, uncertainties, and/or sensitivities for each plan; in certain embodiments one of the options may be a status quo option, for example utilizing a capital expenditure plan 3904 that is already in place and/or that is inferred from historical data based on previous ongoing equipment replacement expenditures).

In certain embodiments, the capital expenditure plan 3904 may include a timing value, for example indicating a time for replacement (e.g., which may be a future plan based on estimated useful life remaining for components, equipment, facilities, etc., and/or based on estimated availability and/or installation time for components to be replaced); a sequencing value (e.g., the order and/or timing for replacing multiple components at a facility, within a workflow, etc.); a dependency value (e.g., depicting groups of related components that should be replaced together, and/or groups of components that can be replaced independently; in certain embodiments selection of various equipment groups may be characterized as options for a lifecycle cost comparison 4006; it will be noted that the determination of benefits and/or costs of the capital expenditure plan 3904 between components or component groups may have a dependency that is distinct from the workflow process dependency, where the lifecycle cost comparison 4006 can utilize distinct descriptions of the benefits and/or costs as different replacement options or scenarios; for example a capital expenditure plan 3904 may include a recommendation to replace an upstream gas line with a higher capacity gas line, and a downstream tank with a larger capacity tank, where the larger capacity tank may have no workflow process dependency with the change to the upstream gas line, but the benefits of the larger capacity tank may not be realized if the upstream gas line is not also replaced); and/or a frequency value (e.g., expected service life of components, repeated replacement cycles over time, etc.).

In certain embodiments, the lifecycle cost comparison between options may be normalized (e.g., overall lifecycle cost per unit of production, for example per widget produced, per unit of energy provided, per unit of financial production such as unit of revenue and/or unit of profit), determined according to a steady state averaging of the facility (or workflow) (e.g., averaging for a selected time period, with the impact of capital expenditures managed through accounting practices such as equivalent investments, net present value, initial and residual value of the facility at the beginning and end of the period, etc.), determined according to a cashflow position (e.g., calculations based on estimated actual expenditures during a selected time period, for example capital expenditures, operating costs, maintenance costs, inspection costs, and/or estimated costs to mitigate and/or respond to estimated failures and/or downtime during the period of operation), and/or determined according to financial techniques such a return on investment (ROI) and/or internal rate of return (IRR) for capital expenditures under the capital expenditure plan 3904. The selection of parameters for the operations for the lifecycle cost comparison 4006 is not limited to the examples, and any parameters understood in the art to determine the costs and/or benefits of the capital expenditure plan 3904 are contemplated herein.

In certain embodiments, a CapEx planning circuit 3902 may additionally cooperate with other aspects of the present disclosure, for example a maintenance planning circuit 3202 and/or an inspection planning circuit 4202 (reference FIG. 42 and the related description), to determine the cost/benefits of the capital expenditure plan 3904, for example based on the maintenance schedule 3206, the inspection schedule 4206, and/or changes or recommendations to these. In certain embodiments, adjustments to the maintenance schedule 3206 and/or inspection schedule 4206 may be combined with the capital expenditure plan 3904 to improve the operating space for iterative improvement and/or optimization of the system (e.g., utilizing the coupled and combined outcomes of the capital expenditure plan 3904, maintenance schedule 3206, and/or inspection schedule 4206 to trade off between base component capability, maintenance operations, and inspection operations to improve a success parameter, such as normalized lifecycle cost, cash flow performance, compliance performance, production availability, etc.), to estimate the outcomes of the capital expenditure plan 3904 (e.g., accounting for maintenance and inspection operations related to the plan 3904), and/or to communicate changes in maintenance and/or inspection operations required in response to the capital expenditure plan 3904 (e.g., due to installation of equipment requiring a different inspection or maintenance regime, and/or due to obviated aspects of the inspection and/or maintenance regime, for example due to the removal and/or change of equipment from the capital expenditure plan 3904).

In certain embodiments, a CapEx planning circuit 3902 may additionally cooperate with other aspects of the present disclosure, for example including any of the visual displays (e.g., user geographic display values 3102, view based user geographic display values 3104, maintenance schedule display values 3106, facility display values 3116, inspection schedule display values 3110, inspection surface display values 3112, and/or event display values 3114), operations of circuits that generate and/or determine precursor information for the visual displays, to determine cost/benefit parameters for the capital expenditure plan 3904. For example, a match of estimated performance of the capital expenditure plan 3904 to actual achieved performance may depend upon various facility/workflow execution aspects such as: a response time to detect a failure; a lead time in detecting an imminent failure; a response time to mitigate and/or correct a failure; implementation of an adjusted inspection schedule and/or maintenance schedule; the ability of operators or technical personnel to interact with stakeholders (e.g., to communicate issues, to demonstrate the impact of issues, to coordinate application of resources for those issues, to get approval to adjusted plans for maintenance and/or inspection operations, etc.); and/or the ability of users of the platform 2302 to confirm that adjustments were applied (e.g., continuing performance under updated inspection schedules, maintenance schedules, and/or replacement of equipment or components under the capital expenditure plan 3904). Operations of various systems, controllers, circuits, components, and the like as set forth throughout the present disclosure, where such aspects are present, improve each of these facility/workflow execution aspects, improving the match of estimated performance of the capital expenditure plan 3904 with the actual achieved performance in real facilities, systems, workflows, and the like. Accordingly, operations of the CapEx planning circuit 3902 can achieve an improved performance of a success parameter over time relative to previously known systems.

Additionally or alternatively, operations of the maintenance planning circuit 3202 to determine the actual cost/benefit of an updated maintenance schedule 3206, and/or operations of the inspection planning circuit 4202 to determine the actual cost/benefit of an updated inspection schedule 4206, also depend upon the various facility/workflow execution aspects as set forth preceding. Accordingly, operations of the maintenance planning circuit 3202 and/or the inspection planning circuit 4202 can achieve an improved performance of a success parameter over time relative to previously known systems. It will thus be understood that each of the operations, systems, managers, circuits, and/or components set forth in the disclosure herein provide additive improvements to the operations of the CapEx planning circuit 3902, the maintenance planning circuit 3202, and/or the inspection planning circuit 4202. Such operations include, without limitation: providing a graphical depiction of a hierarchical inspection presentation (e.g., providing an operator or other user with an interface to review operations and performance, and to identify outliers, anomalies, and/or events, and/or to confirm that changes have been implemented); providing view customization of a geographical inspection presentation (e.g., providing tools to facilitate repeated or recursive analysis, and/or to provide stakeholders with an immediate and accurate view of performance, changes, or events); determination and/or updating of a maintenance schedule (e.g., providing tools to evaluate maintenance operations, plan for and confirm changes, manage coupled system effects with inspection and/or capital expenditure plans, and to identify improvement opportunities that may not be readily evident to the user, and that may consider information unavailable to the user such as offset data, third party data, production data, new maintenance procedures, etc.); determination and/or updating of a capital expenditure plan (e.g., providing tools to evaluate the capital expenditure plan, plan for and confirm changes, manage coupled system effects with maintenance and/or inspection plans, and to identify improvement opportunities that may not be readily evident to the user, and that may consider information unavailable to the user such as offset data, third party data, production data, etc.); determination and/or updating of an inspection schedule (e.g., providing tools to evaluate inspection operations, plan for and confirm changes, manage coupled system effects with maintenance and/or capital expenditure plans, and to identify improvement opportunities that may not be readily evident to the user, and that may consider information unavailable to the user such as offset data, third party data, production data, new inspection services, etc.); a user interface for geographical depiction of an inspection presentation (e.g., allowing the user to readily confirm the success and/or applicability of inspection operations, to detect inspection related events, and/or to rapidly and accurately share these with other users such as managers, operators, and/or stakeholders); depicting of inspection surfaces for facilities (e.g., allowing the user to readily confirm the success and/or applicability of inspection operations, to detect inspection related events, and/or to rapidly and accurately share these with other users such as managers, operators, and/or stakeholders); to provide configured event detection and notification through a geographical depiction of inspection data (e.g., allowing the user to readily detect and confirm events, provide notification of events to other users, and to troubleshoot potential causes and effects of the event, and/or to rapidly and accurately share events and related information with other users); to provide a collaborative and/or shareable annotation and markup interface on a digital representation of a component, facility, and/or equipment (e.g., to allow multiple users to work together on equipment using real data, to identify issues or improvements, and to rapidly and accurately share annotated versions of any display values set forth throughout the present disclosure); and/or to provide a robust and interactive analytics interface for users (e.g., allowing the user to combine data, determine statistical evaluations, identify outliers, identify anomalies, and/or test scenarios for adjustments to maintenance operations, inspection operations, and/or a capital expenditure plan, including identifying aspects that may drive uncertainty and/or sensitivity in the updates and/or in regard to existing operations). Accordingly, embodiments herein having a CapEx planning circuit 3902, a maintenance planning circuit 3202, and/or an inspection planning circuit 4202 can therefore be combined with any other aspects of the present disclosure (including one or both of the other ones of the CapEx planning circuit 3902, a maintenance planning circuit 3202, and/or an inspection planning circuit 4202), and such embodiments provide for improved operations of the CapEx planning circuit 3902, the maintenance planning circuit 3202, and/or the inspection planning circuit 4202.

It will additionally be understood that the cost/benefit analysis of updates to the maintenance schedule, inspection schedule, and/or capital expenditure plan interact with the content of the other schedules and/or plans. Accordingly, in certain embodiments, two or more of the maintenance schedule, inspection schedule, and/or capital expenditure plan may be considered together to determine improvements, to perform iterative improvement operations, and/or to perform optimization operations of these. Accordingly, in certain embodiments, the CapEx planning circuit 3902 may determine an updated capital expenditure plan 3904 in combination with the maintenance planning circuit 3202 determining an updated maintenance schedule 3206, and/or in combination with the inspection planning circuit 4202 determining an updated inspection schedule 4206. Similarly, the maintenance planning circuit 3202 may determine an updated maintenance schedule 3206 in combination with the CapEx planning circuit 3902 determining an updated capital expenditure plan 3904, and/or in combination with the inspection planning circuit 4202 determining an updated inspection schedule 4206.

One of skill in the art, having the benefit of the present disclosure and information ordinarily available when considering applicable facilities and embodiments of the present disclosure, can readily determine success parameters utilized to determine updates to inspection operations, maintenance operations, and/or the capital expenditure plan that result in performance improvements for the system (e.g., performance of a facility, workflow, entire group of facilities, a component or unit of equipment, etc.). Example and non-limiting success parameters include one or more of: a normalized lifecycle cost, a cash flow performance, a compliance performance, and/or a production availability. Certain considerations for determining success parameters include, without limitation: priorities for a beneficial entity of the applicable facilities between capital costs and operating costs; the regulatory and/or policy environment for the applicable facilities; the priority and impact of reputational risks in response to production failures, shutdowns, or other events (e.g., including reputational risks with suppliers, customers, service providers, operators, and/or the general public); the availability of components, inspection operations and/or providers, and/or maintenance operations and/or providers; infrastructure considerations for alternative components or equipment (e.g., the availability of physical space and/or an appropriate operating environment for the alternatives, availability to meet power requirements, availability to meet water requirements, etc.); the accounting practices and/or financial analysis preferences of a beneficial entity of the applicable facilities (e.g., whether investment decisions are made based on ROI, IRR, NPV, or other financial techniques); the expected lifecycle of a facility or product (e.g., the beneficial entity plans to close a plant in 30 years, and/or product is expected to be discontinued in 5 years, for example defining a maximum time horizon for analyzing benefits); and/or the expected disposal of a facility or workflow (e.g., the beneficial entity plans to sell a plant in 10 years, which may limit the time horizon for analysis, and/or analysis may be performed based on the state of the plant at the 10 year mark, and the expected analysis of the plant by a potential buyer at that time).

A person of skill in the art, having the benefit of the present disclosure and information ordinarily available when considering applicable facilities and embodiments of the present disclosure, can readily determine which aspects of the present disclosure would be beneficial for planned systems incorporating embodiments herein. Each one of the aspects of the present disclosure provides for benefits over previously known systems, such as: providing a graphical depiction of a hierarchical inspection presentation; providing view customization of a geographical inspection presentation; determination and/or updating of a maintenance schedule; determination and/or updating of a capital expenditure plan; determination and/or updating of an inspection schedule; providing a user interface for geographical depiction of an inspection presentation; depicting of inspection surfaces for facilities; providing configured event detection and notification through a geographical depiction of inspection data; providing a collaborative and/or shareable annotation and markup interface on a digital representation of a component, facility, and/or equipment; and/or to providing a robust and interactive analytics interface for users. Certain considerations for determining whether inclusion of a combination of two or more aspects of the present disclosure is indicated for a particular system include, without limitation: the organizational compartmentalization of visibility to facility operations, facility outcomes, applicable regulatory schemes, and future plans for products and/or facilities; the organizational division of responsibility for financial analysis and financial authority for facilities applicable to the system; the number of facilities, units of equipment, and the like within the scope of the overall system and related workflows (e.g., whether the overall system has a sufficient number of units to provide for statistically significant determinations for event detection, improvement analysis, etc.); the number of approvals needed, and the role and/or expertise of approvers, to implement changes to a facility, workflow, component, unit of equipment, etc.; the roles and responsibilities of users interacting with the system (e.g., operator, manager, supervision of other users, equipment operator, production operator, etc.); and/or the applicable workloads, competing responsibilities, and/or time available for monitoring, evaluation, planning, and/or analysis of the system for any of the users described preceding.

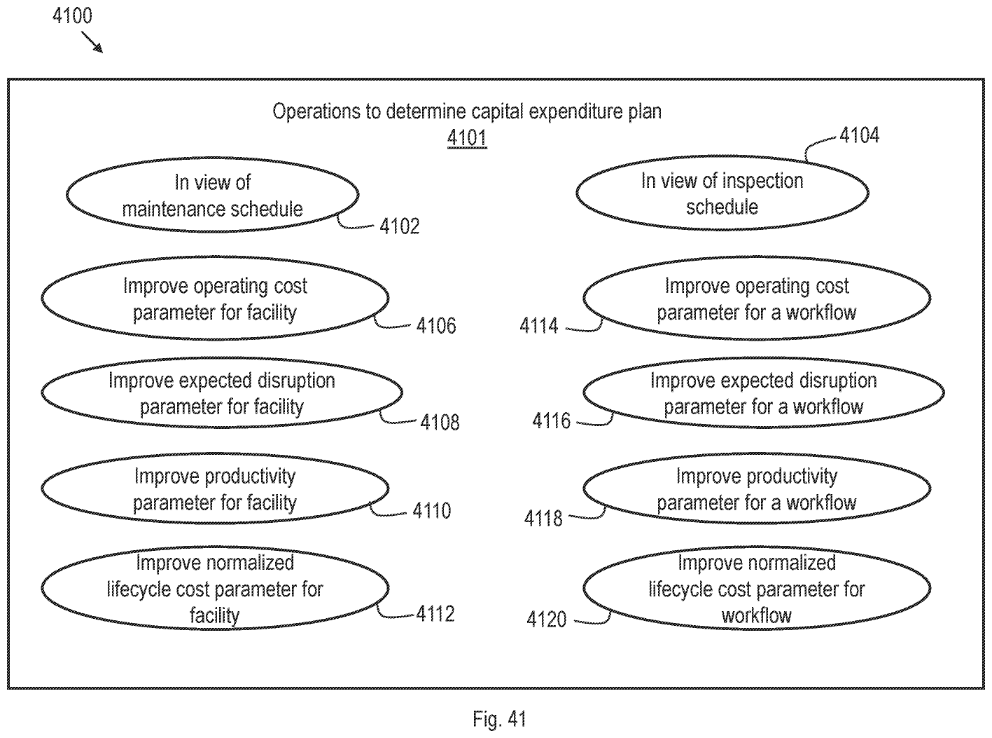

Referencing FIG. 41, an illustration 4100 of example operations 4101 of the CapEx planning circuit 3902 to determine a capital expenditure plan 3904 are schematically depicted. The operations 4101 are not limiting to any other aspect of the present disclosure. Example operations 4101 include: an operation 4102 to determine the capital expenditure plan 3904 in response to the maintenance schedule (and/or a planned update to the maintenance schedule, which may be for a unit of equipment, a facility, and/or a workflow); an operation 4104 to determine the capital expenditure plan 3904 in response to the inspection schedule (and/or a planned update to the inspection schedule, which may be for a unit of equipment, a facility, and/or a workflow); an operation 4106 to improve an operating cost parameter for a facility; an operation 4108 to improve an expected disruption parameter for a facility (e.g., to reduce the risk of a disruption, and/or to reduce the consequences of the disruption); an operation 4110 to improve a productivity parameter for a facility (e.g., to improve throughput, reduce downtime, increase uptime, etc.); an operation 4112 to improve a normalized lifecycle cost parameter for the facility; an operation 4114 to improve an operating cost parameter for a workflow; an operation 4116 to improve an expected disruption parameter for a workflow; an operation 4118 to improve a productivity parameter for a workflow; and/or an operation 4120 to improve a normalized lifecycle cost parameter for a workflow.

Referencing FIG. 42, an example system 4200 for configuring an inspection content based schedule, and/or for configuring an inspection schedule based on third party data is schematically depicted. The example system 4200 may be embodied as a controller 2306 on a facility visualization and planning platform 2302. The example controller 2306 includes a facility inspection data circuit 2404 that interprets facility relevant data 3204 in response to the aggregation of inspection data and the user facility request value 2318 (e.g., provided by a user interface component 2304 in response to operations on a user interface 2308), an inspection planning circuit 4202 that determines an inspection schedule 4206 for at least one industrial facility in response to the facility relevant data 3204, and a facility inspection circuit 4204 that determines an inspection schedule display value 3110 in response to the inspection schedule 4206 and the facility relevant data 3204. For example, the inspection schedule display value 3110 may include elements of the inspection schedule 4206 that have changed, that are within the scope of responsibility for a user, that are permitted for data visibility to the user, etc. An example user interface component 2304 provides the inspection schedule display value 3110 to the user interface 2308.

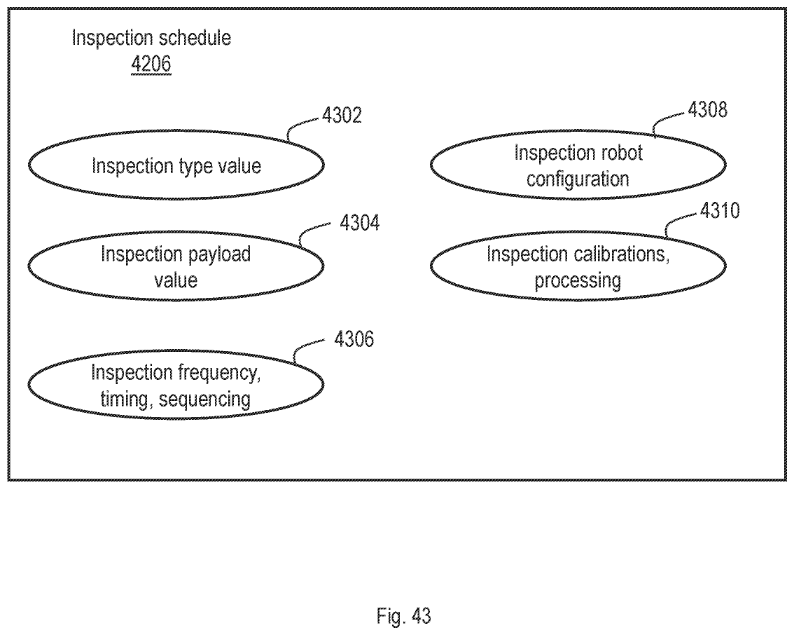

Referencing FIG. 43, an example inspection schedule 4206 includes one or more aspects such as: an inspection type value 4302 (e.g., an inspection type such as wall thickness determination, weld affected area inspection, corrosion inspection, etc., and/or an inspection type such as an inspection service name, specific sensor type, etc.); an inspection payload value 4304 (e.g., a specific payload to be utilized, such as a configuration and/or name for the payload, a number and type of sensor to be included on the payload, and/or payload configuration such as an ability to raise/lower the payload and/or a payload width); an inspection frequency, timing, and/or sequencing 4306 (e.g., scheduling for inspection of specific components; a sequencing of inspecting components; a sequencing for inspection operations on a given component (e.g., to allow subsequent inspection operations to be configured, confirmed, or declined in response to earlier inspection operations); and/or a frequency of inspection operations to be applied to various components); an inspection robot configuration 4308 (e.g., according to an inspection area, surface height, surface conditions such as temperatures and/or corrosion, etc., includes imaging, positioning, repair, and/or marking capability; and/or to ensure that an inspection robot performing inspection operations has appropriate capability); and/or inspection calibrations and/or processing 4310 (e.g., configured to inspect appropriate depths, to manage surface coatings, to provide appropriate resolution of inspection operations, etc.).

In certain embodiments, the facility relevant data 3204 includes offset facility data, and/or third party facility data (e.g., data from a facility having a different owner, operator, manager, or the like relative to a facility intended for the inspection schedule 4206, which may include a facility for which the owner, operator, and/or manager for the facility intended for the inspection schedule 4206 does not have permissions to access data related to the offset facility and/or third party facility). An example facility inspection circuit determines the inspection schedule display value 3110 in response to a facility inspection record of the aggregation of inspection data, for example marking inspection operations that have already occurred or are planned, to highlight changes in the inspection schedule 4206 that would be different from a previous inspection schedule and/or inspection operations performed, etc.

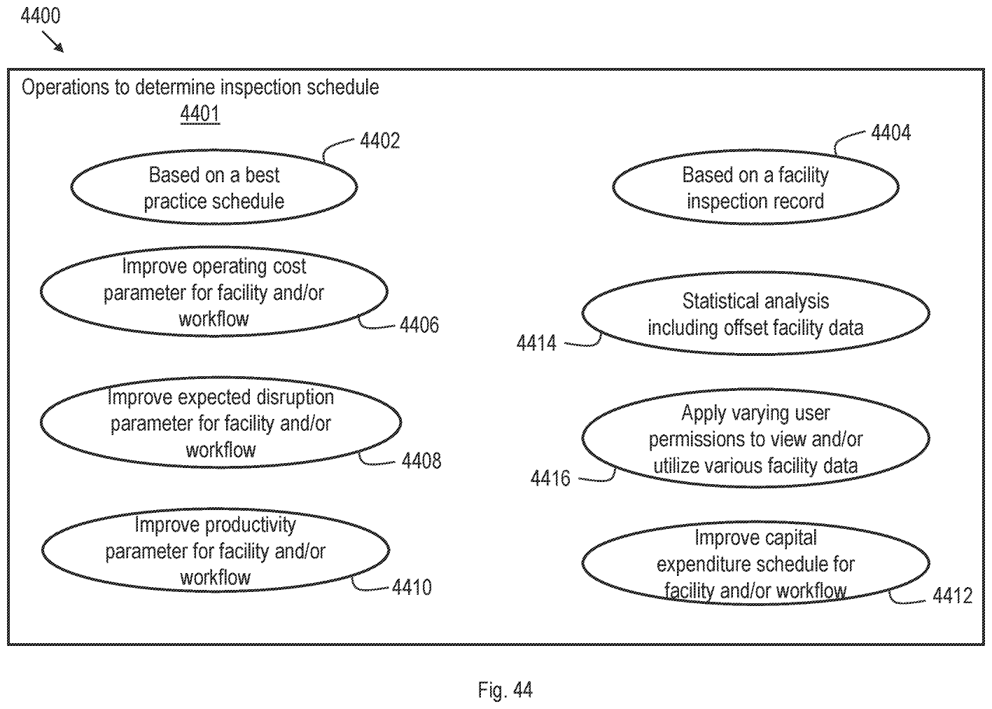

Referencing FIG. 44, an illustration 4400 of operations 4101 by the inspection planning circuit 4202 to determine the inspection schedule 4206 are schematically depicted. The example operations 4101 include, without limitation to any other aspect of the present disclosure, operations such as: an operation 4402 to determine the inspection schedule based on a best practice inspection schedule; an operation 4404 to determine the inspection schedule based on a facility inspection record; an operation 4406 to determine the inspection schedule to improve an operating cost parameter for a facility and/or workflow; an operation 4408 to determine the inspection schedule to improve an expected disruption parameter for a facility and/or workflow; an operation 4410 to improve a productivity parameter for a facility and/or workflow; an operation 4414 to determine the inspection schedule in response to a statistical analysis including offset facility data (and/or third party facility data; e.g., to determine an inspection scheme that is likely to provide sufficient lead time for failures to prevent and/or mitigate the consequences of the failures, e.g., based on predicted wear rates, failure mode development, etc.); an operation 4416 to apply varying user permission to view and/or utilize various facility data (e.g., preventing the user from accessing offset facility data and/or third party data that is not permissible, limiting the inspection schedule display value 3110 to aspects of interest to the user, etc.); and/or an operation 4412 to determine the inspection schedule in response to improving a capital expenditure schedule for the facility and/or workflow. In certain embodiments, operation 4401 includes determining the inspection schedule in response to improving a maintenance schedule for the facility and/or workflow.

In some aspects, the techniques described herein relate to a system, wherein the facility inspection circuit is further structured to determine an inspection notification value in response to the inspection schedule and the facility relevant data, and wherein the user interface component is further configured to provide the inspection notification value to a user of the facility visualization and planning platform.

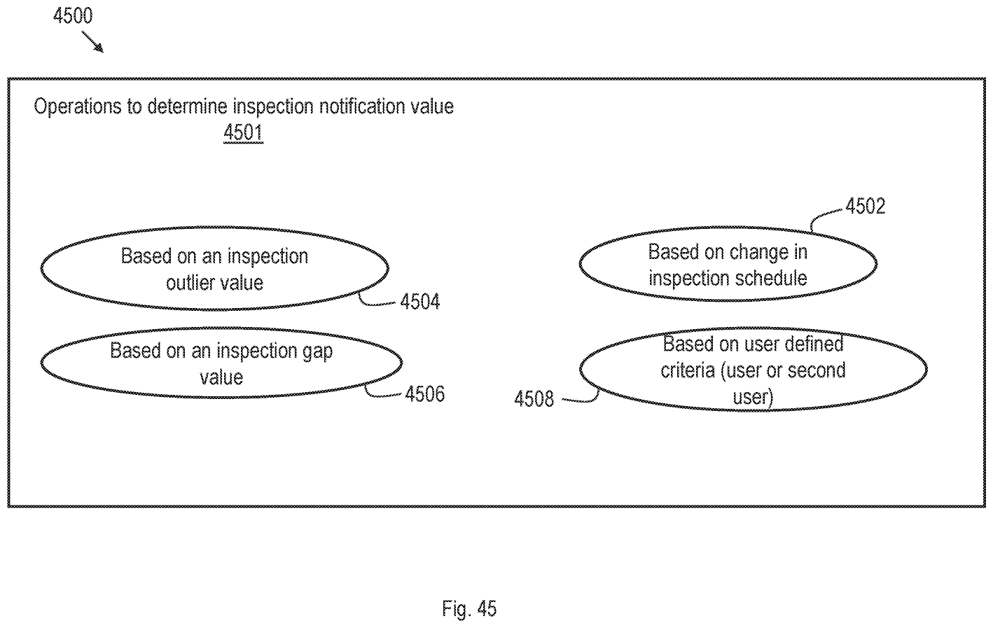

In certain embodiments, the facility inspection circuit 4204 determines an inspection notification value 4210, which may be provided to a user by the user interface component 2304. Referencing FIG. 45, an illustration 4500 of operations 4501 by the facility inspection circuit 4204 to determine the inspection notification value 4210 is schematically depicted. Example operations 4501 include one or more of: an operation 4504 to determine the inspection notification value 4210 in response to an inspection outlier value (e.g., determining that the inspection schedule and/or inspection results are an outlier with respect to offset facilities, third party facilities, and/or historical performance of inspection operations for the facility, where the outlier may be statistically determined under similar considerations to the operations 3704 to determine the maintenance outlier value described preceding); an operation 4506 to determine the inspection notification value 4210 in response to an inspection gap value (e.g., inspection events that have been missed, that are unavailable, unsuccessful inspection events, compliance gaps (e.g., including a notification of gaps that are accepted, for example under a waiver), inspection events that have exceeded a planned cost and/or downtime, and/or aspects of the inspection schedule that may not be achievable (e.g., due to a limited number of providers, limited amount of specialized equipment, and/or based on historical performance of the inspection events for the same or similar facilities)); an operation 4508 to determine the inspection notification value 4210 in response to any user defined criteria (e.g., including providing the inspection notification value 4210 to a second user); and/or an operation 4502 to provide the inspection notification value 4210 based on a change in the inspection schedule.

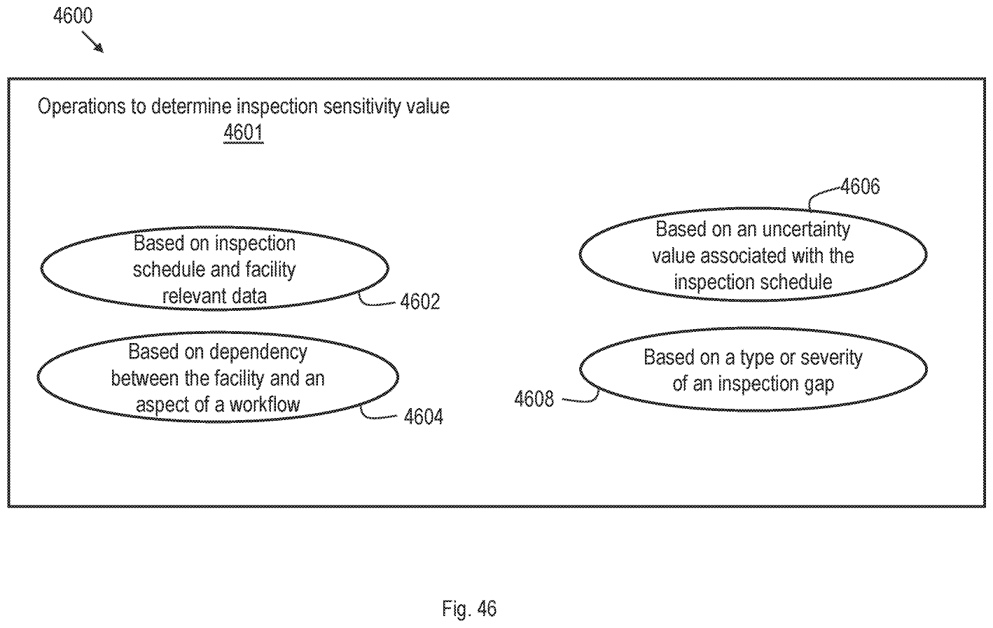

In certain embodiments, the facility inspection circuit 4204 determines an inspection sensitivity value 4212, which may be provided to a user by the user interface component 2304. Referencing FIG. 46, an illustration 4600 of operations 4601 by the facility inspection circuit 4204 to determine the inspection sensitivity value 4212 is schematically depicted. Example operations 4601 include one or more of: an operation 4602 to determine the inspection sensitivity value 4212 in response to the inspection schedule and facility relevant data (e.g., determining aspects of the inspection schedule that are at risk (e.g., utilizing competing resources with other facilities, having limited time windows to perform operations, and/or having marginal capability to address identified risks)); an operation 4604 to determine the inspection sensitivity value 4212 based on a dependency between the facility and an aspect of a workflow (e.g., to highlight externalities related to the inspection operations that may indicate exposure to greater losses than are evident just considering the facility and/or inspected component alone); an operation 4606 to determine the inspection sensitivity value 4212 based on an uncertainty value associated with the inspection schedule (e.g., highlighting uncertainties related to selecting the proper inspection scheme, detecting intended conditions of the inspected component, and/or execution of the inspection schedule); and/or an operation 4608 to determine the inspection sensitivity value 4212 based on a type or severity of an inspection gap.

Again referencing FIG. 42, an example system 4200 includes a facility inspection data circuit 2404 that interprets facility relevant data 3204 and offset facility data in response to the aggregation of inspection data, where the inspection planning circuit 4202 determines an inspection schedule 4206 for at least one industrial facility in response to the facility relevant data 3204 and the offset facility data, and a facility inspection circuit 4204 that determines an inspection schedule display value 3110 in response to the inspection schedule 4206 and the facility relevant data 3204. In certain embodiments, the offset facility data includes data from a number of offset facilities for the at least one industrial facility. An example inspection planning circuit 4202 determines the inspection schedule 4206 by performing a statistical analysis of the offset facility data, and/or of the facility relevant data 3204 in combination with the offset facility data. In certain embodiments, a first owner of the at least one industrial facility is distinct from a second owner (or owners) of one or more, or all, of the number of offset facilities. In certain embodiments, a user providing the user facility request value 2318 has a first set of permissions for the at least one industrial facility, and a second set of permissions associated with one or more, or all, of the offset facilities. In certain embodiments, the first set of permissions includes a higher permissions level (e.g., greater permissions to view data, facilities, facility information, and/or provide approvals) than the second set of permissions. In certain embodiments, the second set of permissions includes the user not having permissions (e.g., not able to view the facilities, related data, and/or wherein the user interface component 2304 does not provide any awareness of the existence of one or more, or all, of the offset facilities).

Again referencing FIG. 24, an example system 2400 includes the geographic depiction circuit 2406 determining a geographic display boundary 2412 and a facility inspection presentation 2418 for at least one industrial facility positioned within the geographic display boundary 2412 in response to the user facility visualization value 2408 and the aggregation of inspection data 2410, and determining a user geographic display value 3102 in response to the geographic display boundary 2412 and the facility inspection presentation 2418. An example user interface component 2304 provides the user geographic display value 3102 to the user interface 2308.

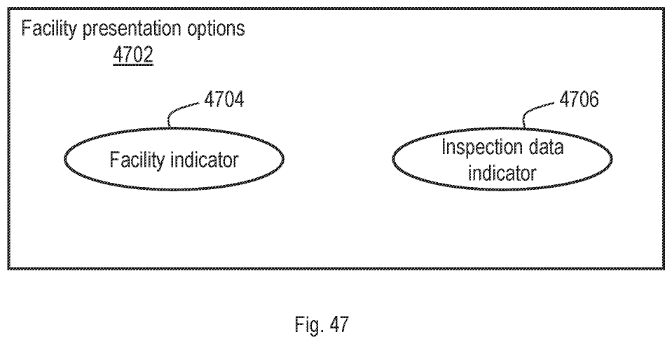

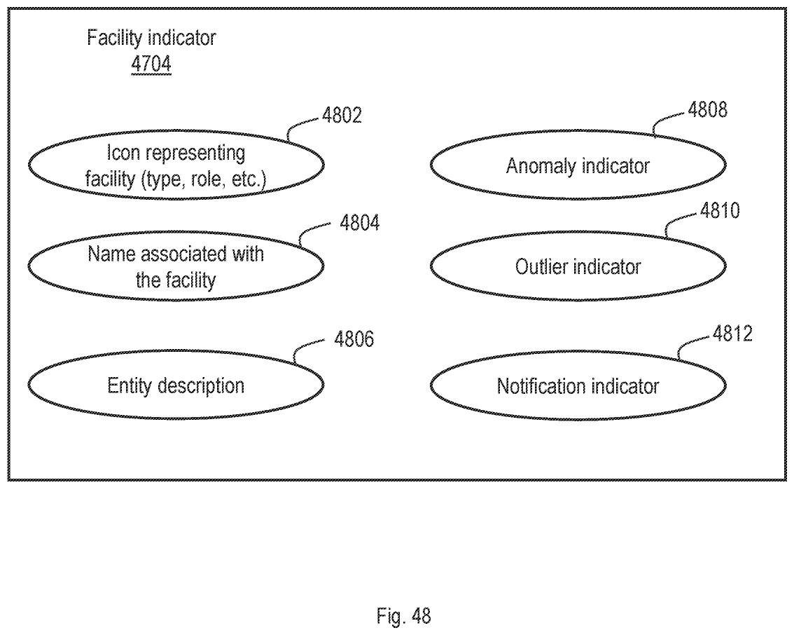

Referencing FIG. 47, example facility inspection presentation options 4702 include a facility indicator 4704 and/or an inspection data indicator 4706. Referencing FIG. 48, example and non-limiting facility indicators 4704 include one or more of: an icon 4802 representing the facility (e.g., a facility type, role, sized according to importance, productivity, throughput, etc.); a name 4804 associated with the facility (e.g., a nickname, an identifying name, a name used by an organization associated with the facility, etc.); an entity description 4806 (e.g., an indicator of an owner, operator, manager, etc. associated with the facility); an anomaly indicator 4808 (e.g., an indicator that some aspect of the facility is anomalous, such as excessive downtime, inspection information indicating an issue at the facility, overdue operations such as maintenance, service, and/or inspection operations, etc.); an outlier indicator 4810 for the facility (e.g., an indicator that some aspect of the facility is determined to be an outlier, for example based on inspection schedules or results, maintenance schedules or results, etc., and which may be determined in response to historical information for the facility and/or offset facilities); and/or a notification indicator 4812 for the facility (e.g., an indicator than any notification as set forth throughout the present disclosure has been sent, and/or providing the notification indicator 4812 as a part of providing the notification to a user).

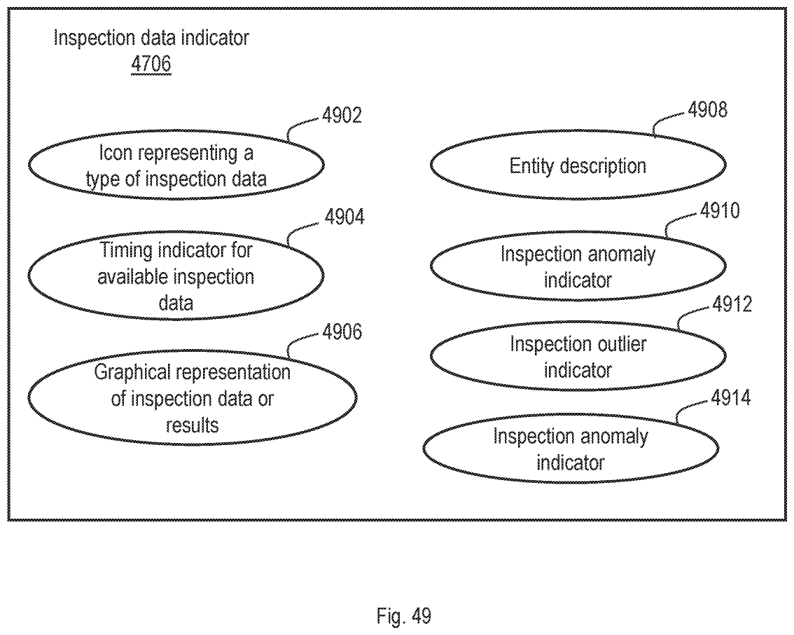

Referencing FIG. 49, example and non-limiting inspection data indicator 4706 options include one or more of: an icon 4902 representing a type of inspection data (e.g., inspection operations performed, sensor types utilized, and/or payloads or configurations of an inspection robot utilized); a timing indicator 4904 for inspection data (e.g., a most recent inspection date, an upcoming inspection operation, an aging indicator for inspection data, etc.); a graphical representation 4906 of inspection data or results (e.g., a graph, surface depiction, color coded and/or icon shape selected to indicate that inspection results were normal, indicated an off-nominal condition, and/or an indication of missing inspection information); an entity description 4908 (e.g., an entity performing inspection operations, a responsible party for ordering and/or approving inspection operations, etc.); an inspection anomaly indicator 4910 (e.g., an indicator of an anomaly determined from inspection operations, and/or about the inspection operations such as an incomplete inspection, delayed inspection, inspection that had a cost and/or operational time that was unusual, missing inspection information, and/or inspection data that may be incorrect or suspect); an inspection outlier indicator 4912 (e.g., inspection operations, schedule, and/or inspection data determined to be an outlier in some sense relative to historical information about the facility and/or relative to offset facilities); and/or an inspection notification indicator 4914 (e.g., an indicator than any notification as set forth throughout the present disclosure has been sent, and/or providing the inspection notification indicator 4914 as a part of providing the notification to a user). The utilization of icons, as described herein, includes selecting an icon picture (e.g., the pictorial content for the icon), color scheme (e.g., fill colors, gradients, outline colors, primary and secondary colors, highlight colors, etc.), line scheme (e.g., solid lines, double lines, dashed lines, dotted lines, etc.), opacity (e.g., providing an icon where the background can selectively be seen through the icon), sizing (e.g., the scale of the icon, relative to other icons and/or other features of the display), and/or rotation (e.g., rotating the icon relative to a nominal background orientation scheme, such as relative to north at the top of the display). The configuration of icons, text, and the like can be utilized to indicate selected aspects, for example uncertainty and/or sensitivity values may be reflected utilizing opacity modulation, solid/dashed manipulation, etc. In another example, color schemes may be utilized to indicate associated entities (e.g., green or purple outlines for inspection data representations indicating a provider of inspection services) and/or notification types (e.g., primary color scheming in red indicating active issues, green indicating nominal operation, etc.). The described examples are non-limiting. The indicators 4704, 4706 provided have a number of levers that can be utilized as desired to communicate any desired information in a consistent manner on the user interface 2308, as set by user preferences, and/or which may be varied through various hierarchy layer.

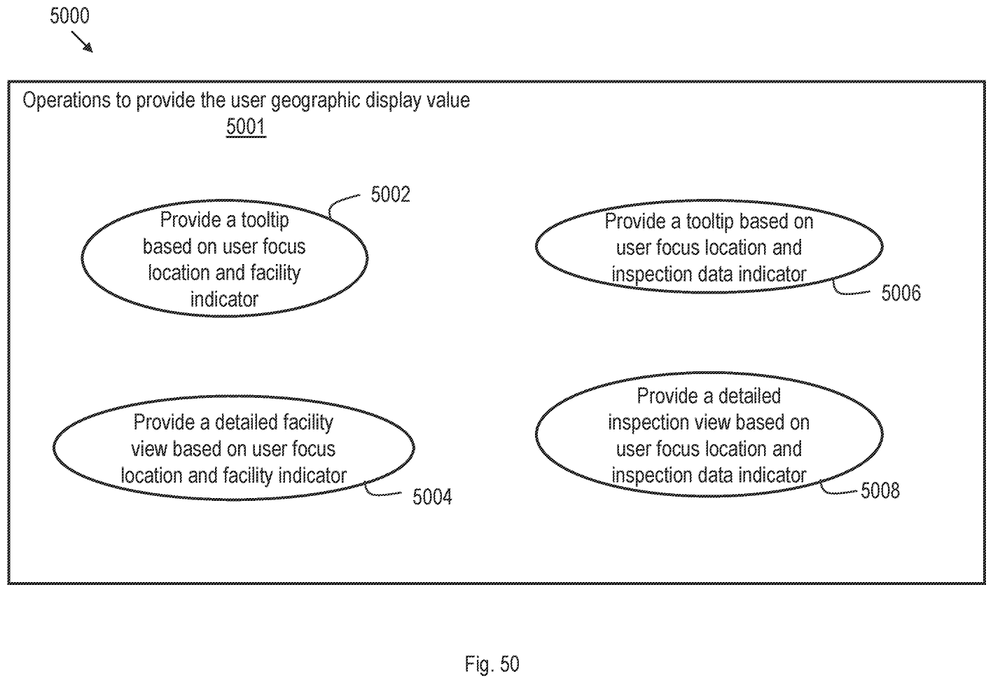

Referencing FIG. 50, an illustration 5000 of example operations 5001 of a user interface 2308 to provide the user geographic display value 3102, and/or operations of the geographic depiction circuit 2406 to configure the user geographic display value 3102, are schematically depicted. Example operations 5001 include one or more of: an operation 5002 to provide a tooltip based on a user focus location (e.g., a mouse location, cursor location, tabbed focus location, etc.) and the facility indicator 4704; an operation 5004 to provide a detailed facility view in response to the user focus location and the facility indicator 4704 (e.g., navigating down a hierarchy layer, and/or pulling up a detailed facility view for the facility, for example providing additional detail about the facility, a description of any notifications or indicators provided at the upper level, providing a physical view of equipment at the facility, providing a facility map with equipment locations, etc.); an operation 5006 to provide a tooltip based on a user focus location and the inspection data indicator 4706; and/or an operation 5008 to provide a detailed inspection view based on the user focus location and inspection data indicator (e.g., a more detailed summary or display of inspection data, an inspection surface display with inspection data positioned thereon in text, graphically, and/or utilizing shading or cross-hatching). In certain embodiments, user operations to access a tooltip may be distinct from operations to access the detailed view, for example a tooltip may appear in response to hovering over the relevant feature, where the detailed view may appear in response to a selection operation, and/or an alternate selection operation (e.g., a right click, shift click, etc.). In certain embodiments, information depicted in the tooltip may be more abbreviated than the detailed view, for example an intermediate level of detail between the top level view (e.g., based on map, icons, and/or limited text) and the detailed view (e.g., allowing full descriptions, tables, graphs, and/or depictions of specific equipment). In certain embodiments, the user interface component 2304 supports additional navigation beyond the detailed view, for example allowing access to raw data, inspection calibrations, maintenance work orders, and/or any other detail about a facility, a component or unit of equipment, entities named or depicted on the display, or the like. In certain embodiments, the detailed view and/or tooltip exist as one of the levels in a hierarchy scheme (e.g., reference FIGS. 25-27 and the related description). In certain embodiments, one or both of the detailed view and/or tooltip are interface elements that exist outside of the hierarchy scheme, and/or are available in embodiments that do not use a hierarchy scheme.

Referencing FIG. 51, an example system 5100 for depicting an inspection surface for industrial facilities is schematically depicted. The example system 5100 may be embodied as a controller 2306 on a facility visualization and planning platform 2302. The example controller 2306 includes a facility planning circuit 2402 that interprets a user facility visualization value 2408 in response to the visualization request value (e.g., received by a user interface component 2304), a facility inspection data circuit 2404 that interprets the aggregation of inspection data 2410 in response to the user facility visualization value 2408, and an inspection surface depiction circuit 5102 that determines a facility inspection presentation 2418 for at least one industrial facility in response to the user facility visualization value 2408 and the aggregation of inspection data 2410, and determines an inspection surface display value 3112 for at least one component of the at least one industrial facility in response to the facility inspection presentation 2418. An example user interface component 2304 provides the inspection surface display value 3112 to the user interface 2308.

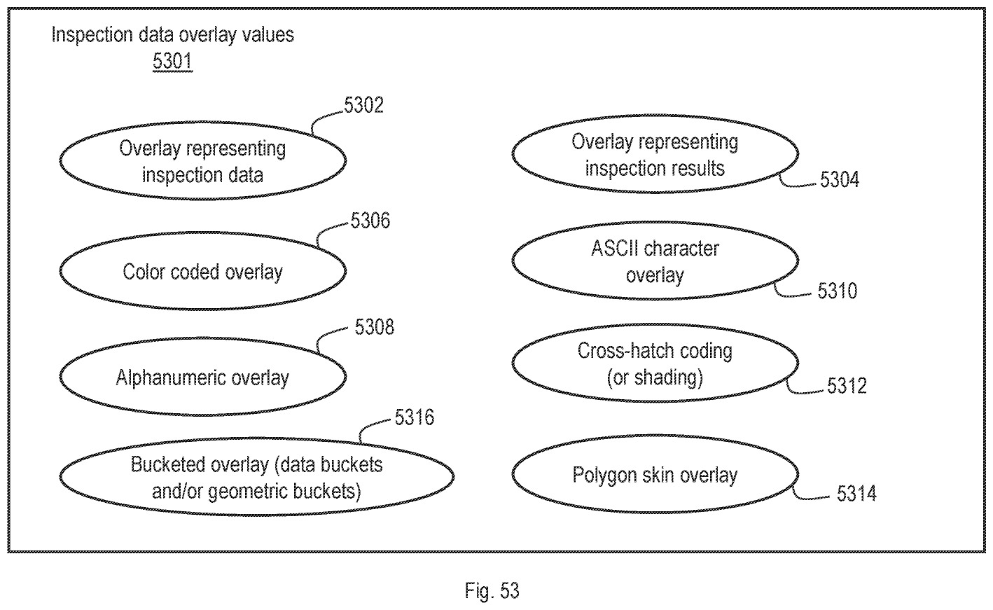

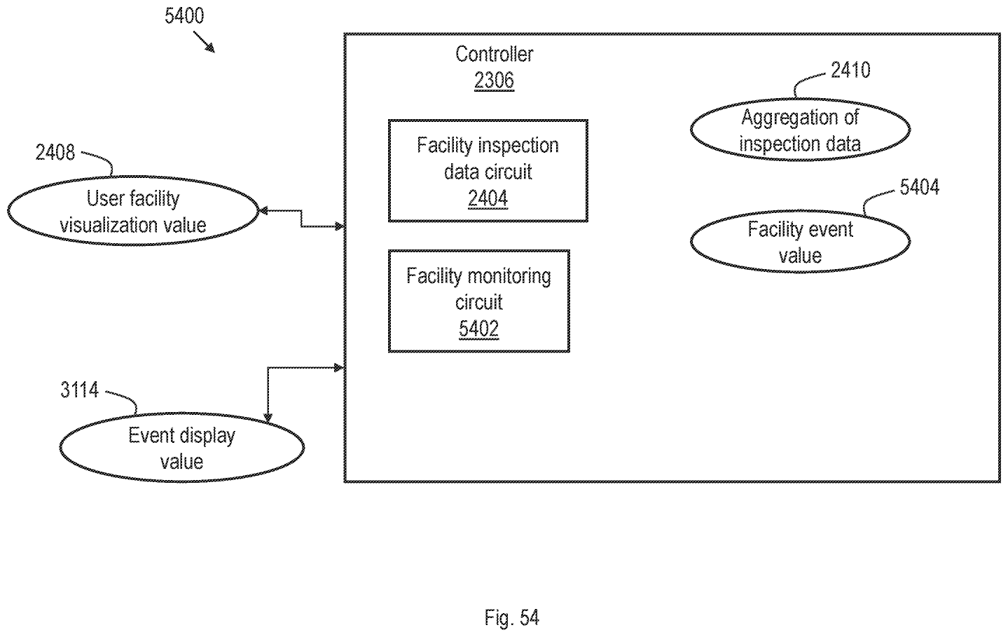

Referencing FIG. 52, example and non-limiting options for an example inspection surface display value 3112 are depicted. The example inspection surface display value 3112 includes one or more of: a tooltip view 5202 of a facility on a user interface 2308 of user geographic display values 3102 (e.g., a high level view of a component having inspection data of interest, a highest value component of the facility, a component relevant to an active notification, etc.); a detailed inspection view 5204 of a facility on the user geographic display (e.g., a detailed view of the facility, of a component of the facility, a map of the facility, etc., with inspection data and/or results overlaid and/or summarized for one or more components of the facility); a facility depiction 5206 adapted from a photograph (e.g., a photograph of one or more components of the facility, and/or of the facility (e.g., an aerial view), with inspection data and/or results overlaid on the relevant component depictions); a facility depiction 5208 adapted from inspection imaging data (e.g., inspection data and/or results coupled with imaging data from the inspection, for example images related to areas of interest, obstacles, and/or areas having inspection data that indicates wear, corrosion, or a component failure); a facility depiction 5210 adapted from a schematic drawing (e.g., for the facility and/or a component of interest, including an artist's depiction, a nominal drawing such as a generic depiction of the type of component, an auto-generated drawing having the basic characteristics and/or shape of the component, and/or a high level depiction such as a marketing depiction of the component); a facility depiction 5212 adapted from an engineering drawing (e.g., an engineering schematic of a component of interest, potentially with obfuscated or omitted elements to protect proprietary information); a facility depiction 5214 adapted from a manufacturing drawing (e.g., a drawing provided by a manufacturer of the component of interest, such as in an integration manual, sales manual, technical support documents, etc., and with potentially obfuscated or omitted elements to protect proprietary information); a facility depiction 5216 adapted from a near net geometric representation (e.g., a depiction of the facility and/or components of interest, approximately shaped like the components, but potentially missing aspects such as fasteners, obstacles, minor deformation (e.g., dents, scratches, bulges, etc.)); and/or a facility depiction with an inspection data overlay 5218 (e.g., depicting inspection data and/or results over the depiction of the facility and/or a component thereof, for example where the display is numerical, graphical, shaded, color coded, etc.; the resolution of the overlay is selectable and may be adjusted according to user preference, the resolution of the underlying inspection data, whether regions of interest on the surface are present, and/or the size and distribution of the regions of interest; also reference FIG. 53 and the related description).

Referencing FIG. 53, example and non-limiting inspection data overlay values 5301 are depicted. The examples are non-limiting to illustrate various examples of overlay information that can be provided. In certain embodiments, different overlay values may be provided based on the specific view (e.g., a map, detailed view, tooltip, etc.), user preferences, different layers in a hierarchical scheme, etc. Example inspection data overlay values 5301 include one or more of: an overlay representing inspection data 5302 (e.g., an overlay using an analog for inspection data, such as a numbering scheme, color scheme, shading scheme, etc.); a color coded overlay 5306 (e.g., where colors provide an analog for the inspection data, indicate various inspection determined status values, missing or suspect inspection data, etc.); an alphanumeric overlay 5308 (e.g., alphanumeric characters providing an analog for the inspection data, indication of detected conditions, and indication of missing or suspect data, etc.); an overlay representing inspection results 5304 (e.g., status indicators, condition indicators, and/or areas related to notifications); an ASCII character overlay 5310 (e.g., similar to an alphanumeric overlay 5308, with additional capability to use characters such as punctuation marks, parentheticals, mathematical symbols, etc.); a cross-hatch and/or shading coding 5312 (e.g., using a hatching direction, type, and/or density to provide an indicator of inspection data and/or inspection results on the surface); a polygon skin overlay 5314 (e.g., providing the inspection data overlay as a skin over a depiction of the component, for example an inspection surface display value 3112, where the skin may be embodied as a texture for the inspection surface display value 3112, and/or as a polygon grid placed over the depiction of the component); and/or a bucketed overlay 5316 (e.g., where the bucketing can be data related, such as a color coding, character scheme, and/or cross-hatch scheme that indicates inspection data values placing the depicted portion within a given range, and/or having a determined inspection result; and/or the bucketing can be spatially related, for example selecting the spatial resolution of inspection data, where each block, for example a grid square or rectangle, and/or a polygon grid element, is marked with an average of the inspection data therein, a variability of the inspection data therein (e.g., a range of the data, and/or a standard deviation of the data), and/or marked with a highest value (e.g., thickest observed wall section), a lowest value (e.g., a thinnest observed wall section), a distribution description (e.g., average top and bottom quintile of the data), and/or combinations of these).

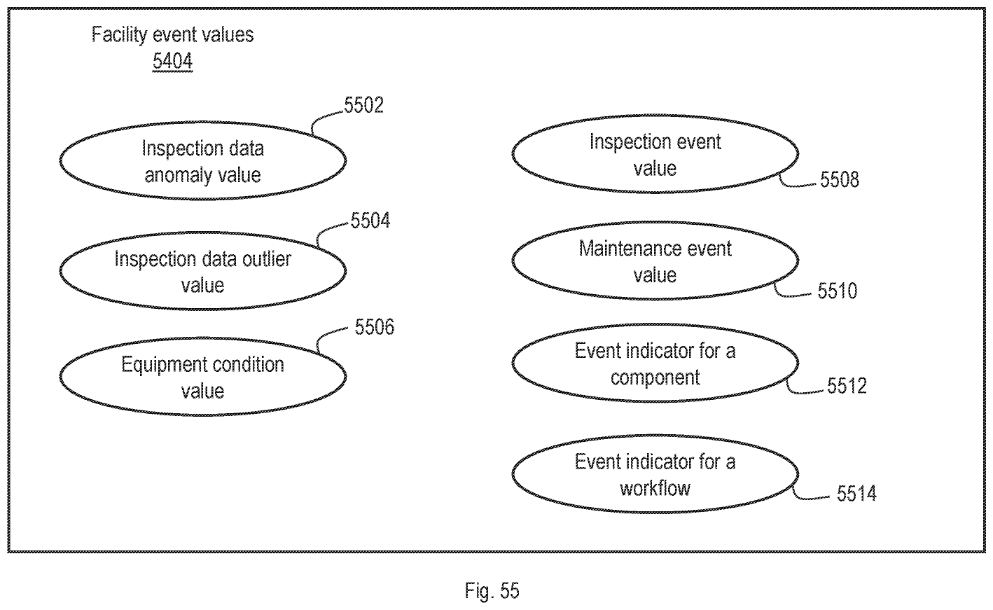

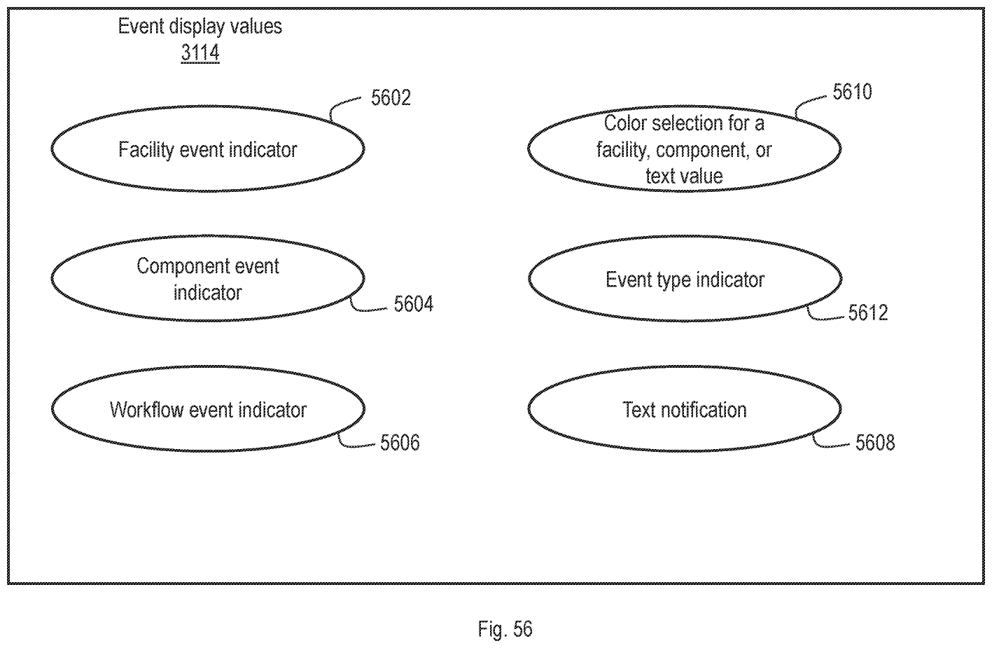

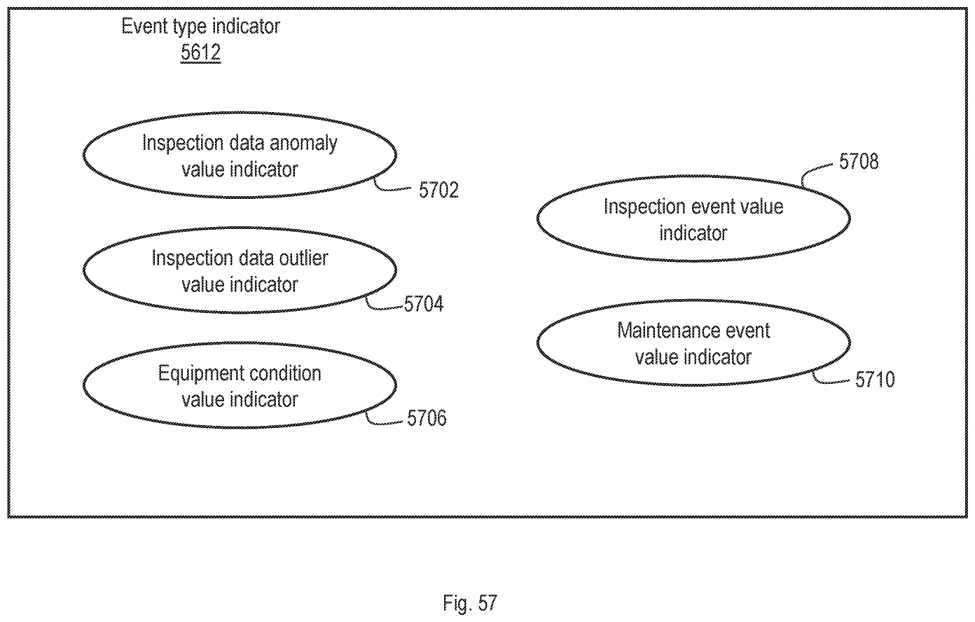

Referencing FIG. 54, an example system 5400 for rapid event detection using a geographical depiction of inspection data is schematically depicted. The example system 5400 may be embodied as a controller 2306 on a facility visualization and planning platform 2302. The example controller 2306 includes a facility monitoring circuit 5402 that determines a facility event value 5404 for at least one industrial facility in response to the visualization request value (e.g., received from a user interface component 2304) and the aggregation of inspection data 2410, and determines an event display value 3114 for at least one component of the at least one industrial facility in response to the facility event value 5404. An example user interface component 2304 provides the event display value 3114 to the user interface 2308. Referencing FIG. 55, example and non-limiting facility event values 5404 include one or more of: an inspection data anomaly value 5502 (e.g., an anomaly determined from inspection data, for example missing data, suspect data, a potential failed or non-compliant condition, a condition indicating excessive estimated wear or degradation, etc.); an inspection data outlier value 5504 (e.g., inspection data indicating an outlier condition, such as based on historical inspection information for a facility or related component, inspection information for offset facilities, a lack of variability of the inspection data, excessive uniformity or other unusual characteristics of the inspection data, etc.); an inspection event value 5508 (e.g., a detected failure condition, an inspection performance event such as excess cost and/or performance time, a failure to complete inspection operations, an update to an inspection schedule, etc.); a maintenance event value 5510 (e.g., a failure to complete maintenance operations, a missed or delayed maintenance event, a condition of the facility noted during maintenance operations, an equipment condition value 5506, an excess cost and/or performance time of the maintenance event, an update to a maintenance schedule, etc.); an event indicator for a component 5512 (e.g., any of the facility event values 5404 for a component of the facility); and/or an event indicator for a workflow 5514 (e.g., an indicator of an effect on the workflow due to any of the foregoing for the facility). An example facility event value 5404 includes an indicator of an update to a capital expenditure plan. Referencing FIG. 56, example and non-limiting event display values 3114 include one or more of: a facility event indicator 5602 (e.g., an indicator on the user interface 2308 notifying of the event, and/or providing an indication of the type and/or impact of the event, which may be an icon adjustment, text adjustment, color adjustment, line selection adjustment, etc.); a component event indicator 5604 (e.g., an indicator on the user interface 2308 notifying of the event, and/or providing an indication of the type and/or impact of the event, which may be shown on the facility for certain displays and/or at certain hierarchy levels, and shown specific to the component for other displays, tooltips, detailed views, certain hierarchy levels, etc.); a workflow event indicator 5606; a color selection 5610 for a facility, component, and/or text value (e.g., the color selected as an indicator of the existence of the event, a type of the event, and/or an impact of the event); and/or a text notification 5608 (e.g., a summary or description of the event, and/or a character indicating the event, depending on the specific view, selected hierarchy level, etc.). Referencing FIG. 57, example and non-limiting event type indicators 5612 include one or more of: an inspection data anomaly value indicator 5702 (e.g., an icon, graphical representation, notification, and/or text value indicating an inspection data anomaly for a facility, component, or related workflow); an inspection data outlier value indicator 5704 (e.g., an icon, graphical representation, notification, and/or text value indicating an inspection data outlier for a facility, component, or related workflow); an equipment condition value indicator 5706 (e.g., an indicator of equipment condition, including wear, degradation, failed areas, operating limitations, etc.); an inspection event value indicator 5708 (e.g., an indicator of an inspection event, such as completion of an inspection, a failure to complete an inspection, and/or any aspect of an inspection event value as described herein); and/or a maintenance event value indicator 5710 (e.g., an indicator of a maintenance event, such as completion of maintenance, a failure to complete maintenance, and/or any aspect of a maintenance event value as described herein).

Referencing FIG. 58, examples of additional facility data 3308 are depicted, which may include data to be utilized to determine an impact of a facility event on a workflow, to determine an impact of a component event on a facility, to determine a capital expenditure plan 3904, a maintenance schedule 3206, and/or an inspection schedule 4206, to determine whether iterative improvement operations are improving and/or converging, and/or utilized to determine uncertainty and/or sensitivity values as set forth herein. The example additional facility data 3308 includes one or more of: production data 5802 (e.g., production duties and/or capacities of a facility, including the contribution of components of the facility on these); productivity data 5804 (e.g., production formulas for a component, facility, and/or workflow, based on utilization of available inputs and/or time relationships); operational cost data 5806 (e.g., costs to operate a component, facility, and/or workflow, and which may be related to cost of inputs, production rates, etc.); facility dependency data 5810 (e.g., the relationship between facilities of a workflow, a description of degradation of other facilities based on degradation of a given facility, etc.); capital cost data 5812 (e.g., the cost of components, including costs to access, install, and/or integrate the component, and which may include related costs such as component volume discounts, increased costs due to a high demand for a large number of a given component, component manufacturer production rate limitations, etc.); and/or an aggregation of inspection data associated with a second entity 5814 (e.g., allowing for consideration of historical performance of other facilities, aggregated statistical analysis on a larger corpus of data than that within the knowledge or control of a first entity, etc.).

Referencing FIG. 59, an example system 5900 to combine inspection data for industrial facilities with other data, and/or to provide a collaboration, annotation, and/or markup interface for a geographic and/or hierarchical inspection presentation is schematically depicted. The example system 5900 may be embodied as a controller 2306 on a facility visualization and planning platform 2302. The example system 5900 includes the aggregation of inspection data associated with a first inspection entity and including additional facility data. The example controller 2306 includes a facility monitoring circuit 5402 that determines a facility display value 3116 in response to the inspection data and the additional facility data. An example user interface component 2304 provides the facility display value 3116 to the user interface 2308.

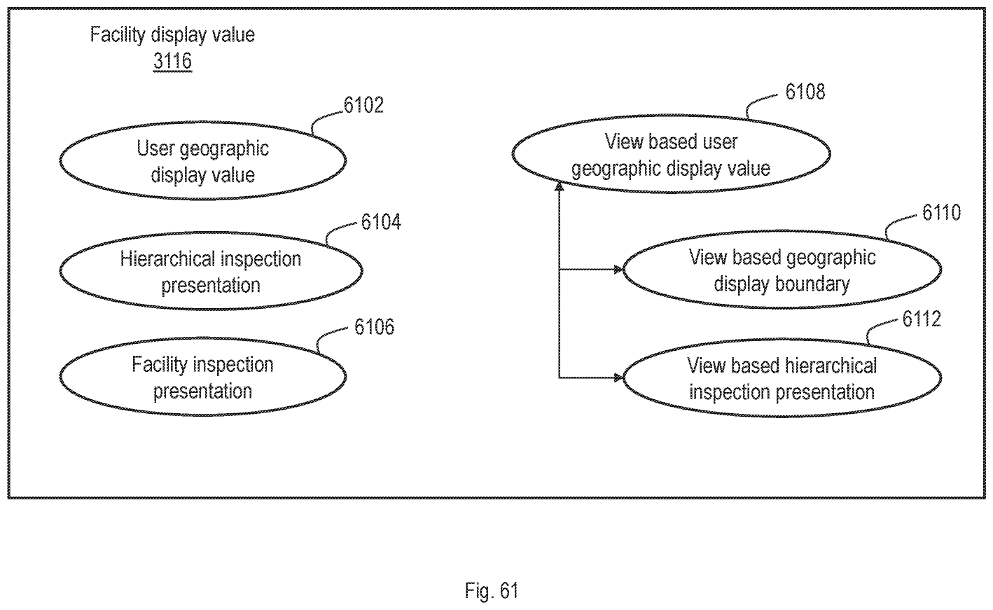

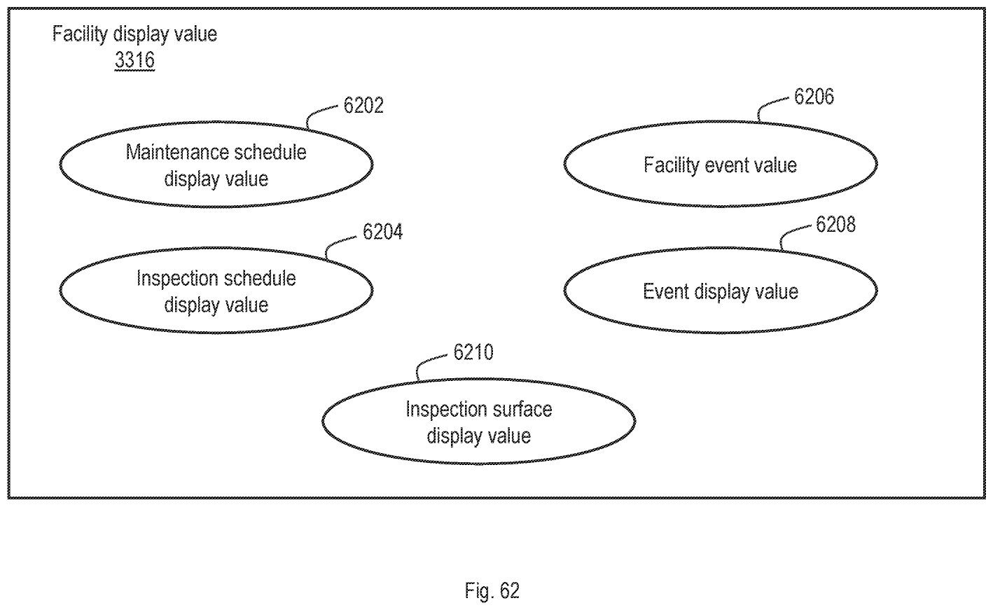

Referencing FIG. 61, example and non-limiting facility display values 3116 include one or more of: a user geographic display value 6102 (e.g., a geographically bounded depiction of facilities, with selected details, applied tooltip and/or detailed views, etc.), a hierarchical inspection presentation 6104 (e.g., a display organized using a hierarchical scheme, with navigation between hierarchy levels, for example as in FIGS. 25-27 and the related description), and/or a facility inspection presentation 6106 (e.g., depiction of facilities and/or components thereof, with indicators, analogs, and/or notifications related to inspection information). An example facility display value 3116 includes a view based user geographic display value 6108 (e.g., reference FIG. 30 and the related description), which may further include a view based geographic display boundary 6110 and/or a view based hierarchical inspection presentation 6112. Referencing FIG. 62, example and non-limiting facility display values 3316 include one or more of: a maintenance schedule display value 6202 (e.g., an indicator of a change to a maintenance schedule, a maintenance gap, a benefit description from a changed maintenance schedule, etc.); an inspection schedule display value 6204 (e.g., an indicator of a change to an inspection schedule, an inspection gap, a benefit description from a changed inspection schedule, etc.); a facility event value 6206; an event display value 6208; and/or an inspection surface display value 6210. Descriptions related to the facility display values 3116, and/or operations using the facility display values 3116, as set forth throughout the present disclosure, are applicable to the examples of FIG. 62.

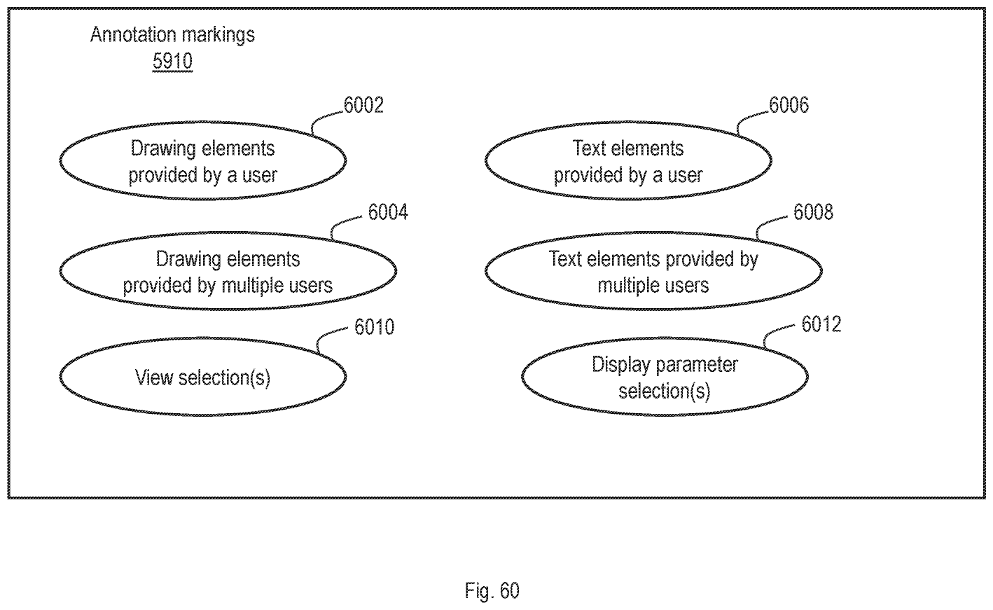

Again referencing FIG. 59, an example system 5900 includes a facility visualization circuit 5902 that interprets an equipment visualization value 5908 for equipment positioned at an industrial facility (e.g., a component that is a part of the facility) in response to the visualization request value (e.g., received from a user interface component 2304 from the user interface 2308). The example controller 2306 includes a facility review circuit 5904 that determines annotation markings 5910 in response to facility annotation values 5906 (e.g., received from a user interface component 2304 that receives the facility annotation values 5906 from user operations on the user interface 2308), and determines a facility display value 3116 in response to the equipment visualization value 5908 and the facility annotation values 5906. An example user interface component 2304 provides the facility display value 3116 to the user interface 2308. Example annotation markings 5910 include user drawings on any display as set forth herein, text annotations, color selections for elements of the display, or the like. Referencing FIG. 60, example and non-limiting annotation markings 5910 include one or more of: drawing elements provided by a user 6002; drawing elements provided by multiple users 6004 (e.g., collaborating on a particular display); view selections 6010 (e.g., defining and/or labeling certain views, which can be shared and/or retrieved); text elements provided by a user 6006 (e.g., comments, adjustments to standard display data, etc.); text elements provide by multiple users 6008; and/or display parameter selections 6012 (e.g., definitions and/or content for hierarchy layers and/or selected hierarchy schemes; icon, color, shading, and/or text aspects of displays; selection of depiction of components; selection of depictions for inspection data; content and/or criteria for notifications; and/or adjustments to any other aspects of the present disclosure relating to any user display values 2314 as set forth herein). Annotations and/or annotated displays may be shared as views, shared in real time, and/or accessed by users synchronously and/or asynchronously. In certain embodiments, annotations or related adjustments may be applied as an overlay, for example allowing annotations to be hidden, approved or rejected, rolled back to a previous version, hidden or displayed for selected users, or the like.

Referencing FIG. 63, an example system 6300 for performing analytics of inspection data for industrial facilities is schematically depicted. The example system 6300 may be embodied as a controller 2306 on a facility visualization and planning platform 2302. The example system 6300 may be utilized with a facility visualization and planning platform 2302 that includes a user interface component 2304 that implements a user interface 2308, and receives a visualization request value 2312 from user operations on the user interface 2308, and receives analytical review communications 6304 from user operations on the user interface 2308. An inspection database (e.g., data store 2310) includes an aggregation of inspection data 2410. The example controller 2306 includes a facility inspection data circuit 2404 that interprets facility relevant data 3204 in response to the aggregation of inspection data 2410 and the analytical review communications 6304, and a facility analysis circuit 6302 that determines a facility display value 3116 in response to the facility relevant data 3204 and the analytical review communications 6304. An example user interface component 2304 provides the facility display value 3116 to the user interface 2308. An example facility analysis circuit 6302 updates the facility display value 3116 in response to an outlier identification selection 6802. An example outlier identification selection 6802 includes a selection (e.g., by a user) of a facility and an attribute for determining an outlier status of the selected facility. Example attributes for determining the outlier status of the facility include attributes such as: a facility having a productivity gap (e.g., a productivity that is a threshold value lower than an estimated potential productivity, and/or having an issue that reduces the productivity); a facility having an outlier component (e.g., a component that, based on inspection data, inspection schedule, maintenance data, and/or a maintenance schedule, is a statistical outlier relative to historical performance and/or offset components); and/or a facility having a statistically significant number of outlier components. In certain embodiments, the outlier identification selection 6802 is based on attributes selected by the user, and performed for every facility, and/or for a selected group of facilities, on an ongoing basis by the facility analysis circuit 6302 (e.g., where the facility analysis circuit 6302 periodically checks each facility to determine an outlier status for the facility, for example sequentially working through the facilities such that each facility is checked over a selected period of time, for example once per week, once per month, and/or more often such as daily (e.g., where the number of facilities and available computing resources allow frequent checks). In certain embodiments, the outlier identification selection 6802 includes a component of a facility, and an attribute of the selected component for determining an outlier status of the selected components. In certain embodiments, the facility analysis circuit 6302 automatically populates the outlier identification selection 6802 to cycle through components of a facility and/or workflow. In certain embodiments, the facility analysis circuit 6302 checks facilities and/or components that are critical (e.g., with a high cost of failure, a dependency on other elements of a workflow, etc.), and/or checks facilities and/or components with a frequency weighted toward checking facilities and/or components that are critical more often than other facilities and/or components.

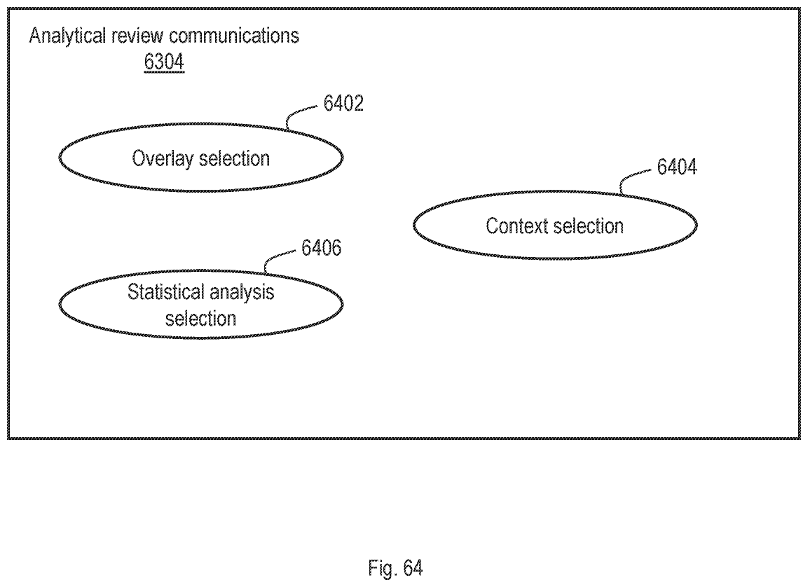

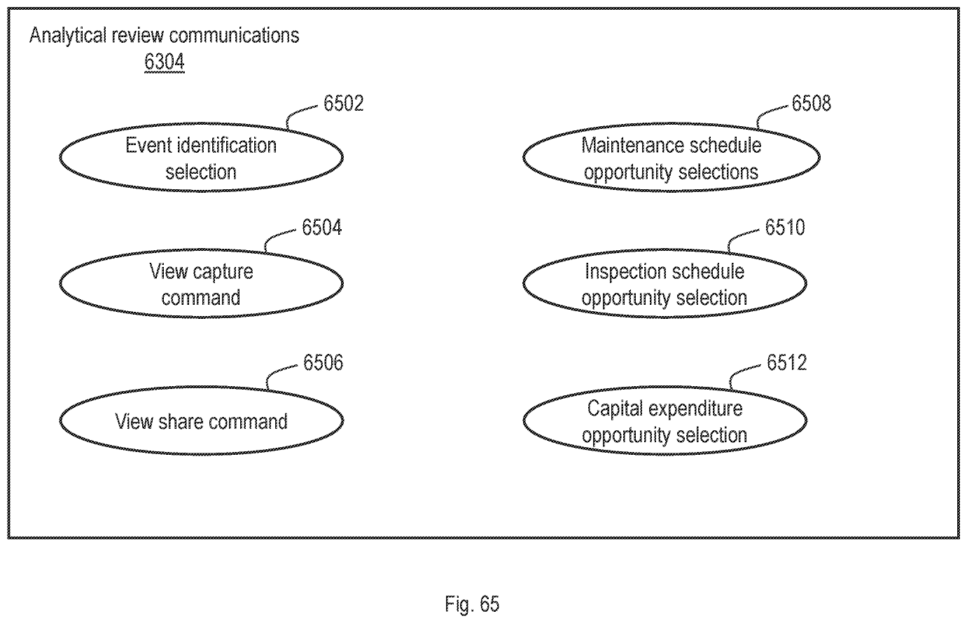

Referencing FIG. 64, example and non-limiting analytical review communications 6304 include one or more of: an overlay selection 6402 (e.g., selection of an overlay to be applied to any user display values 2314 described herein); a statistical analysis selection 6406 (e.g., determination of outlier status, anomalies, high performing components, and/or low performing components, related to any component, facility, workflow, inspection schedule, maintenance schedule, inspection operations, and/or maintenance operations as set forth throughout the present disclosure); and/or a context selection 6404. Referencing FIG. 65, example and non-limiting analytical review communications include one or more of: an event identification selection 6502 (e.g., configuring criteria and/or thresholds for detecting and/or identifying events for any component, facility, workflow, inspection activity, and/or maintenance activity, and/or notifications or other responses to be provided in response to the detected or identified events); a view capture command 6504 (e.g., capturing a view, such as set forth in FIG. 30 and the related description, including configuring navigation and/or visibility of aspects of the view, for example for sharing to another user); a view share command 6506 (e.g., sharing a captured and/or active view with another user); a maintenance schedule opportunity selection 6508 (e.g., reviewing available maintenance schedules and related details, requesting determination of a maintenance planning circuit 3202 to evaluate and/or determine an updated maintenance schedule, and/or setting iterative improvement criteria for a maintenance schedule, such as frequency of iterative improvement operations, a number of execution cycles for iterative improvement options, and/or a convergence criteria for such operations, such as thresholds for a success parameter, a rate of change of the success parameter indicating convergence, or the like); an inspection schedule opportunity selection 6510 (e.g., reviewing available inspection schedules and related details, requesting determination of a inspection planning circuit 4202 to evaluate and/or determine an updated inspection schedule, and/or setting iterative improvement criteria for an inspection schedule, such as frequency of iterative improvement operations, a number of execution cycles for iterative improvement options, and/or a convergence criteria for such operations, such as thresholds for a success parameter, a rate of change of the success parameter indicating convergence, or the like); and/or a capital expenditure opportunity selection 6512 (e.g., reviewing available capital expenditure plans and related details, requesting determination of a CapEx planning circuit 3902 to evaluate and/or determine an updated capital expenditure plan, and/or setting iterative improvement criteria for a capital expenditure plan, such as frequency of iterative improvement operations, a number of execution cycles for iterative improvement options, and/or a convergence criteria for such operations, such as thresholds for a success parameter, a rate of change of the success parameter indicating convergence, or the like).

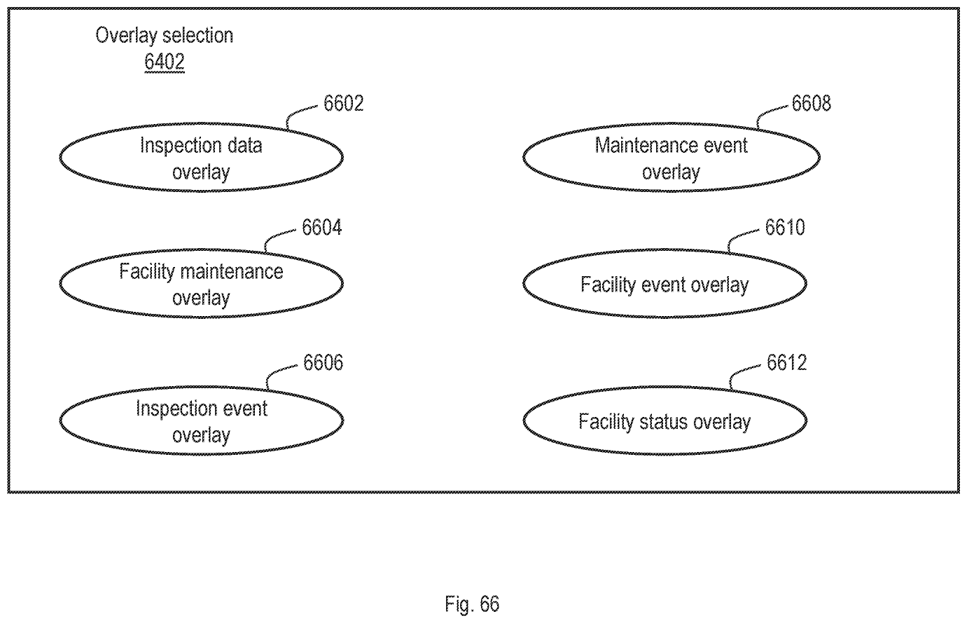

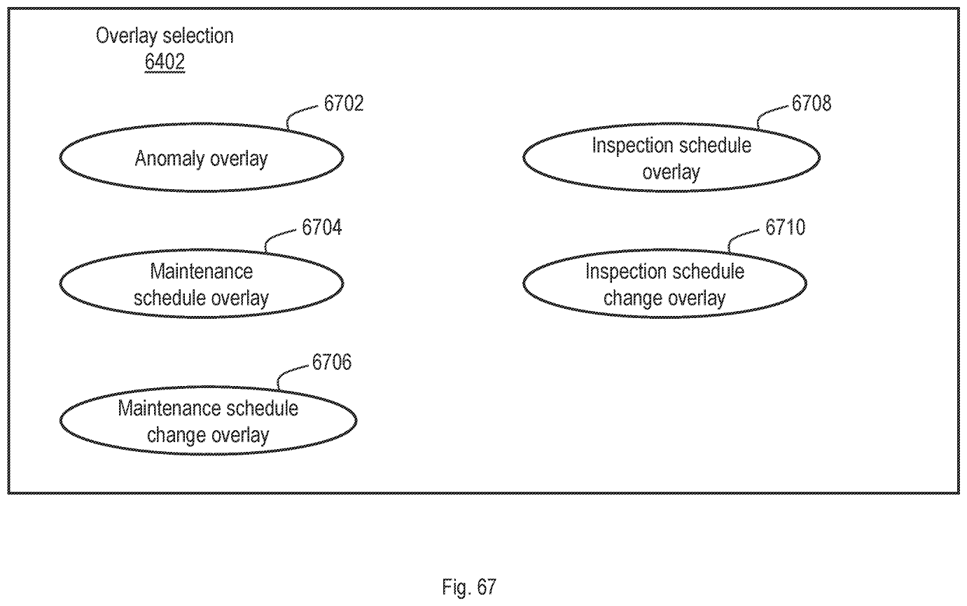

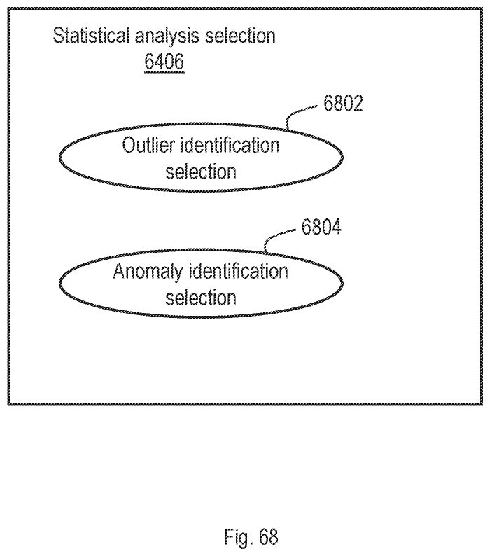

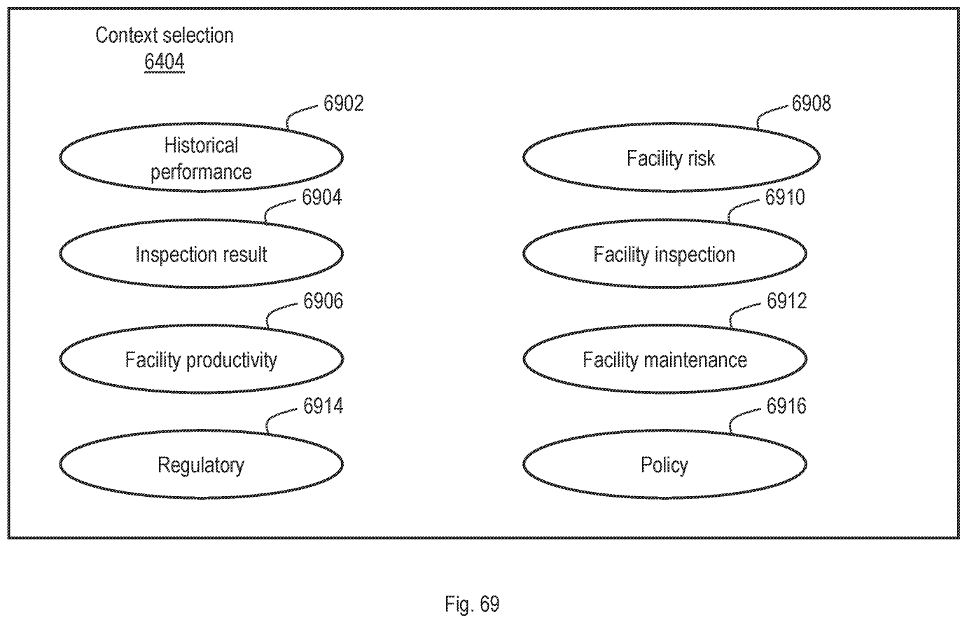

Referencing FIG. 66, an example overlay selection 6402 includes one or more aspects such as: an inspection data overlay 6602 (e.g., depiction parameters for inspection data on any user display value 2314); a facility maintenance overlay 6604 (e.g., depiction parameters for maintenance values on any user display value 2314); an inspection event overlay 6606 (e.g., depiction parameters, notification settings, etc., for inspection events on any user display value 2314); a maintenance event overlay 6608 (e.g., depiction parameters, notification settings, etc., for maintenance events on any user display value 2314); a facility event overlay 6610 (e.g., depiction parameters, notification settings, etc., for facility events on any user display value 2314); and/or a facility status overlay 6612 (e.g., depiction parameters, displayed data and/or display paradigms, etc., for any facility status depiction on any user display value 2314). Referencing FIG. 67, an example overlay selection 6402 includes one or more aspects such as: an anomaly overlay 6702 (e.g., depiction parameters for anomalies on any user display value 2314, including any anomalies set forth throughout the present disclosure); a maintenance schedule overlay 6704 (e.g., depiction parameters for any maintenance schedule, including for example component, facility, and/or workflow status parameters that result from, and/or are estimated to be achieved by, a current or proposed maintenance schedule); a maintenance schedule change overlay 6706; an inspection schedule overlay 6708 (e.g., depiction parameters for any inspection schedule, including for example component, facility, and/or workflow status parameters that result from, and/or are estimated to be achieved by, a current or proposed inspection schedule); and/or an inspection schedule change overlay 6710 (e.g., highlighting affected components, facilities, and/or workflows, from an inspection schedule change, and/or a listing or description of inspection schedule changes). Referencing FIG. 68, example statistical analysis selections 6406 include one or more of an outlier identification selection 6802 and/or an anomaly identification selection 6804. The example outlier identification selection 6802 allows the user to set up aspects that are to be checked for anomalies, thresholds for anomaly determination, and/or notification settings for anomalies that are detected. Detected anomalies include any anomaly detection criteria set forth throughout the present disclosure, and include at least anomalies related to inspection operations, inspection data, maintenance operations, and/or maintenance data or outcomes. Detected outliers include any outlier detection criteria set forth throughout the present disclosure, and include at least outliers related to inspection operations, inspection data, maintenance operations, and/or maintenance data or outcomes. Referencing FIG. 69, example and non-limiting context selections 6404 include one or more aspects such as: a historical performance 6902 (e.g., evaluating any component, facility, workflow, inspection operation, inspection data, maintenance operation, and/or maintenance data or outcome, based on historical performance of that aspect or an offset aspect); an inspection result 6904 (e.g., evaluating any aspect in view of inspection results, for example whether maintenance events are recommended, whether inspection operations are expected to be successful, and/or evaluating any maintenance schedule, inspection schedule, and/or capital expenditure plan, whether current or proposed, in view of the inspection data); a facility productivity 6906 (e.g., evaluating the effects of any aspect on a productivity of a facility); a regulatory context 6914 (e.g., confirming that current or proposed plans or schedules are compliant with a regulatory scheme, and/or identifying components, facilities, or workflows that may be affected by a regulatory change, etc.); a facility risk 6908 (e.g., evaluating the effects of any aspect on a risk parameter of the facility); a facility inspection 6910 (e.g., evaluating the effects of a facility inspection outcome on any aspect, evaluating the effects of any aspect on a facility inspection schedule, for example determining whether the inspection schedule can be executed, and/or evaluating the effect of an inspection schedule or prospective inspection schedule on other aspects); a facility maintenance 6912 (e.g., evaluating the effects of a facility maintenance outcome on any aspect, evaluating the effects of any aspect on a facility maintenance schedule, for example determining whether the maintenance schedule can be executed, and/or evaluating the effect of a maintenance schedule or prospective maintenance schedule on other aspects); and/or a policy 6916 (e.g., confirming that current or proposed plans or schedules are compliant with a policy scheme, and/or identifying components, facilities, or workflows that may be affected by a policy change, etc.).

The description following includes schematic flow descriptions of various procedures operations of the present disclosure. The procedures and/or operations thereof may be performed by any systems, platforms, circuits, components, managers, or elements thereof as set forth in the preceding disclosure. Example operations are non-limiting, for example operations may be omitted in whole or part, and/or rearranged in whole or part.

An example procedure for geographic depiction of a hierarchical inspection presentation for industrial facilities includes an operation to implement a user interface and to receive a visualization request value from user operations on the interface. The example procedure further includes an operation to interpret a user facility visualization value in response to the visualization request value, an operation to interpret the aggregation of inspection data in response to the user facility visualization value, an operation to determine a geographic display boundary and a hierarchical inspection presentation for at least one industrial facility positioned within the geographic display boundary in response to the user facility visualization value, an operation to determine a user geographic display value in response to the geographic display boundary and the hierarchical inspection presentation, and an operation to provide the user geographic display value to the user interface.

An example procedure for view customization of a geographical depiction of inspection information for industrial facilities includes an operation to implement a user interface and to receive a visualization request value from user operations on the interface. The example procedure further includes an operation to interpret a view based user facility visualization value in response to the visualization request value, an operation to interpret the aggregation of inspection data in response to the view based user facility visualization value, an operation to determine a view based geographic display boundary and a view based hierarchical inspection presentation for at least one industrial facility positioned within the view based geographic display boundary in response to the view based user facility visualization value, an operation to determine a view based user geographic display value in response to the view based geographic display boundary and the view based hierarchical inspection presentation, and an operation to provide the view based user geographic display value to the user interface.

An example procedure for determining a maintenance schedule includes an operation to receive a user facility request value from user operations on a user interface. The example procedure further includes an operation to interpret facility relevant data in response to an aggregation of inspection data and the user facility request value. The example procedure further includes an operation to determine a maintenance schedule for at least one industrial facility in response to the facility relevant data, and an operation to determine a maintenance schedule display value in response to the maintenance schedule and the facility relevant data. The example procedure further includes an operation to provide the maintenance schedule display value to the user interface.

An example procedure for determining a capital expenditure plan for industrial equipment includes an operation to receive a user facility request value from user operations on a user interface. The example procedure further includes an operation to interpret facility relevant data in response to an aggregation of inspection data and the user facility request value. The example procedure further includes an operation to determine a capital expenditure plan for at least one industrial facility in response to the facility relevant data, and an operation to determine a capital expenditure display value in response to the capital expenditure plan and the facility relevant data. The example procedure further includes an operation to provide the capital expenditure display value to the user interface.

An example procedure for configuring an inspection schedule for industrial equipment includes an operation to receive a user facility request value from user operations on a user interface. The example procedure further includes an operation to interpret facility relevant data in response to an aggregation of inspection data and the user facility request value. The example procedure further includes an operation to determine an inspection schedule for at least one industrial facility in response to the facility relevant data, and an operation to determine an inspection schedule display value in response to the inspection schedule and the facility relevant data. The example procedure further includes an operation to provide the inspection schedule display value to the user interface.

An example procedure for geographic depiction of inspection information for industrial facilities includes an operation to implement a user interface and to receive a user facility request value from user operations on the interface. The example procedure further includes an operation to interpret a facility relevant data and offset facility data in response to an aggregation of inspection data (and/or further in response to the user facility request value), an operation to determine an inspection schedule for at least one industrial facility in response to the facility relevant data and the offset facility data, and an operation to determine an inspection schedule in response to the facility relevant data and the offset facility data. The example procedure further includes an operation to determine an inspection schedule display value in response to the inspection schedule and the facility relevant data, and an operation to provide the inspection schedule display value to the user interface.

An example procedure for displaying an inspection surface for industrial equipment includes an operation to implement a user interface and to receive a visualization request value from user operations on the interface. The example procedure further includes an operation to interpret a user facility visualization value in response to the visualization request value, an operation to interpret the aggregation of inspection data in response to the user facility visualization value, an operation to determine a facility inspection presentation for at least one industrial facility in response to the user facility visualization value and an aggregation of inspection data, an operation to determine an inspection surface display value for at least one component of the industrial facility in response to the facility inspection presentation, and an operation to provide the inspection surface display value to the user interface.

An example procedure for rapid event detection through a geographical depiction of inspection data for industrial equipment includes an operation to implement a user interface and to receive a visualization request value from user operations on the interface. The example procedure further includes an operation to interpret an aggregation of inspection data in response to the visualization request value, an operation to determine a facility event value for at least one industrial facility in response to the visualization request value and the aggregation of inspection data, an operation to determine an event display value in response to the facility event value, and an operation to provide the event display value to the user interface.

An example procedure for facilitating an annotation and markup display for inspection data on a digital representation of a physical object includes an operation to implement a user interface and to receive a visualization request value and facility annotation values from user operations on the user interface, an operation to interpret an equipment visualization value for equipment positioned at an industrial facility in response to the visualization request value, an operation to determine annotation markings in response to the facility annotation values, an operation to determine a facility display value in response to the equipment visualization value and the facility annotation values, and an operation to provide the facility display value to the user interface.

An example procedure for performing analytics of inspection data for industrial facilities includes an operation to implement a user interface, and to receive a visualization request value and an analytical review communication from user operations on the interface. The example procedure further includes an operation to interpret facility relevant data in response to the analytical review communication and an aggregation of inspection data, an operation to determine a facility display value in response to the facility relevant data and the analytical review communication, and an operation to provide the facility display value to a user interface.

The methods and systems described herein may be deployed in part or in whole through a machine having a computer, computing device, processor, circuit, and/or server that executes computer readable instructions, program codes, instructions, and/or includes hardware configured to functionally execute one or more operations of the methods and systems herein. The terms computer, computing device, processor, circuit, and/or server, (“computing device”) as utilized herein, should be understood broadly.

An example computing device includes a computer of any type, capable to access instructions stored in communication thereto such as upon a non-transient computer readable medium, whereupon the computer performs operations of the computing device upon executing the instructions. In certain embodiments, such instructions themselves comprise a computing device. Additionally or alternatively, a computing device may be a separate hardware device, one or more computing resources distributed across hardware devices, and/or may include such aspects as logical circuits, embedded circuits, sensors, actuators, input and/or output devices, network and/or communication resources, memory resources of any type, processing resources of any type, and/or hardware devices configured to be responsive to determined conditions to functionally execute one or more operations of systems and methods herein.

Network and/or communication resources include, without limitation, local area network, wide area network, wireless, internet, or any other known communication resources and protocols. Example and non-limiting hardware and/or computing devices include, without limitation, a general-purpose computer, a server, an embedded computer, a mobile device, a virtual machine, and/or an emulated computing device. A computing device may be a distributed resource included as an aspect of several devices, included as an interoperable set of resources to perform described functions of the computing device, such that the distributed resources function together to perform the operations of the computing device. In certain embodiments, each computing device may be on separate hardware, and/or one or more hardware devices may include aspects of more than one computing device, for example as separately executable instructions stored on the device, and/or as logically partitioned aspects of a set of executable instructions, with some aspects comprising a part of one of a first computing device, and some aspects comprising a part of another of the computing devices.

A computing device may be part of a server, client, network infrastructure, mobile computing platform, stationary computing platform, or other computing platform. A processor may be any kind of computational or processing device capable of executing program instructions, codes, binary instructions and the like. The processor may be or include a signal processor, digital processor, embedded processor, microprocessor or any variant such as a co-processor (math co-processor, graphic co-processor, communication co-processor and the like) and the like that may directly or indirectly facilitate execution of program code or program instructions stored thereon. In addition, the processor may enable execution of multiple programs, threads, and codes. The threads may be executed simultaneously to enhance the performance of the processor and to facilitate simultaneous operations of the application. By way of implementation, methods, program codes, program instructions and the like described herein may be implemented in one or more threads. The thread may spawn other threads that may have assigned priorities associated with them; the processor may execute these threads based on priority or any other order based on instructions provided in the program code. The processor may include memory that stores methods, codes, instructions and programs as described herein and elsewhere. The processor may access a storage medium through an interface that may store methods, codes, and instructions as described herein and elsewhere. The storage medium associated with the processor for storing methods, programs, codes, program instructions or other type of instructions capable of being executed by the computing or processing device may include but may not be limited to one or more of a CD-ROM, DVD, memory, hard disk, flash drive, RAM, ROM, cache and the like.

A processor may include one or more cores that may enhance speed and performance of a multiprocessor. In embodiments, the process may be a dual core processor, quad core processors, other chip-level multiprocessor and the like that combine two or more independent cores (called a die).

The methods and systems described herein may be deployed in part or in whole through a machine that executes computer readable instructions on a server, client, firewall, gateway, hub, router, or other such computer and/or networking hardware. The computer readable instructions may be associated with a server that may include a file server, print server, domain server, internet server, intranet server and other variants such as secondary server, host server, distributed server and the like. The server may include one or more of memories, processors, computer readable transitory and/or non-transitory media, storage media, ports (physical and virtual), communication devices, and interfaces capable of accessing other servers, clients, machines, and devices through a wired or a wireless medium, and the like. The methods, programs, or codes as described herein and elsewhere may be executed by the server. In addition, other devices required for execution of methods as described in this application may be considered as a part of the infrastructure associated with the server.

The server may provide an interface to other devices including, without limitation, clients, other servers, printers, database servers, print servers, file servers, communication servers, distributed servers, and the like. Additionally, this coupling and/or connection may facilitate remote execution of instructions across the network. The networking of some or all of these devices may facilitate parallel processing of program code, instructions, and/or programs at one or more locations without deviating from the scope of the disclosure. In addition, all the devices attached to the server through an interface may include at least one storage medium capable of storing methods, program code, instructions, and/or programs A central repository may provide program instructions to be executed on different devices. In this implementation, the remote repository may act as a storage medium for methods, program code, instructions, and/or programs.

The methods, program code, instructions, and/or programs may be associated with a client that may include a file client, print client, domain client, internet client, intranet client and other variants such as secondary client, host client, distributed client and the like. The client may include one or more of memories, processors, computer readable transitory and/or non-transitory media, storage media, ports (physical and virtual), communication devices, and interfaces capable of accessing other clients, servers, machines, and devices through a wired or a wireless medium, and the like. The methods, program code, instructions, and/or programs as described herein and elsewhere may be executed by the client. In addition, other devices required for execution of methods as described in this application may be considered as a part of the infrastructure associated with the client.

The client may provide an interface to other devices including, without limitation, servers, other clients, printers, database servers, print servers, file servers, communication servers, distributed servers, and the like. Additionally, this coupling and/or connection may facilitate remote execution of methods, program code, instructions, and/or programs across the network. The networking of some or all of these devices may facilitate parallel processing of methods, program code, instructions, and/or programs at one or more locations without deviating from the scope of the disclosure. In addition, all the devices attached to the client through an interface may include at least one storage medium capable of storing methods, program code, instructions, and/or programs A central repository may provide program instructions to be executed on different devices. In this implementation, the remote repository may act as a storage medium for methods, program code, instructions, and/or programs.

The methods and systems described herein may be deployed in part or in whole through network infrastructures. The network infrastructure may include elements such as computing devices, servers, routers, hubs, firewalls, clients, personal computers, communication devices, routing devices and other active and passive devices, modules, and/or components as known in the art. The computing and/or non-computing device(s) associated with the network infrastructure may include, apart from other components, a storage medium such as flash memory, buffer, stack, RAM, ROM and the like. The methods, program code, instructions, and/or programs described herein and elsewhere may be executed by one or more of the network infrastructural elements.

The methods, program code, instructions, and/or programs described herein and elsewhere may be implemented on a cellular network having multiple cells. The cellular network may either be frequency division multiple access (FDMA) network or code division multiple access (CDMA) network. The cellular network may include mobile devices, cell sites, base stations, repeaters, antennas, towers, and the like.

The methods, program code, instructions, and/or programs described herein and elsewhere may be implemented on or through mobile devices. The mobile devices may include navigation devices, cell phones, mobile phones, mobile personal digital assistants, laptops, palmtops, netbooks, pagers, electronic books readers, music players and the like. These devices may include, apart from other components, a storage medium such as a flash memory, buffer, RAM, ROM and one or more computing devices. The computing devices associated with mobile devices may be enabled to execute methods, program code, instructions, and/or programs stored thereon. Alternatively, the mobile devices may be configured to execute instructions in collaboration with other devices. The mobile devices may communicate with base stations interfaced with servers and configured to execute methods, program code, instructions, and/or programs. The mobile devices may communicate on a peer-to-peer network, mesh network, or other communications network. The methods, program code, instructions, and/or programs may be stored on the storage medium associated with the server and executed by a computing device embedded within the server. The base station may include a computing device and a storage medium. The storage device may store methods, program code, instructions, and/or programs executed by the computing devices associated with the base station.

The methods, program code, instructions, and/or programs may be stored and/or accessed on machine readable transitory and/or non-transitory media that may include: computer components, devices, and recording media that retain digital data used for computing for some interval of time; semiconductor storage known as random access memory (RAM); mass storage typically for more permanent storage, such as optical discs, forms of magnetic storage like hard disks, tapes, drums, cards and other types; processor registers, cache memory, volatile memory, non-volatile memory; optical storage such as CD, DVD; removable media such as flash memory (e.g. USB sticks or keys), floppy disks, magnetic tape, paper tape, punch cards, standalone RAM disks, Zip drives, removable mass storage, off-line, and the like; other computer memory such as dynamic memory, static memory, read/write storage, mutable storage, read only, random access, sequential access, location addressable, file addressable, content addressable, network attached storage, storage area network, bar codes, magnetic ink, and the like.

Certain operations described herein include interpreting, receiving, and/or determining one or more values, parameters, inputs, data, or other information (“receiving data”). Operations to receive data include, without limitation: receiving data via a user input; receiving data over a network of any type; reading a data value from a memory location in communication with the receiving device; utilizing a default value as a received data value; estimating, calculating, or deriving a data value based on other information available to the receiving device; and/or updating any of these in response to a later received data value. In certain embodiments, a data value may be received by a first operation, and later updated by a second operation, as part of the receiving a data value. For example, when communications are down, intermittent, or interrupted, a first receiving operation may be performed, and when communications are restored an updated receiving operation may be performed.

Certain logical groupings of operations herein, for example methods or procedures of the current disclosure, are provided to illustrate aspects of the present disclosure. Operations described herein are schematically described and/or depicted, and operations may be combined, divided, re-ordered, added, or removed in a manner consistent with the disclosure herein. It is understood that the context of an operational description may require an ordering for one or more operations, and/or an order for one or more operations may be explicitly disclosed, but the order of operations should be understood broadly, where any equivalent grouping of operations to provide an equivalent outcome of operations is specifically contemplated herein. For example, if a value is used in one operational step, the determining of the value may be required before that operational step in certain contexts (e.g., where the time delay of data for an operation to achieve a certain effect is important), but may not be required before that operation step in other contexts (e.g. where usage of the value from a previous execution cycle of the operations would be sufficient for those purposes). Accordingly, in certain embodiments an order of operations and grouping of operations as described is explicitly contemplated herein, and in certain embodiments re-ordering, subdivision, and/or different grouping of operations is explicitly contemplated herein.

The methods and systems described herein may transform physical and/or or intangible items from one state to another. The methods and systems described herein may also transform data representing physical and/or intangible items from one state to another.

The methods and/or processes described above, and steps thereof, may be realized in hardware, program code, instructions, and/or programs or any combination of hardware and methods, program code, instructions, and/or programs suitable for a particular application. The hardware may include a dedicated computing device or specific computing device, a particular aspect or component of a specific computing device, and/or an arrangement of hardware components and/or logical circuits to perform one or more of the operations of a method and/or system. The processes may be realized in one or more microprocessors, microcontrollers, embedded microcontrollers, programmable digital signal processors or other programmable device, along with internal and/or external memory. The processes may also, or instead, be embodied in an application specific integrated circuit, a programmable gate array, programmable array logic, or any other device or combination of devices that may be configured to process electronic signals. It will further be appreciated that one or more of the processes may be realized as a computer executable code capable of being executed on a machine readable medium.

The computer executable code may be created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and computer readable instructions, or any other machine capable of executing program instructions.

Thus, in one aspect, each method described above, and combinations thereof, may be embodied in computer executable code that, when executing on one or more computing devices, performs the steps thereof. In another aspect, the methods may be embodied in systems that perform the steps thereof, and may be distributed across devices in a number of ways, or all of the functionality may be integrated into a dedicated, standalone device or other hardware. In another aspect, the means for performing the steps associated with the processes described above may include any of the hardware and/or computer readable instructions described above. All such permutations and combinations are intended to fall within the scope of the present disclosure.

1. A system, comprising:
a facility visualization and planning platform comprising:
a user interface component configured to implement a user interface, and to receive a visualization request value from user operations on the user interface;
an inspection database comprising an aggregation of inspection data; and
a controller, comprising:
a facility planning circuit structured to interpret a user facility visualization value in response to the visualization request value;
a facility inspection data circuit structured to interpret the aggregation of inspection data in response to the user facility visualization value;
a geographic depiction circuit structured to:
determine a geographic display boundary and a hierarchical inspection presentation for at least one industrial facility positioned within the geographic display boundary in response to the user facility visualization value and the aggregation of inspection data; and
determine a user geographic display value in response to the geographic display boundary and the hierarchical inspection presentation; and
wherein the user interface component is further structured to provide the user geographic display value to the user interface.

2. The system of claim 1, wherein the user operations on the user interface to provide the visualization request value comprise at least one operation selected from:
defining a geographic boundary;
selecting a geographic region;
selecting a facility of interest;
selecting a facility type of interest;
selecting an entity of interest;
selecting an equipment type of interest; or
selecting a predetermined facility group;
selecting a predetermined equipment group;
providing a facility relationship value;
providing an equipment relationship value;
adjusting a current user geographic display value; or
a hierarchy selection value.

3. The system of claim 1, wherein the facility planning circuit structured is further configured to interpret the user facility visualization value in response to the visualization request value by determining at least one relevant facility for user display.

4. The system of claim 3, wherein the geographic display boundary comprises a geographic region for depiction determined in response to the at least one relevant facility.

5. The system of claim 4, wherein the geographic region for depiction comprises a geometric region encompassing the at least one relevant facility.

6. The system of claim 4, wherein the geographic region for depiction comprises a bounded region at least partially defined by a geographic boundary encompassing the at least one relevant facility.

7. The system of claim 1, wherein the hierarchical inspection presentation comprises a hierarchy organized based upon at least one of:
a facility hierarchy;
an entity hierarchy;
a geographic hierarchy;
an equipment hierarchy; or
an inspection data determined hierarchy.

8. The system of claim 1, wherein the user geographic display value comprises a geographic region for depiction, at least one relevant facility for depiction, and a display paradigm for the at least one relevant facility for depiction.

9. The system of claim 8, wherein the display paradigm includes a facility depiction scheme.

10. The system of claim 8, wherein the display paradigm includes a facility data scheme.

11. The system of claim 10, wherein the facility data scheme further comprises a facility inspection data scheme.

12. The system of claim 1, wherein the user geographic display value comprises a geographic region for depiction, at least one relevant equipment for depiction, and a display paradigm for the at least one relevant equipment.

13.-210. (canceled)

211. A method, comprising:
implementing a user interface for a facility visualization and planning platform, and receiving a visualization request value from user operations on the user interface;
interpreting a user facility visualization value in response to the visualization request value;
interpreting an aggregation of inspection data in response to the user facility visualization value;
determining a geographic display boundary and a hierarchical inspection presentation for at least one industrial facility positioned within the geographic display boundary in response to the user facility visualization value and the aggregation of inspection data;
determining a user geographic display value in response to the geographic display boundary and the hierarchical inspection presentation; and
providing the user geographic display value to the user interface.

212. The method of claim 211, further comprising interpreting the user facility visualization value in response to the visualization request value by determining at least one relevant facility for user display.

213. The method of claim 211, further comprising:
interpreting a view based user facility visualization value in response to visualization request value;
determining a view based geographic display boundary and a view based hierarchical inspection presentation for the at least one industrial facility in response to the view based user facility visualization value and the aggregation of inspection data;
determining a view based user geographic display value in response to the view based geographic display boundary and the view based hierarchical inspection presentation; and
providing the view based user geographic display value to the user interface.

214. The method of claim 211, further comprising:
receiving a user facility request value from the user interface;
interpreting facility relevant data in response to the aggregation of inspection data and the user facility request value;
determining a maintenance schedule for the at least one industrial facility in response to the facility relevant data;
determining a maintenance schedule display value in response to the maintenance schedule and the facility relevant data; and
providing the maintenance schedule display value to the user interface.

215. The method of claim 211, further comprising:
receiving a user facility request value from the user interface;
interpreting facility relevant data in response to the aggregation of inspection data and the user facility request value;
determining a capital expenditure plan for the at least one industrial facility in response to the facility relevant data;
determining a capital expenditure display value in response to the capital expenditure plan and the facility relevant data; and
providing the capital expenditure display value to the user interface.

216. The method of claim 211, further comprising:
receiving a user facility request value from the user interface;
interpreting facility relevant data in response to the aggregation of inspection data and the user facility request value;
determining an inspection schedule for the at least one industrial facility in response to the facility relevant data;
determining an inspection schedule display value in response to the inspection schedule and the facility relevant data; and
providing the inspection schedule display value to the user interface.

217. The method of claim 211, further comprising:
receiving a user facility request value from the user interface;
interpreting facility relevant data and offset facility data in response to the aggregation of inspection data;
determining an inspection schedule for the at least one industrial facility in response to the facility relevant data and the offset facility data;
determining an inspection schedule display value in response to the inspection schedule and the facility relevant data; and
providing the inspection schedule display value to the user interface.

218. The method of claim 211, further comprising:
determine a facility inspection presentation for the at least one industrial facility positioned within the geographic display boundary in response to the user facility visualization value and the aggregation of inspection data; and
determining the user geographic display value further in response to the facility inspection presentation.

219. The method of claim 211, further comprising:
determining a facility inspection presentation for the at least one industrial facility in response to the user facility visualization value and the aggregation of inspection data;
determining an inspection surface display value for at least one component of the at least one industrial facility in response to the facility inspection presentation; and
providing the inspection surface display value to the user interface.

220. The method of claim 211, further comprising:
determining a facility event value for the at least one industrial facility in response to the visualization request value and the aggregation of inspection data;
determining an event display value for at least one component of the at least one industrial facility in response to the facility event value; and
providing the event display value to the user interface.

221. The method of claim 211, further comprising:
wherein the aggregation of inspection data comprises inspection data associated with a first inspection entity and additional facility data;
determining a facility display value in response to the inspection data associated with the first inspection entity and the additional facility data; and
providing the facility display value to the user interface.

222. The method of claim 211, further comprising:
receiving facility annotation values from user operations on the user interface;
interpreting an equipment visualization value for equipment positioned at the at least one industrial facility in response to the visualization request value;
determining annotation markings in response to the facility annotation values;
determining a facility display value in response to the equipment visualization value; and
providing the facility display value to the user interface.

223. The method of claim 211, further comprising:
receiving analytical review communications from user operations on the user interface;
interpreting facility relevant data in response to the aggregation of inspection data and the analytical review communications;
determining a facility display value in response to the facility relevant data and the analytical review communications; and
providing the facility display value to the user interface.
